(19) United States
(12) Patent Application Publication
(10) Pub. No.: US 2012/0311492 A1
(43) Pub. Date: Dec. 6, 2012

(54) AUTOMATED METHOD OF CAPTURING, PRESERVING AND ORGANIZING THOUGHTS AND IDEAS

(75) Inventors: Ray E. OMHOLT, West Chester, PA (US); William P. WAGNER, Media, PA (US)

(73) Assignee: MEMORY ON DEMAND, LLC, West Chester, PA (US)

(21) Appl. No.: 13/483,285

(22) Filed: May 30, 2012

Related U.S. Application Data
(60) Provisional application No. 61/493,231, filed on Jun. 3, 2011.

(51) Int. Cl. G06F 3/048

(52) U.S. Cl. 715/804

(57) ABSTRACT

A computer program product and method is provided for capturing and organizing thoughts and ideas of a user. A user enters into a user interface display screen one or more thought-line headers and a thought-line for each thought-line header. Initial priority information and organizational headers may also be entered. Each thought-line header and associated thought-line define a complete thought-line, thereby capturing the thoughts and ideas of the user as they occur. The user interface display screen presents a display of a plurality of complete thought-lines and any entered initial priority information or organizational headers in a plurality of different configurations. The complete thought-lines may be reordered by the user in a variety of different ways, thereby organizing the thoughts and ideas of the user.

### CROSS-REFERENCE TO RELATED APPLICATIONS

This application claims priority to U.S. Provisional Patent Application No. 61/493,231 filed Jun. 3, 2011, which is incorporated herein by reference.

### COPYRIGHT NOTICE AND AUTHORIZATION

Portions of the documentation in this patent document contain material that is subject to copyright protection. The copyright owner has no object to the facsimile reproduction by anyone of the patent document or the patent disclosure as it appears in the Patent and Trademark Office file or records, but otherwise reserves all copyright rights whatsoever.

### BRIEF DESCRIPTION OF THE DRAWINGS

The foregoing summary as well as the following detailed description of preferred embodiments of the invention, will be better understood when read in conjunction with the appended drawings. For the purpose of illustrating the invention, the drawings show presently preferred embodiments. However, the invention is not limited to the precise arrangements and instrumentalities shown. In the drawings:

FIGS. 1-14 show a sample session in the form of 14 display screens that illustrate the mechanics of an exemplary organizing and priority process in a step-by-step manner in accordance with one preferred embodiment of the present invention.

FIGS. 15-20 show a sample session in the form of six display screens that illustrate the mechanics of how the display screen of FIG. 1 is created in a step-by-step manner in accordance with one preferred embodiment of the present invention.

FIGS. 21A-21B, taken together, shows a sample display screen at the completion of a session in accordance with one preferred embodiment of the present invention.

FIG. 22 shows a sample session for entering a new thought-line in accordance with one preferred embodiment of the present invention.

FIGS. 23-28 shows sample user interface display screens for inputting information that a user wishes to remember in accordance with one preferred embodiment of the present invention.

FIG. 29 shows a memory table for storing the information inputted into the display screens of FIGS. 23-28.

FIGS. 30-32 shows sample pre-populated user interface display screens for inputting information that a user wishes to remember in accordance with one preferred embodiment of the present invention.

FIGS. 33-46 show user interface display screens in accordance with another preferred embodiment of the present invention.

FIG. 47 shows a flowchart of selected steps of the process shown in FIGS. 33-46.

FIGS. 48-57 show user interface display screens for a portable electronic device that implements the functionality shown in FIGS. 33-46.

FIG. 58A, 58B and 58C each shows two views of a database for use in the preferred embodiment of FIGS. 48-57, 59-73 and 74, respectively.

FIGS. 59-72 show user interface display screens in accordance with another preferred embodiment of the present invention.

FIG. 73 shows a flowchart of selected steps of the process shown in FIGS. 59-72.

FIG. 74 shows a flowchart in accordance with another preferred embodiment of the present invention.

FIG. 75 is a schematic diagram of the hardware/software system used to implement preferred embodiments of the present invention.

### BRIEF SUMMARY OF THE INVENTION

A method is provided for capturing, preserving and organizing thoughts and ideas of a person (user). One preferred embodiment of the method operates as follows:
1. The user defines the following three items:

(i) one or more organizational topic headings (also referred to herein as “Header 1”),

(ii) one or more thought-line headers for each organizational topic heading (also referred to herein as “Header 2”), and

(iii) one or more thought-lines for each thought-line header (also referred to herein as a “thought”). The header 2 defines the content of the thought-line.
2. The user enters thought-line headers and thought-lines in one or more sessions.
3. The user then organizes and prioritizes the thought-lines using their respective headers while viewing a display of the three items. The user can quickly and easily focus on the thought-line headers to identify the most important headers, and then prioritize the most important ones.

Another method is provided for capturing and organizing thoughts and ideas of a user and operates as follows:

1. A user enters into a user interface display screen one or more thought-line headers, a thought-line for each thought-line header, and a user-defined initial priority rating for each of the thought-line headers and associated thought-lines. Each thought-line header and associated thought-line define a complete thought-line, thereby capturing the thoughts and ideas of the user as they occur.

2. The user interface display screen presents a display of a plurality of complete thought-lines that are displayed in order of their initial priority rating from highest to lowest.

3. The user selects via the user interface display screen one or more of the complete thought-lines as being of upcoming greatest importance to the user.

4. The order of the complete-thought-lines is modified so that the selected complete thought-lines appear at the highest order on the user interface display screen.

5. The modified order of the complete-thought-lines is displayed, thereby organizing the thoughts and ideas of the user.

Yet another method is provided for capturing and organizing thoughts and ideas of a user and operates as follows:

1. A user enters into a user interface display screen an organizational header, an initial alphanumeric character associated with the organizational header, one or more thought-line headers for each organizational header, and a thought-line for each thought-line header. Each thought-line header and associated thought-line define a complete thought-line, thereby capturing the thoughts and ideas of the user as they occur. The user also enters an initial priority rating for each of the complete thought-lines.

2. The user interface display screen presents a display of organizational headers and associated initial alphanumeric characters, and a plurality of complete thought-lines. The complete thought-lines being visually separated into groups in accordance with their respective organizational headers. The display is initially ordered in alphanumeric order depending upon the initial alphanumeric characters of the organizational headers.

3. The initial alphanumeric characters of an organizational header are changed so that the organizational headers and the associated complete thought-lines within each organizational header can be reordered by the user into a revised alphanumeric order, while remaining in the same visually separated group, thereby organizing the thoughts and ideas of the user.

Yet another method is provided for capturing and organizing thoughts and ideas of a user and operates as follows:

1. A user enters into a user interface display screen one or more thought-line headers and a thought-line for each thought-line header. Each thought-line header and associated thought-line define a complete thought-line, thereby capturing the thoughts and ideas of the user as they occur.

2. The user interface display screen presents a display of a plurality of complete thought-lines in alphanumeric order by thought-line header, and in a manner that visually separates the complete thought-lines into distinct categories, each distinct category having the same thought-line header.

3. The complete thought-lines in each distinct category are reordered by the user so that the complete thought-lines in each distinct category can be reordered by the user into a revised order while remaining in the same visually separated distinct category, thereby organizing the thoughts and ideas of the user.

The thought-line header summarizes or defines the content of the associated thought-line, similar to the way that a descriptive title identifies the content that follows the descriptive title. The descriptive nature of the thought-line header may use header word(s) that have a specific well-understood meaning to many users, or the header word(s) may have specific meaning only to a particular user.

The thought-line header is differentiated in appearance from the thought-line in a manner that emphasizes the thought-line header compared to the thought-line. Examples of differentiation that emphasizes the thought-line header compared to the thought-line include bolded vs. not bolded, uppercase vs. lowercase, underlined vs. not underlined, and larger font vs. smaller font.

The process of displaying the complete thought-lines on a single screen allows the user to quickly and easily identify and prioritize the entries. The process is unlike a “to-do” list or task list because, among other reasons, such lists do not have the concept of a thought-line header and a separate thought-line, or the concept of an organizational header and a thought-line header and a separate thought-line.

### DETAILED DESCRIPTION OF THE INVENTION

Certain terminology is used herein for convenience only and is not to be taken as a limitation on the present invention.

This patent application includes an Appendix having a file named Appendix683928-9U1.txt, created on May 22, 2012, and having a size of 169,998 bytes. The Appendix is incorporated by reference into the present patent application. One preferred embodiment of the present invention is implemented via the source code in the Appendix. The Appendix is subject to the “Copyright Notice and Authorization” stated above.

One preferred embodiment of the present invention is described in the context of a service called Memory on Demand® commercialized by Memory on Demand, LLC, West Chester, Pa. The present invention is used in conjunction with the software-driven process for creating the content, which are the thoughts and ideas of the user.

Each of the embodiments disclosed below displays previously entered items (e.g., complete thought-lines) to be compared directly next to each other so that the user can directly compare the items to each other. In this manner, the user never needs to rely upon their memory since the user is actually looking at the items that need to be compared.

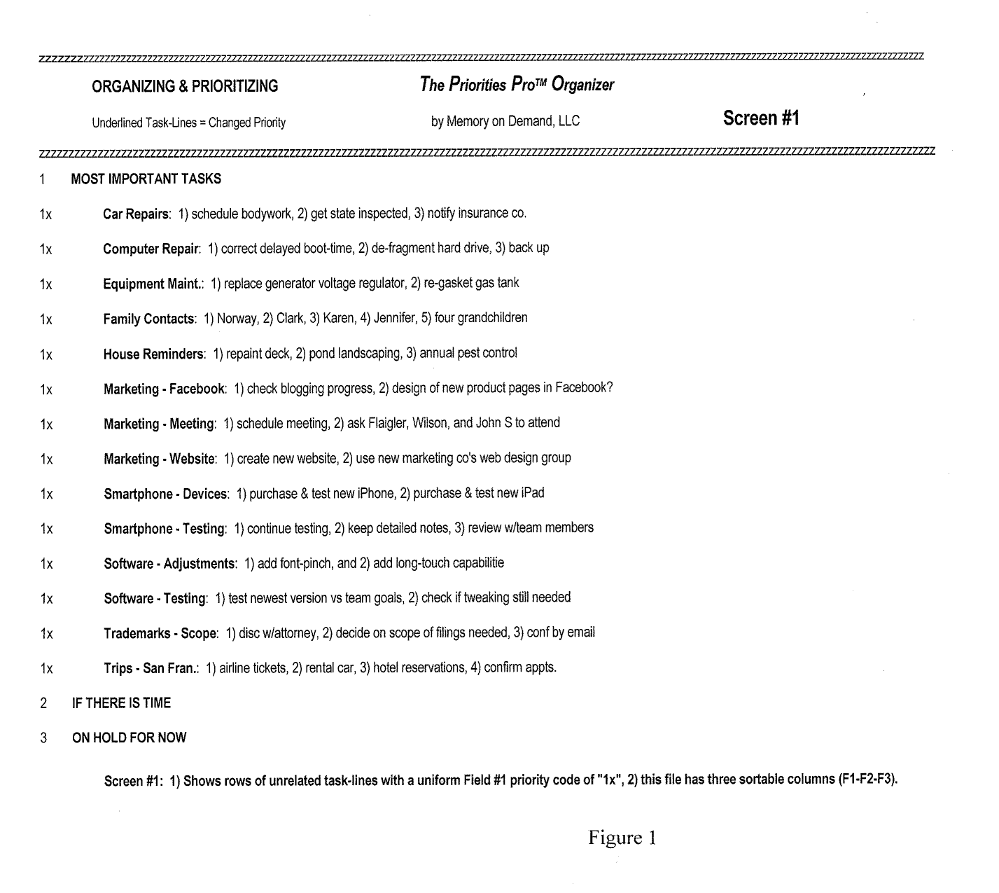

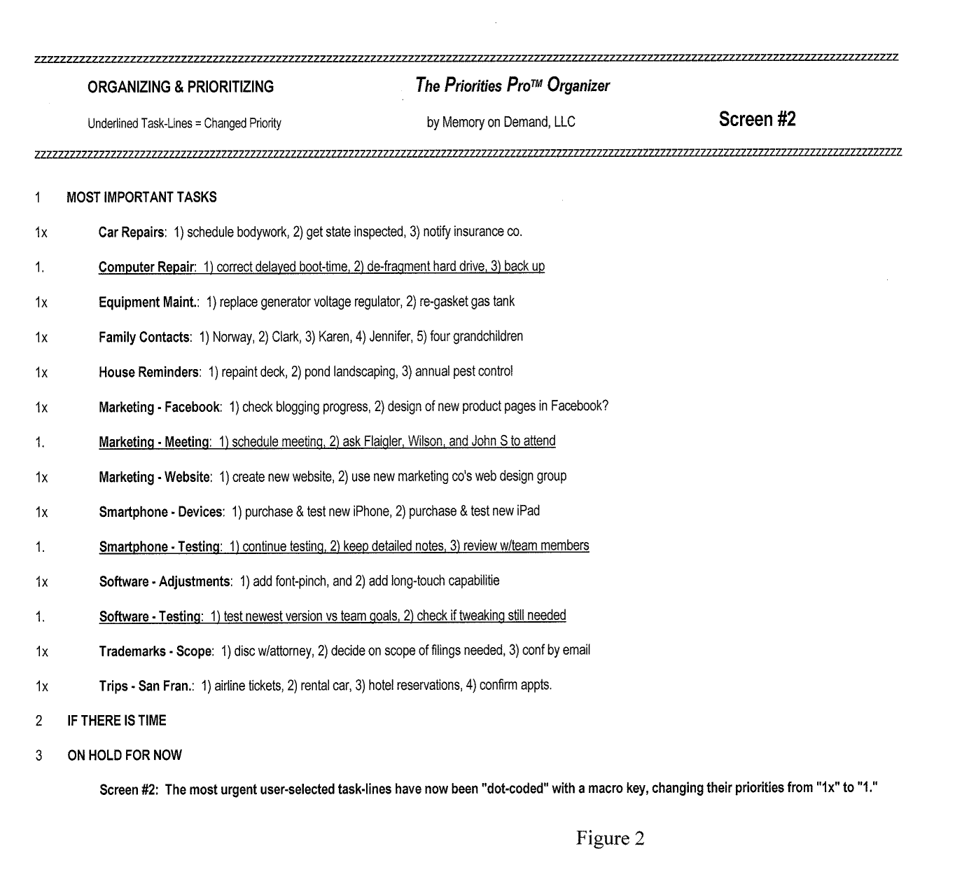

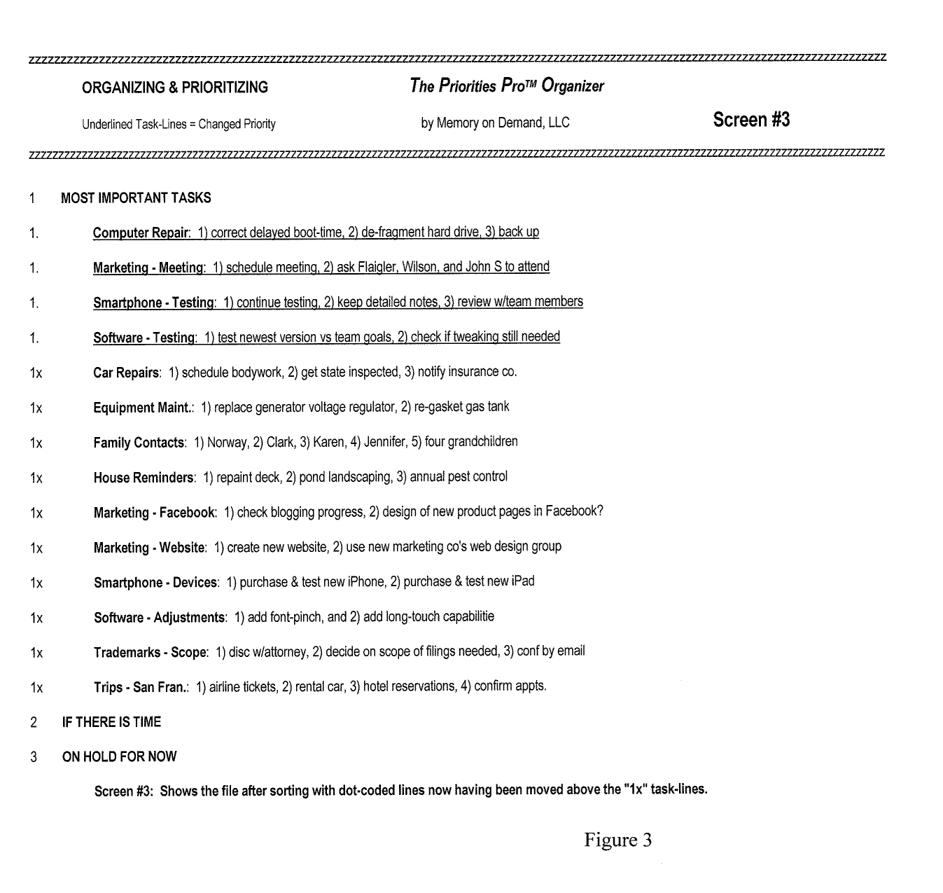

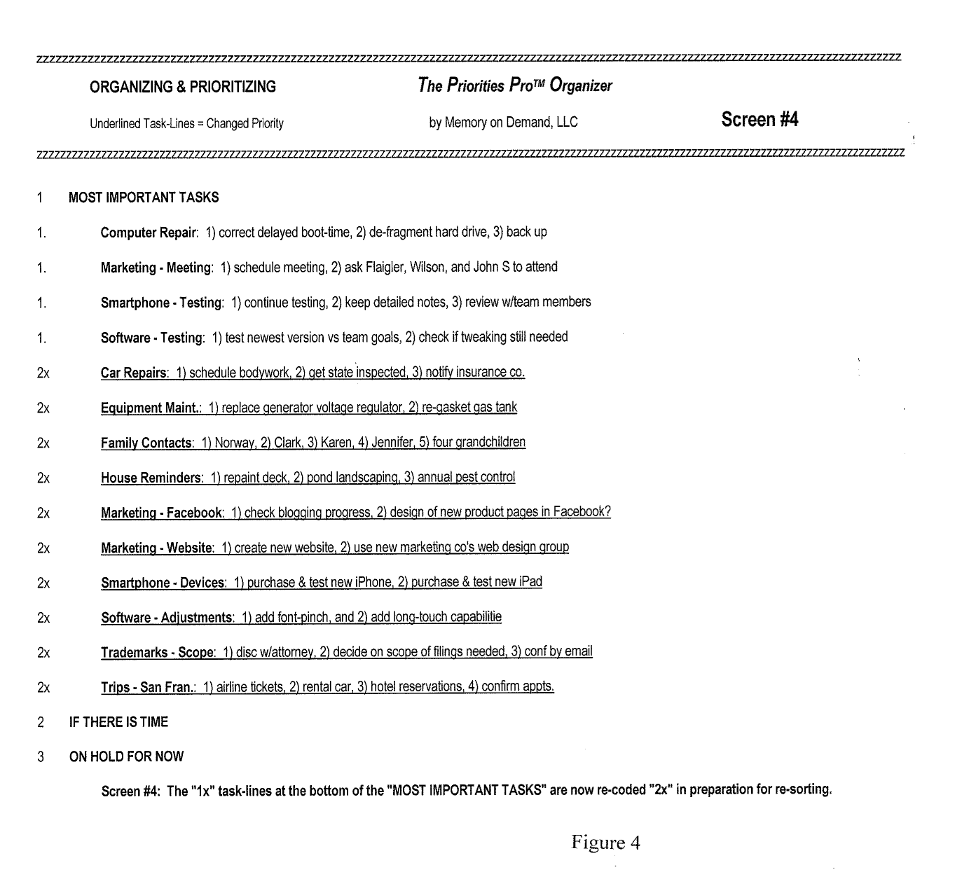

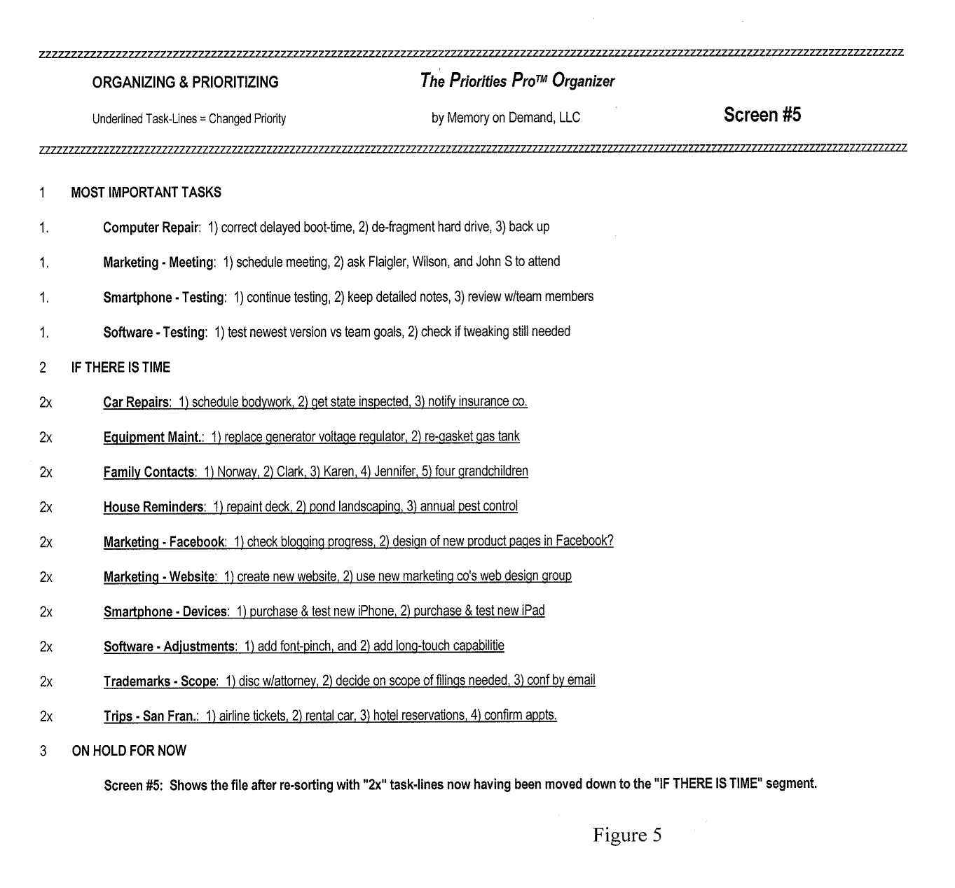

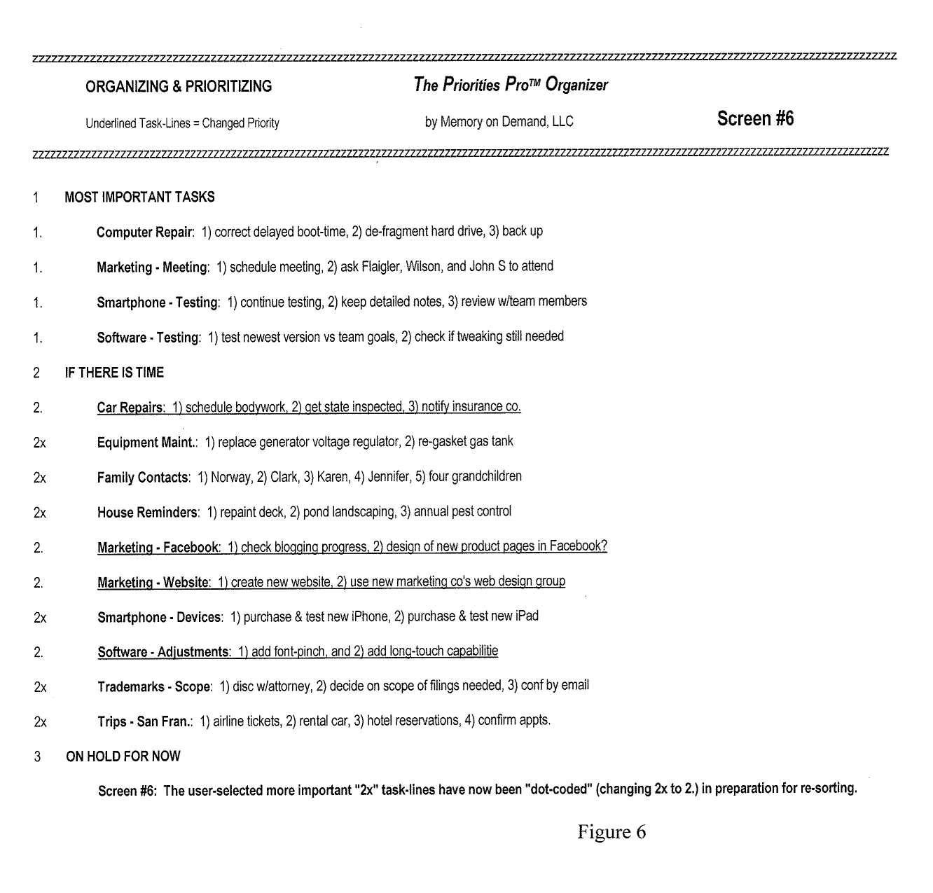

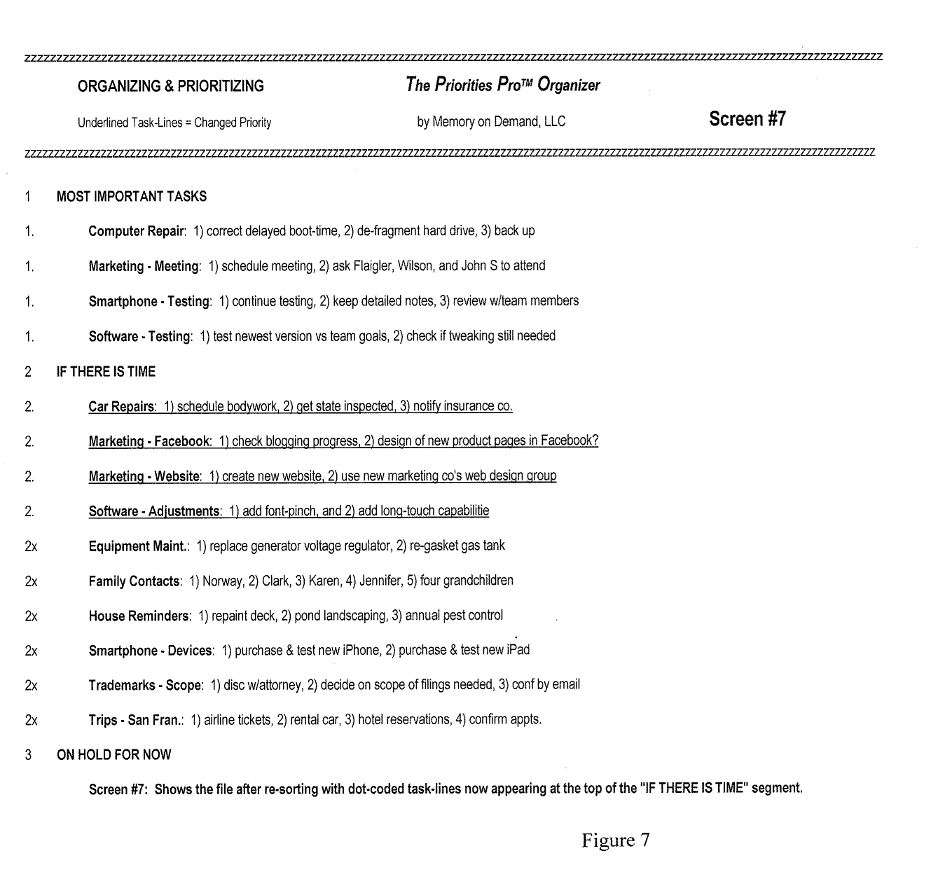

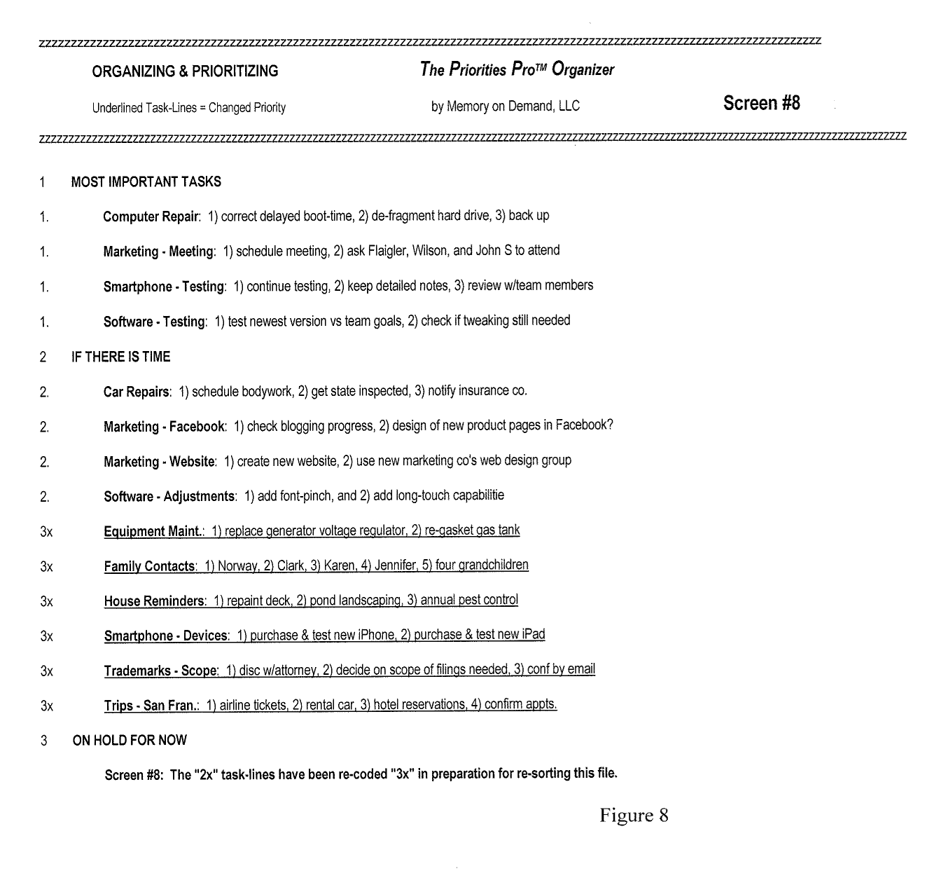

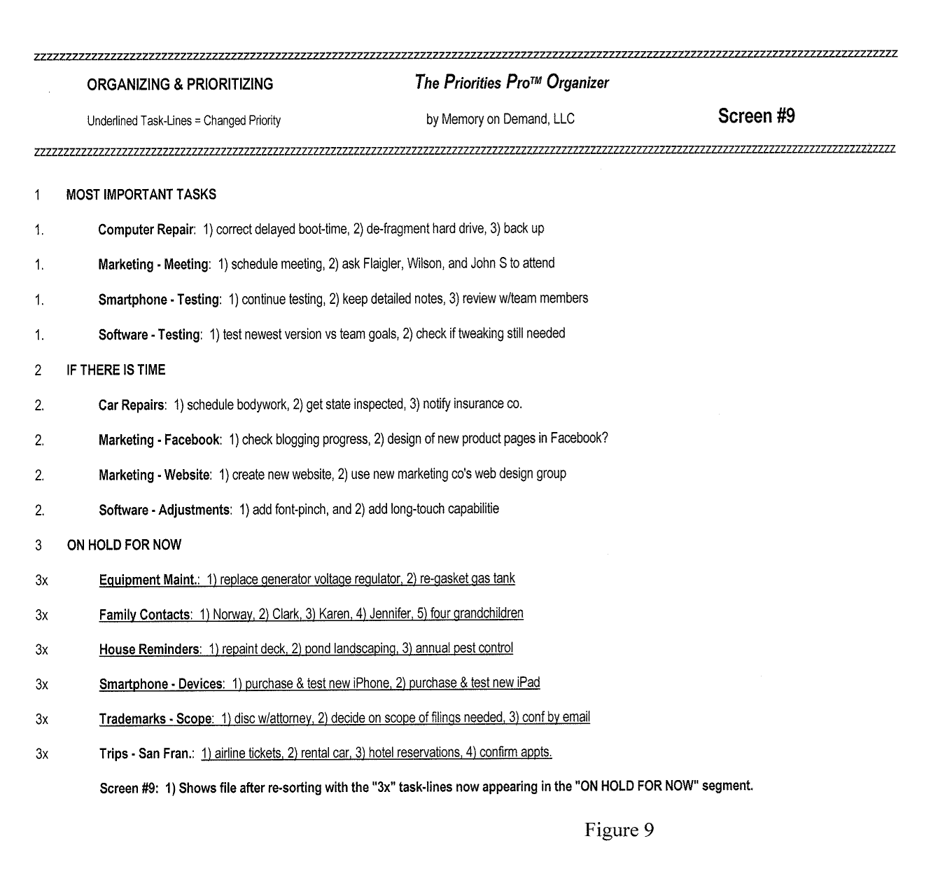

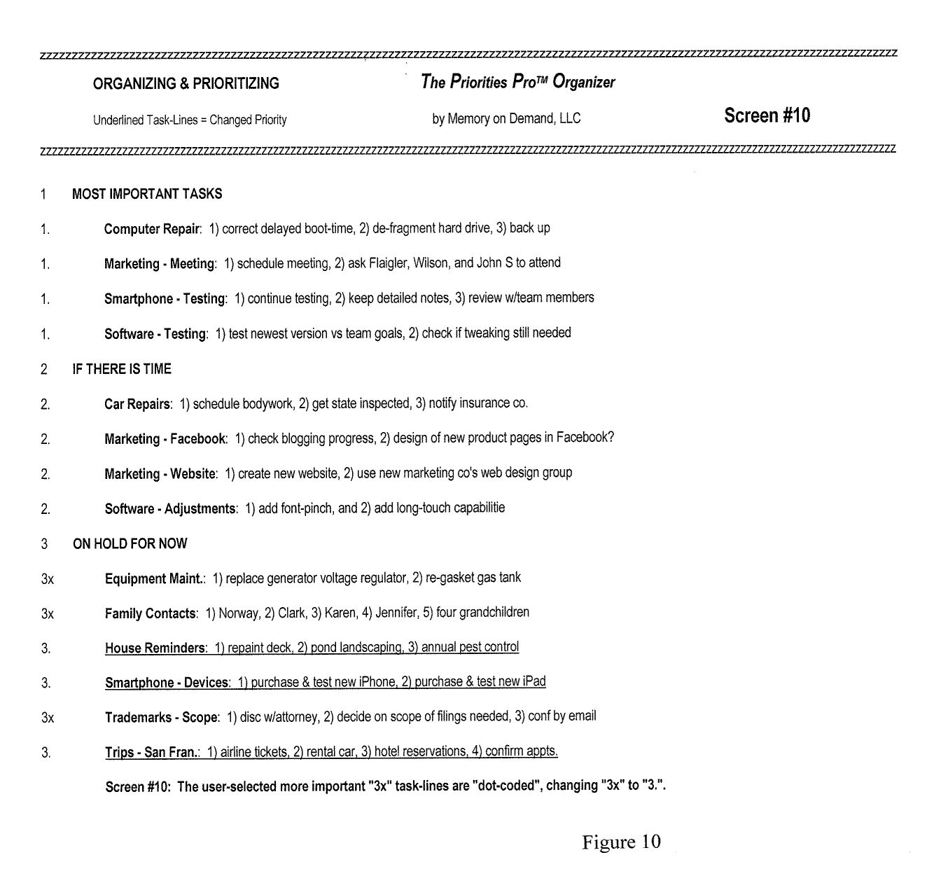

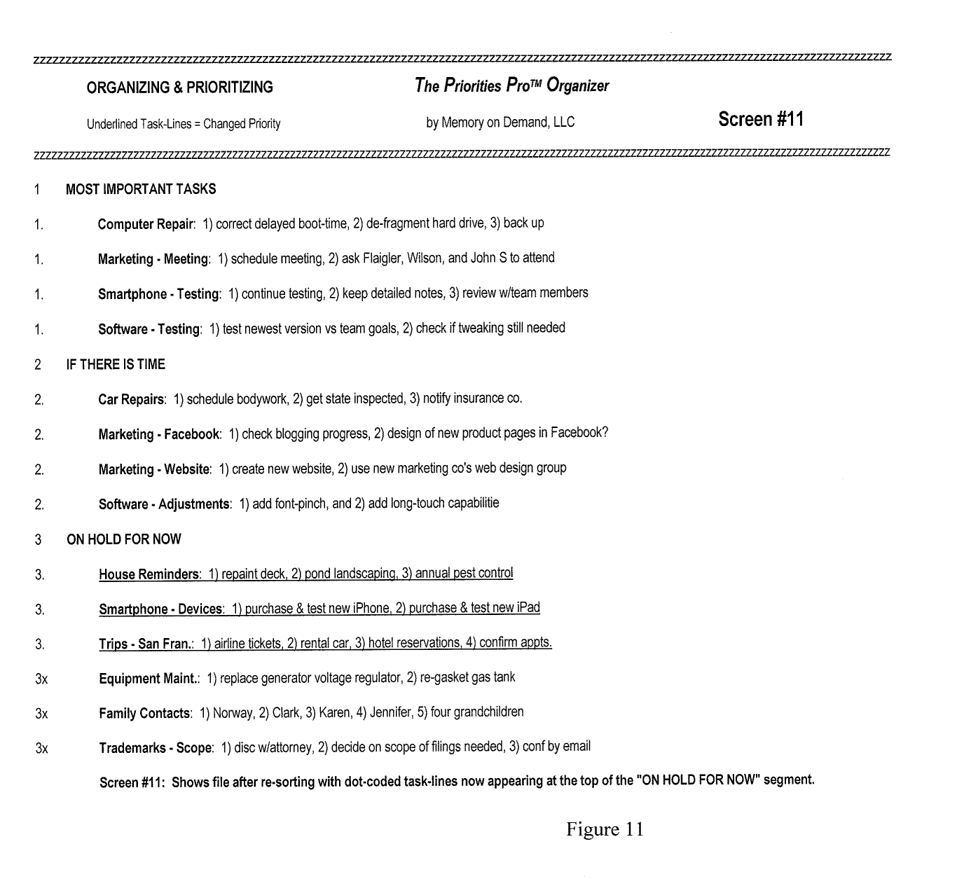

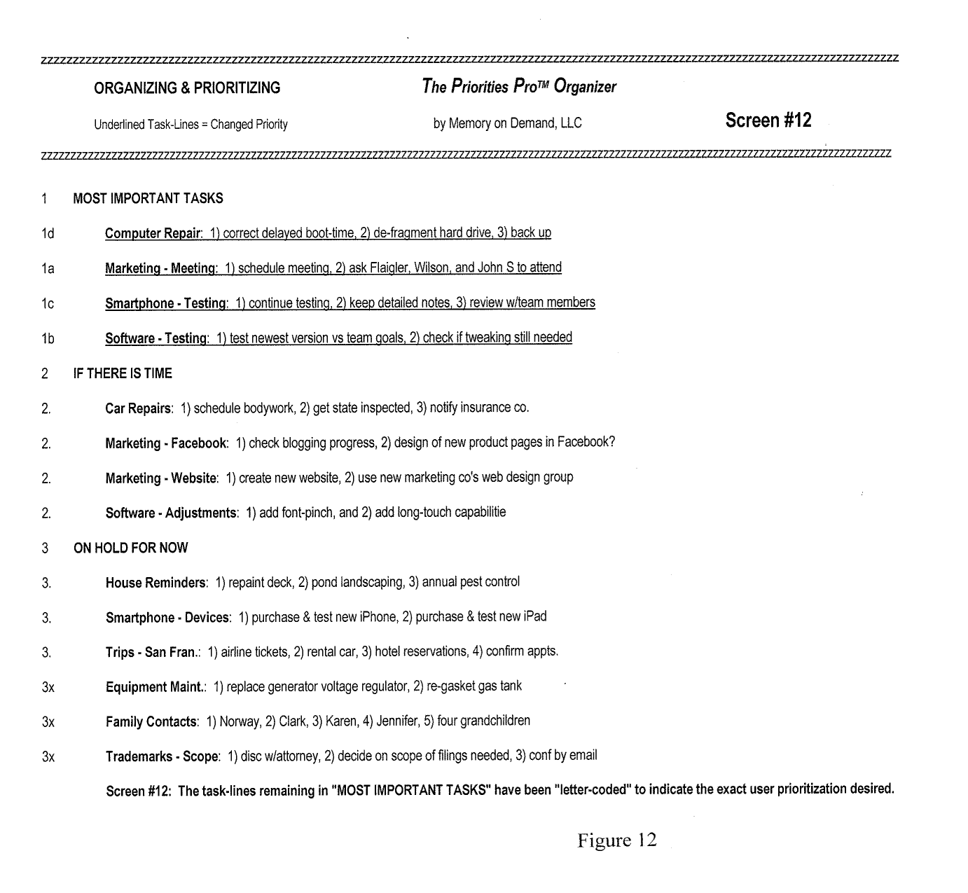

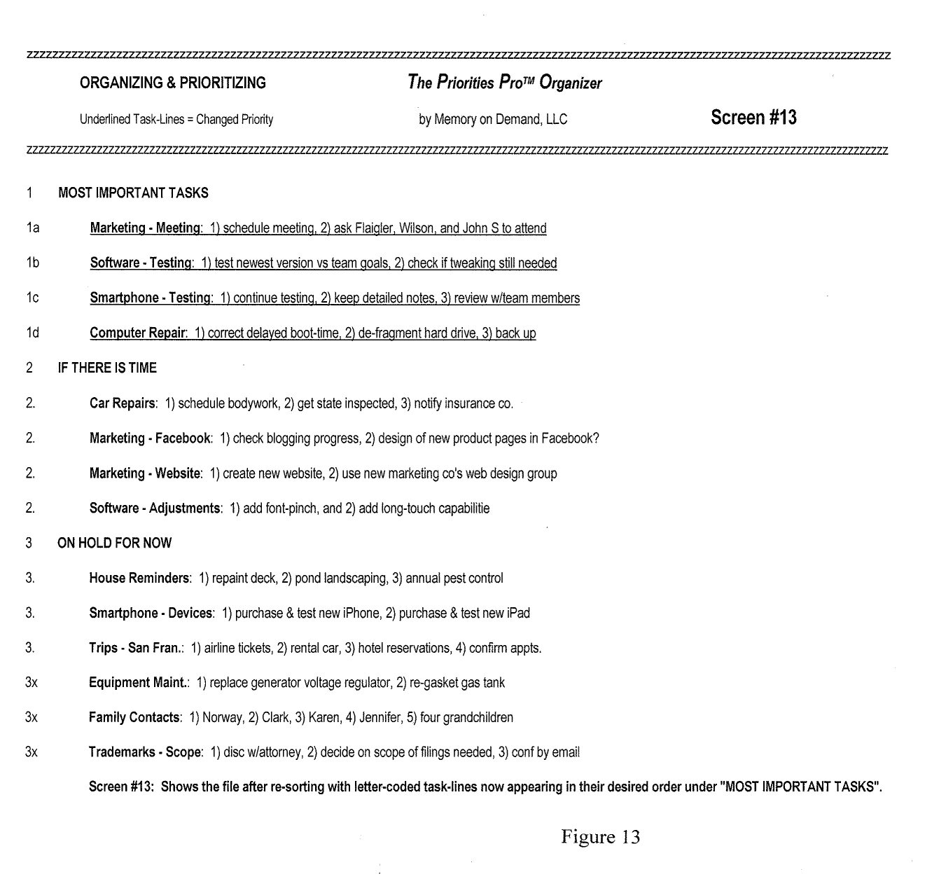

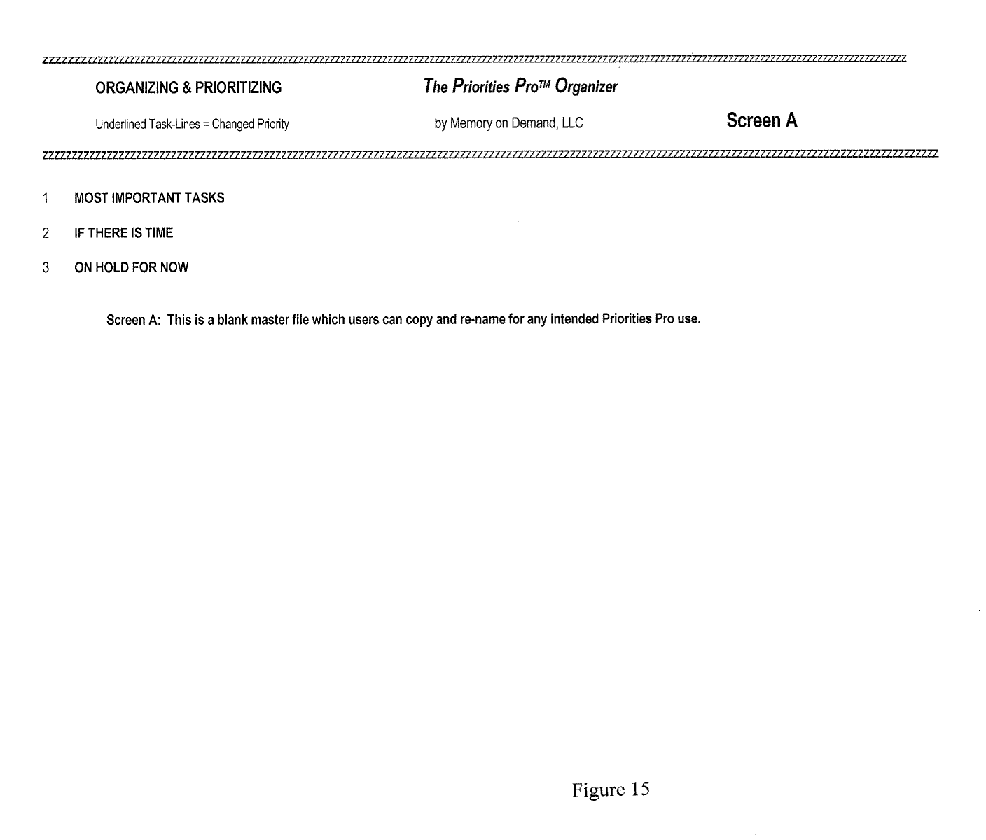

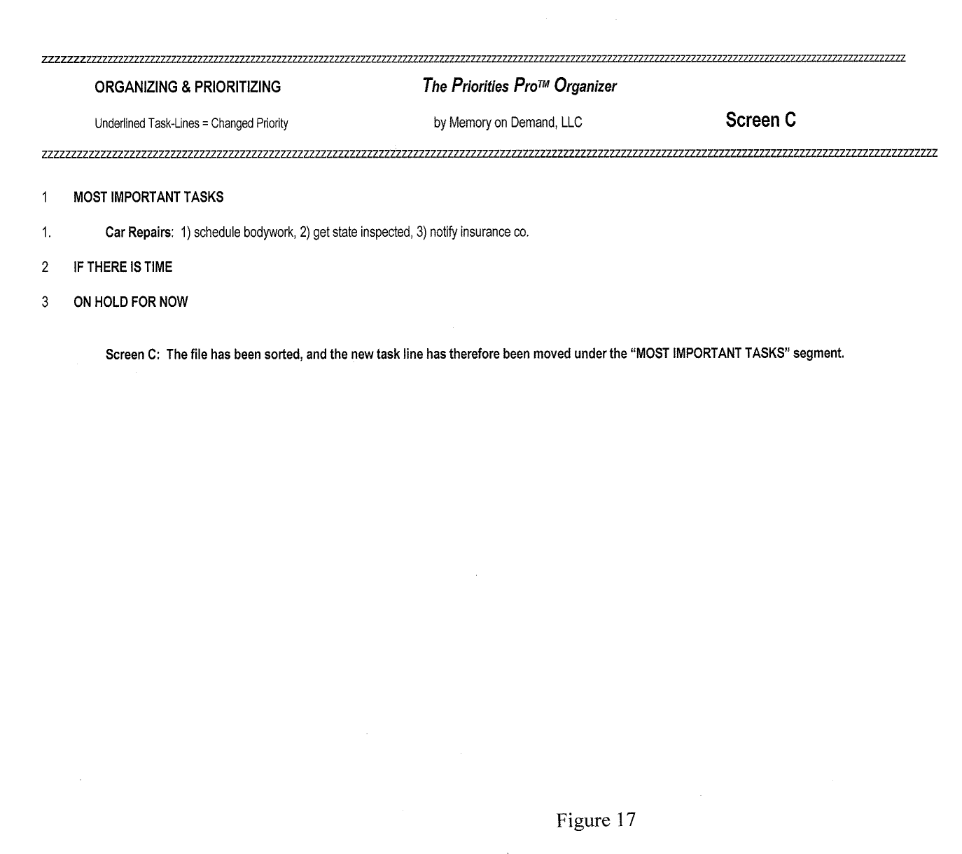

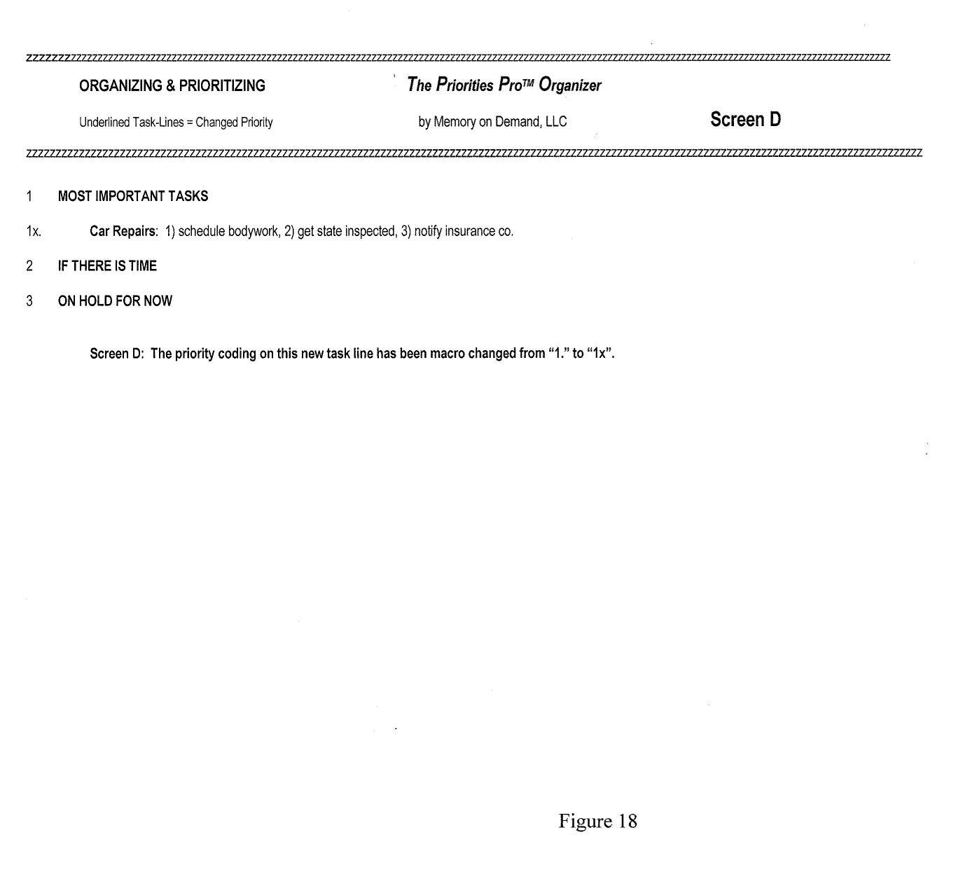

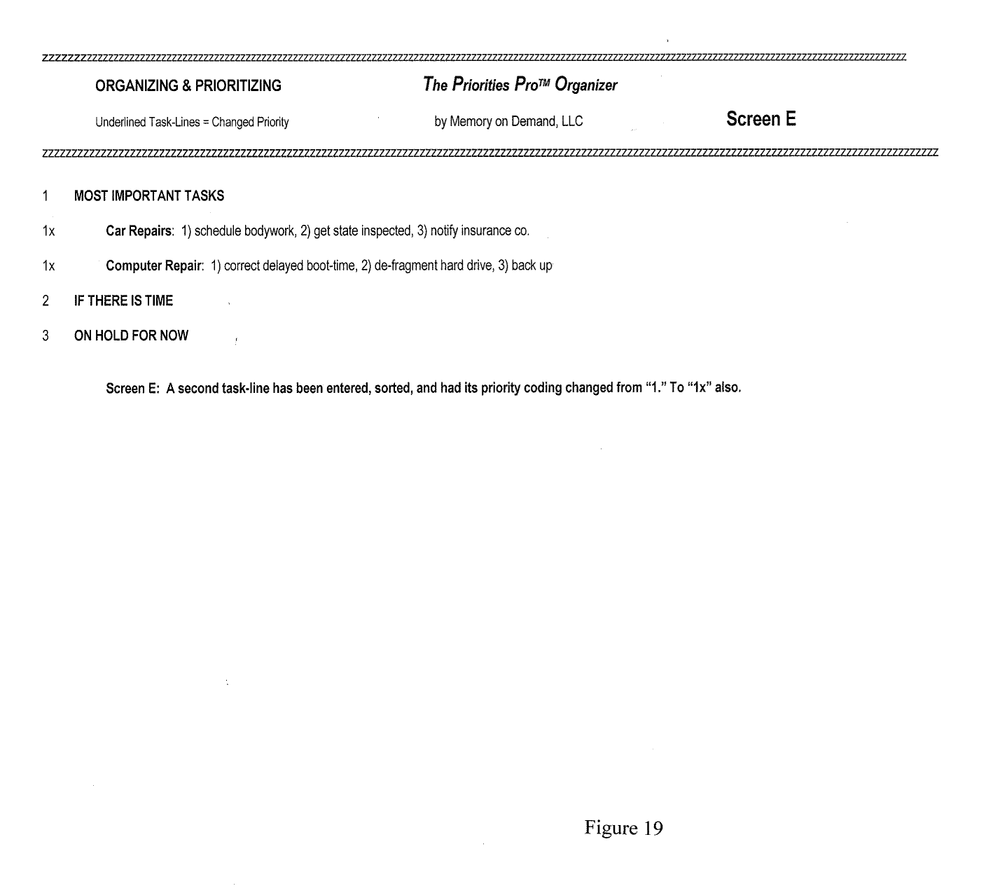

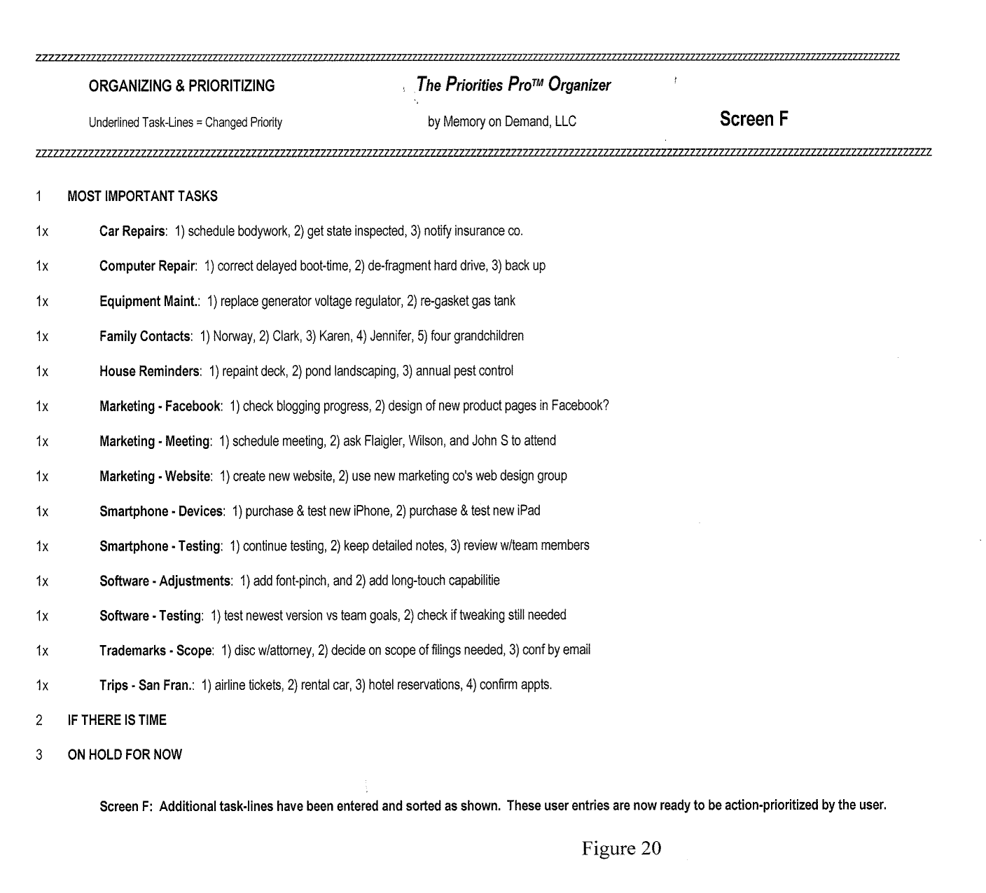

FIGS. 1-14 show a sample session in the form of 14 display screens that illustrate the mechanics of an exemplary organizing and priority process. FIGS. 15-20 show a sample session in the form of six display screens that illustrate the mechanics of how the display screen of FIG. 1 is created. The explanation of what is occurring with each display screen is provided at the bottom of each respective figure.

Referring to FIGS. 1 and 15, there are three organizational topic headings (Header 1), which may be generically referred to as Level #1 importance, Level #2 importance, and Level #3 importance. Referring to FIG. 1, there are 14 thought-line headers (Header 2) under the first organizational topic heading, and each thought-line header has an associated thought-line (thought). The alphanumeric numbers on the left hand side of each page are associated with a single column used for sorting, also referred to below as “column 1.”

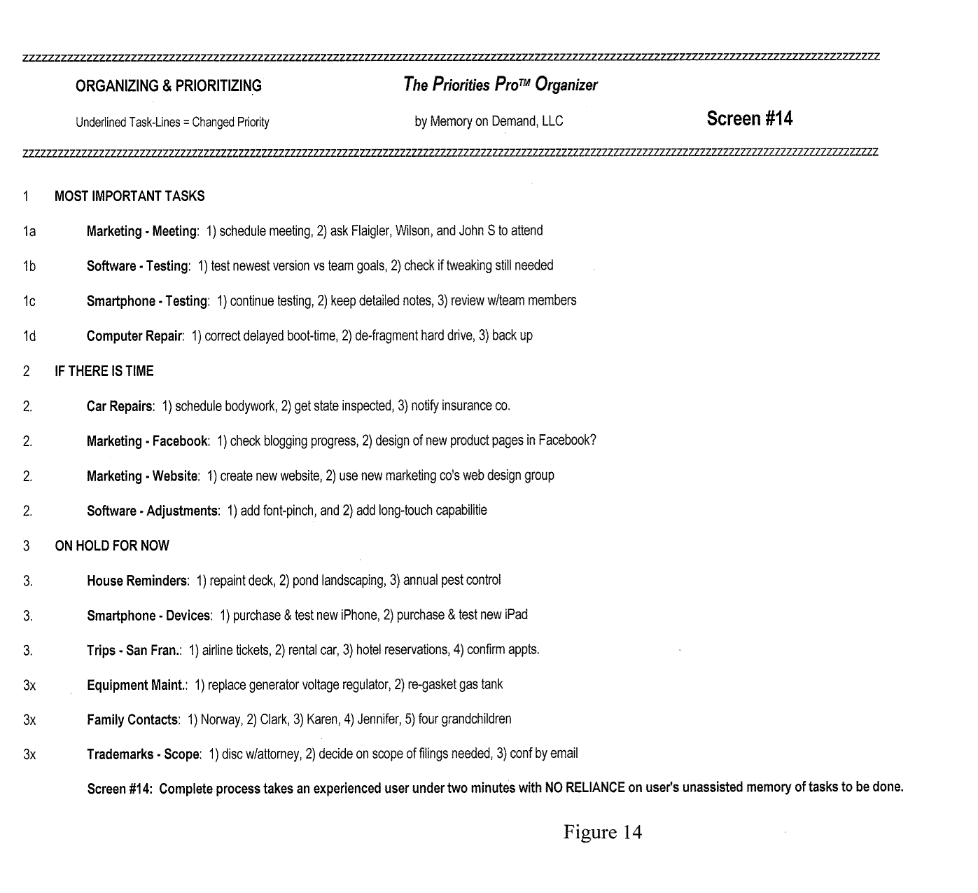

In one preferred embodiment, thought-line headers and their corresponding thought-lines may be moved to different organizational topic headings. For example, in FIGS. 1-14, the user ultimately provides only four thought-line headers and their corresponding thought-lines for the first two organizational topic headings (“MOST IMPORTANT TASKS” and “IF THERE IS TIME”) with the remaining ten thought-line headers and their corresponding thought-lines being placed under the third organizational topic heading (“ON HOLD FOR NOW”). See FIG. 14 which shows the final organized and prioritized listing of thought-line headers and their corresponding thought-lines. The user has complete discretion in deciding how many organizational topic headings should exist, as well as how many thought-line headers and corresponding thought-lines should appear under each organizational topic heading in the finalized listing.

The underlining that appears in FIGS. 1-13 has been added for illustration purposes only and does not actually appear on the display screen. The underlining highlights those thought-line headers and thought-lines that are being currently manipulated or focused on by the user.

In FIGS. 1-20, the entire contents of the display screen is visible on one page. However, the amount of content that is visible on a display screen will depend upon the font size and area of the display screen. Scrolling may be necessary to view the entire display screen.

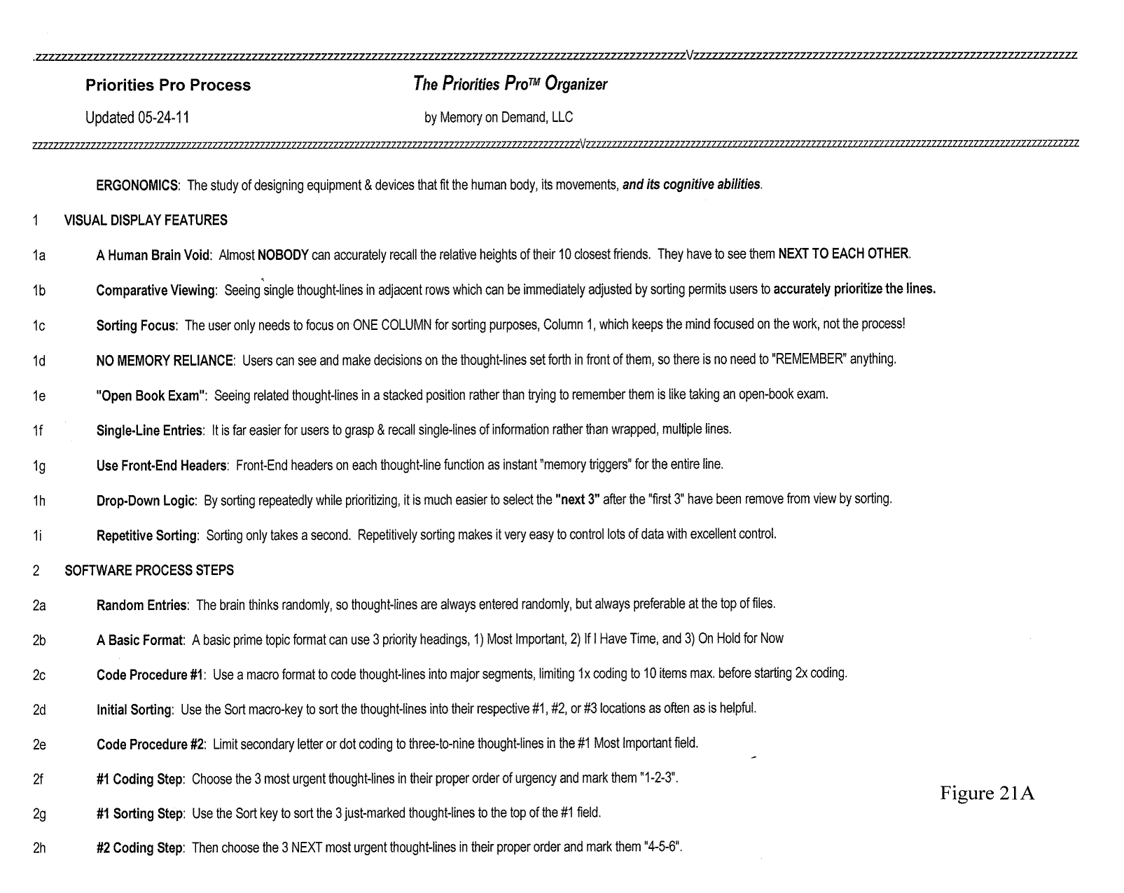

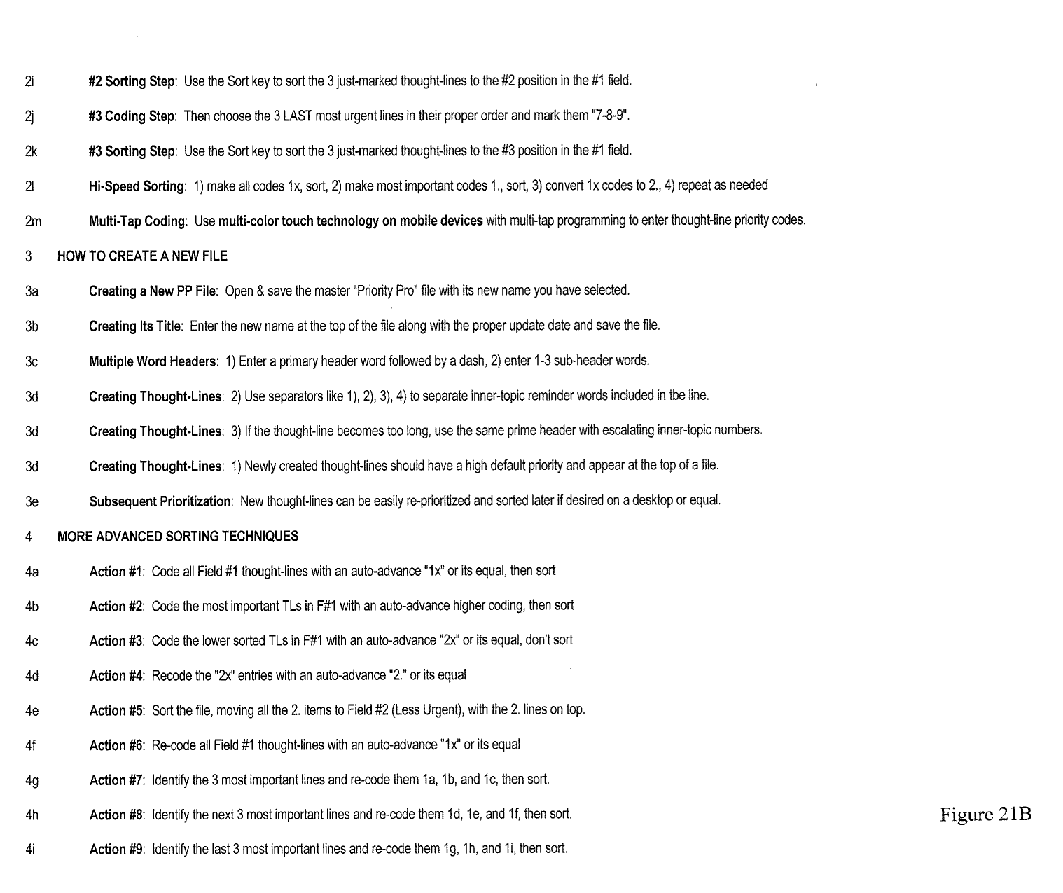

In another preferred embodiment, the organizational topic headings are not priority-based, and thus thought-line headers and their corresponding thought-lines are not moved to different organizational topic headings during the organizing and prioritizing process. FIGS. 21A-21B, taken together, show a display screen for a completed session of this nature.

Ergonomics is the study of designing equipment and devices that fit the human body, its movements, and its cognitive abilities. Preferred embodiments of the present invention rely on various visual display features to take maximum advantage of a user's cognitive abilities.

The following visual display concepts are used in preferred embodiments of the present invention:

a. Human Brain Void: Very few people can accurately recall the relative heights of their closest ten friends. They have to see them next to each other. As discussed below, thought-line headers are visually displayed next to each other so that thoughts can be more easily prioritized.

b. Comparative Viewing: Seeing single thought-lines in adjacent rows which can be immediately adjusted by sorting permits users to accurately prioritize the thought-lines.

c. Sorting Focus: The user only needs to focus on one column for sorting purposes, namely, column 1, which keeps the mind focused on the work, not the process.

d. Open Book Exam: Seeing related thought-lines in a stacked position rather than trying to remember them is like taking an open-book exam.

e. Single-Line Entries: It is far easier for users to grasp and recall single lines of information rather than wrapped, multiple lines.

f. Use Front-End Headers (Thought-line Headers): Front-end headers on each thought-line functions as instant “memory triggers” for the entire line.

g. Drop-Down Logic: By sorting repeatedly while prioritizing, it is much easier to select the “next 3” after the “first 3” have been sorted out, leaving only the unprioritized lines to be considered by the user.

h. Repetitive Sorting: Sorting only takes a second. Repetitively sorting makes it very easy to control lots of data.

The following software process steps are used in preferred embodiments of the present invention, which is referred to as the “Priority Pro™ (PP) process or Priorities Pro™ process:

a. Random Entries: The brain thinks randomly, so thought-lines are always entered randomly, but always preferable at the top of files.

b. A Basic Format: A basic prime topic format can use three priority headings, 1) Most Important, 2) If I Have Time, and 3) On Hold for Now

c. Code Procedure #1: Use a macro format to code thought-lines into major segments, limiting 1× coding to 10 items max. before starting 2× coding.

d. Initial Sorting: Use the Sort macro-key to sort the thought-lines into their respective #1, #2, or #3 locations as often as is helpful.

e. Code Procedure #2: Limit secondary letter or dot coding to three-to-nine thought-lines in the #1 Most Important field.

f. #1 Coding Step: Choose the three most urgent thought-lines in their proper order of urgency and mark them “1-2-3”.

g. #1 Sorting Step: Use the Sort key to sort the three just-marked thought-lines to the top of the #1 field.

h. #2 Coding Step: Then choose the three next most urgent thought-lines in their proper order and mark them “4-5-6”.

i. #2 Sorting Step: Use the Sort key to sort the three just-marked thought-lines to the #2 position in the #1 field.

j. #3 Coding Step: Then choose the three last most urgent lines in their proper order and mark them “7-8-9”.

k. #3 Sorting Step: Use the Sort key to sort the three just-marked thought-lines to the #3 position in the #1 field.

1. High Speed Sorting: 1) make all codes 1×, sort, 2) make most important codes 1., sort, 3) convert 1× codes to 2., 4) repeat as needed

m. Multi-Tap Coding: Use multi-color touch technology on mobile devices with multi-tap programming to enter thought-line priority codes.

A new file is created as follows, using the PP process:

a. Creating a New PP File: Open and save the master “Priority Pro” file with its newly selected name.

b. Creating Its Title: Enter the new name at the top of the file along with the proper update date and save the file.

c. Multiple Word Headers: 1) Enter a primary header word followed by a dash, 2) enter 1-3 sub-header words.

d1. Creating Thought-lines: 2) Use separators like 1), 2), 3), 4) to separate inner-topic reminder words included in the line.

d2. Creating Thought-lines: 3) If the thought-line becomes too long, use the same prime header with escalating inner topic numbers.

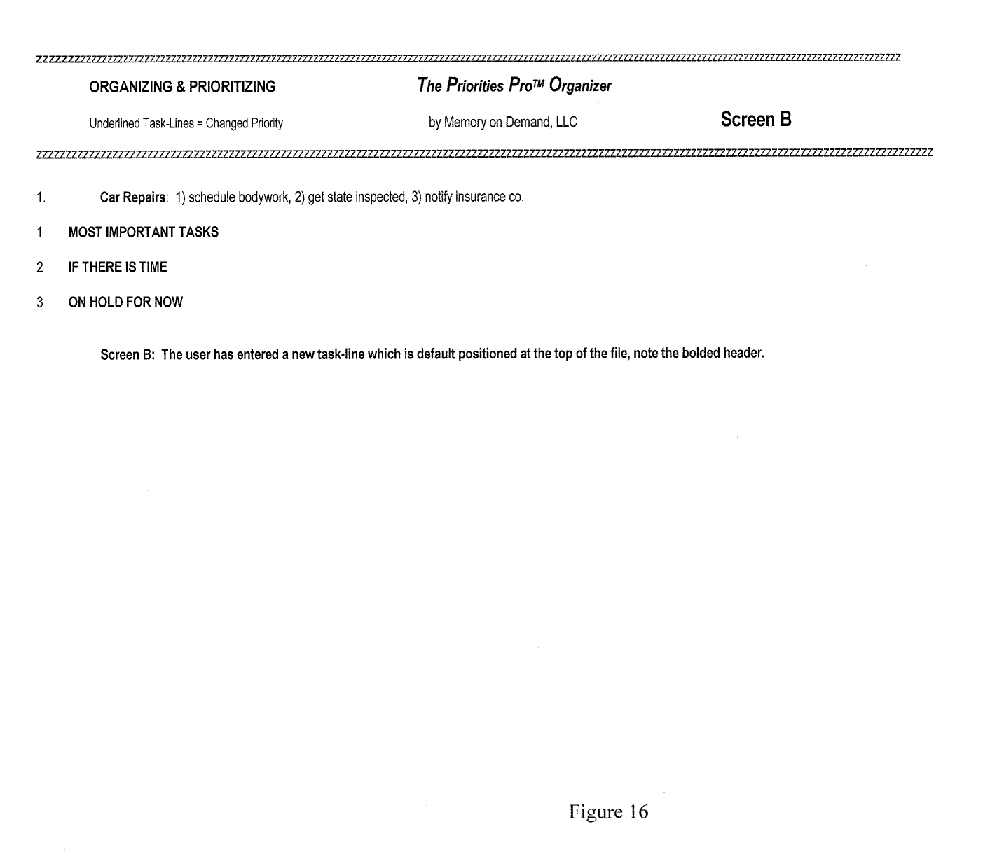

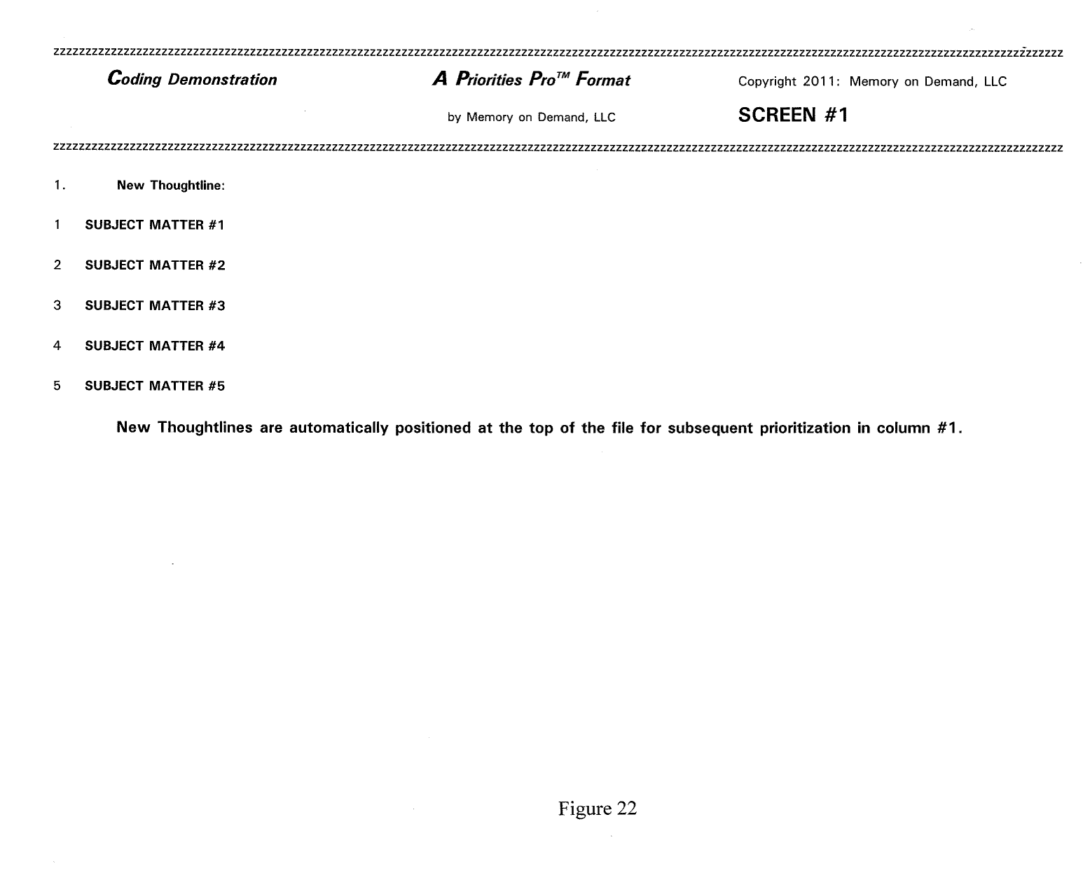

d3. Creating Thought-lines: 1) Newly created thought-lines should have a high default priority and appear at the top of a file. See, for example, FIGS. 16 and 22 where the new thought-line appears at the top of the file. The thought-line header is entered first, followed by the thought. For example, in FIG. 16, “Car Repairs” is the thought-line header, followed by the thought, “1) schedule bodywork. . . . ”

e. Subsequent Prioritization: New thought-lines can be easily re-prioritized and sorted later if desired on a desktop or the like.

More advanced sorting techniques are as follows:

a. Action #1: Code all Field #1 thought-lines with an auto-advance “1×” or its equal, then sort.

b. Action #2: Code the most important thought-lines in F#1 with an auto-advance higher coding, then sort.

c. Action #3: Code the lower sorted thought-lines in F#1 with an auto-advance “2×” or its equal, don't sort.

d. Action #4: Recode the “2×” entries with an auto-advance “2.” or its equal.

e. Action #5: Sort the file, moving all the 2. items to Field #2 (Less Urgent), with the 2. lines on top.

f. Action #6: Re-code all Field #1 thought-lines with an auto-advance “1×” or its equal.

g. Action #7: Identify the three most important thought-lines and re-code them 1a, 1b, and 1c, then sort.

h. Action #8: Identify the next three most important thought-lines and re-code them 1d, 1e, and 1f, then sort.

i. Action #9: Identify the last three most important thought-lines and re-code them 1g, 1h, and 1i, then sort.

In the example shown in FIGS. 1-20, selecting/sorting is done in groups of four, not three, as described above. Selecting/sorting in groups of three is most preferred. However, the scope of the present invention includes groups of numbers greater than three.

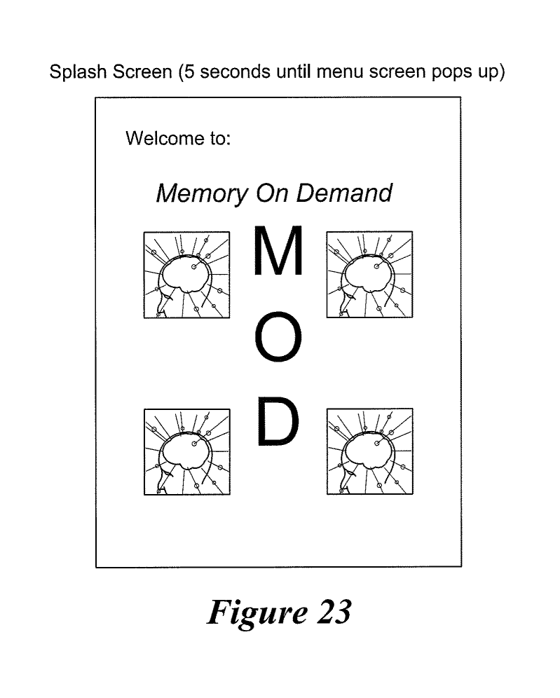

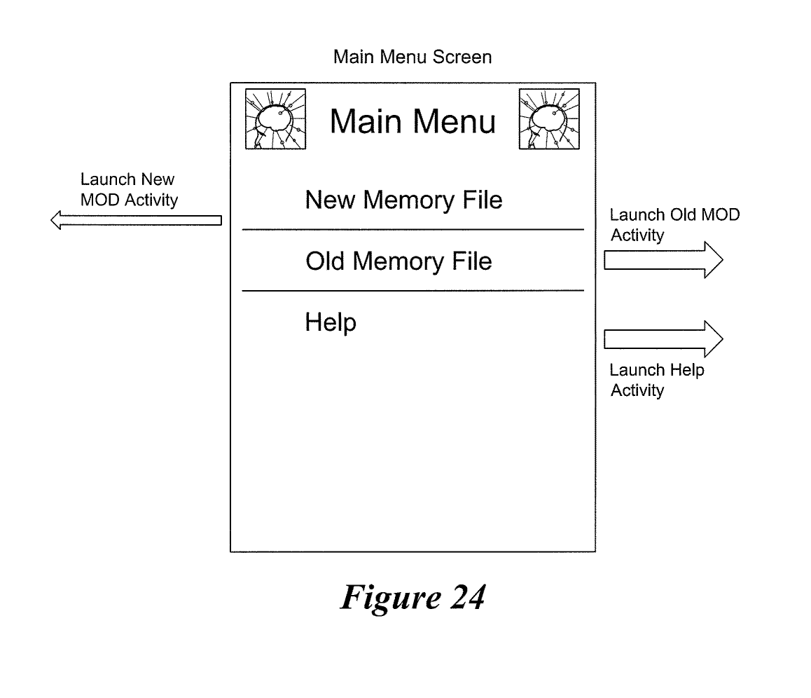

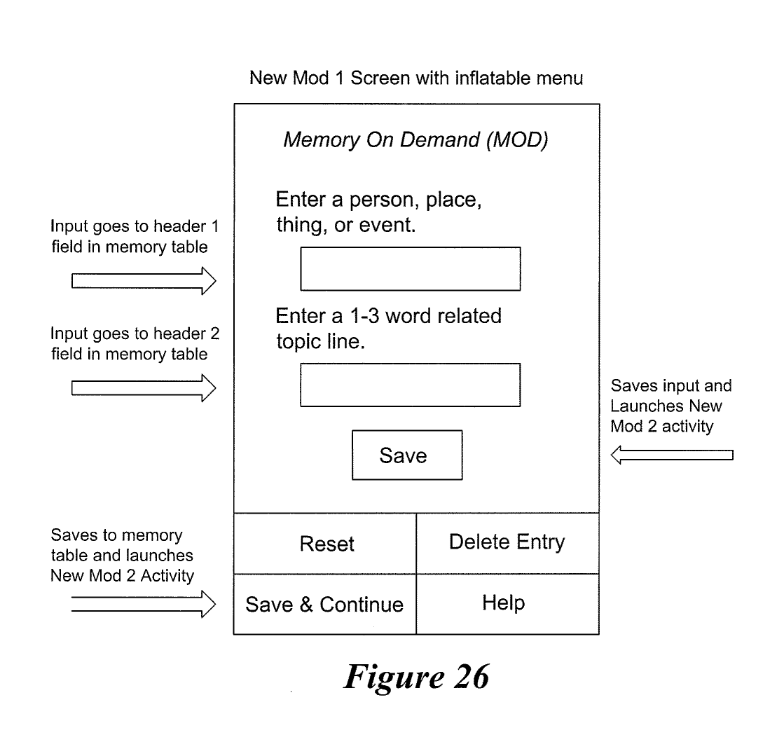

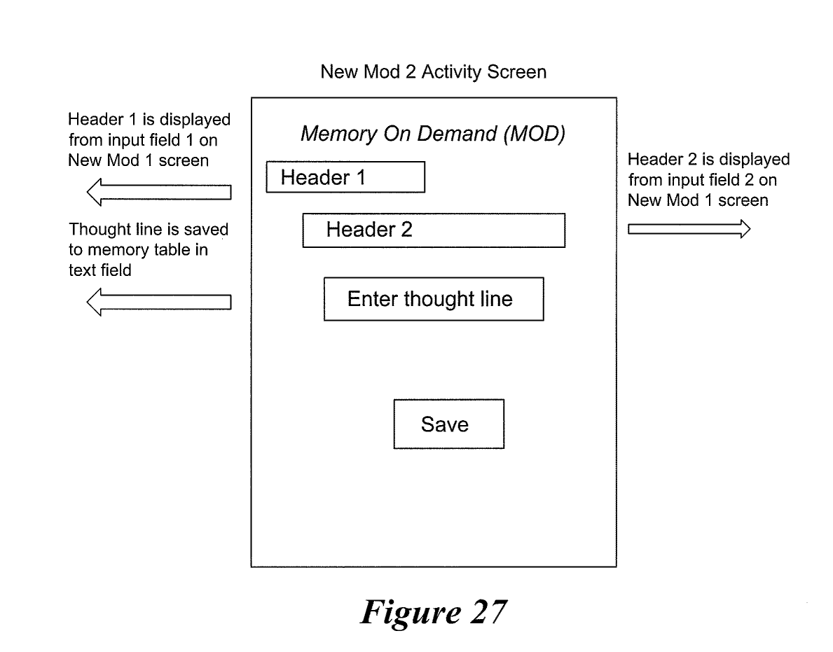

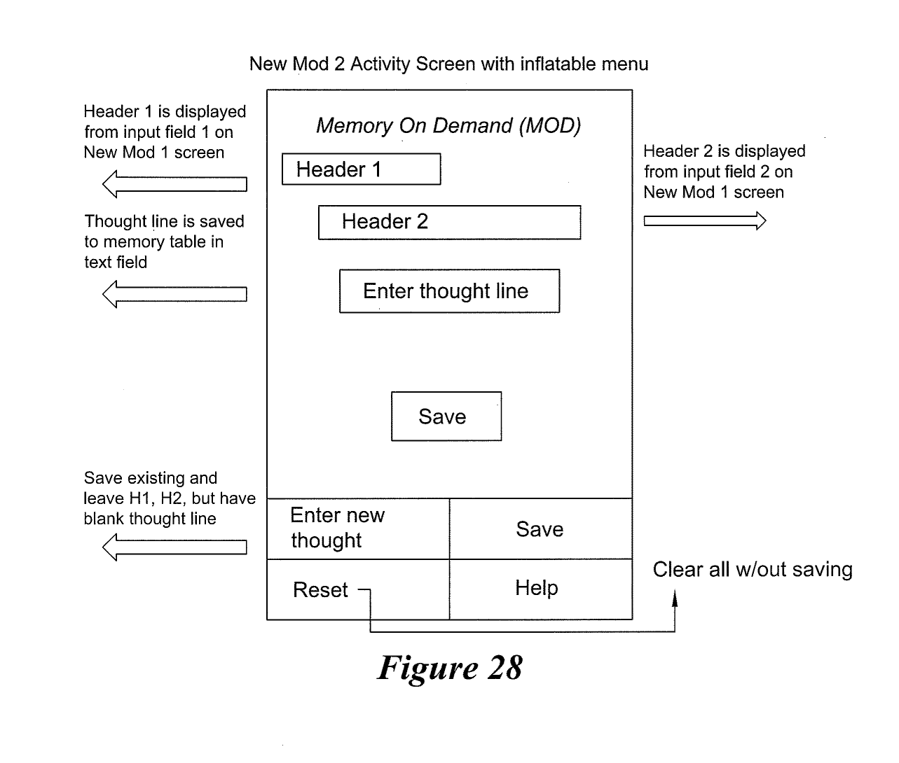

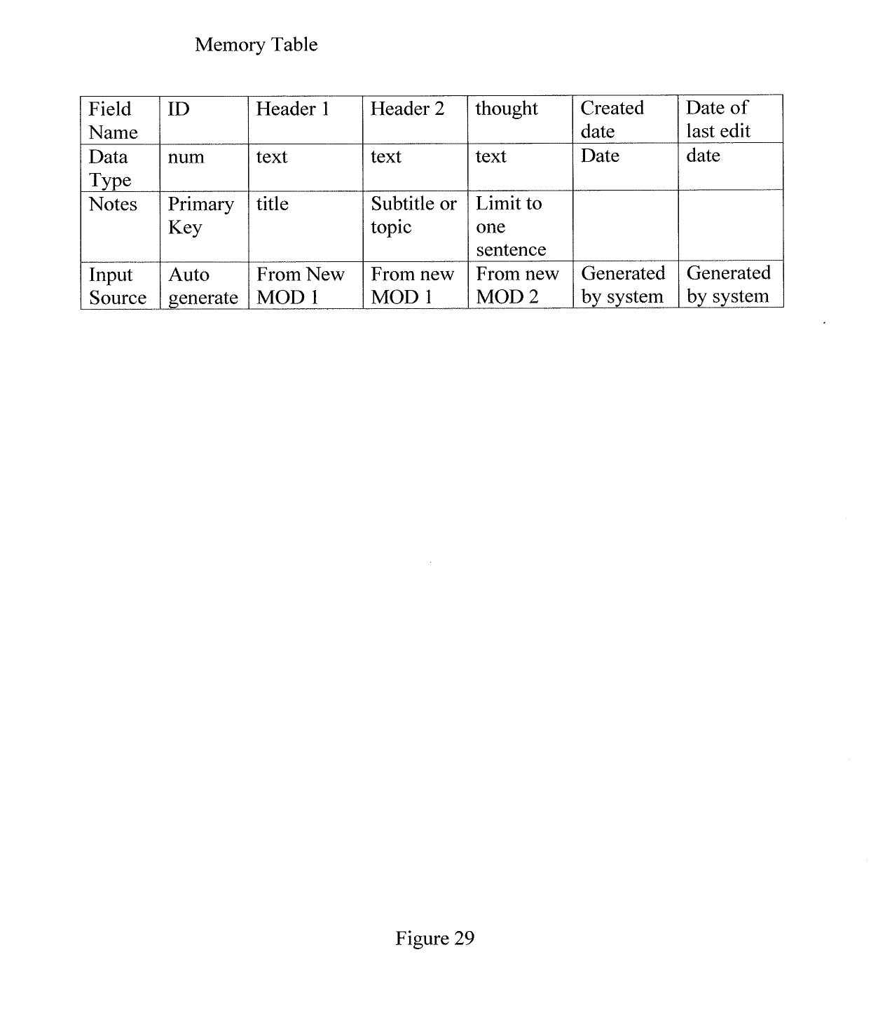

FIGS. 23-28 shows sample user interface display screens for inputting information that a user wishes to remember. FIG. 29 shows a memory table for storing the inputted information. One suitable database management system for the memory table is SQLite. The user interface display screens of FIGS. 23-28 can be associated with a smart phone application. In this embodiment, the information being inputted, including the thought-line, does not appear at the top of a file, as shown in FIGS. 16 and 22.

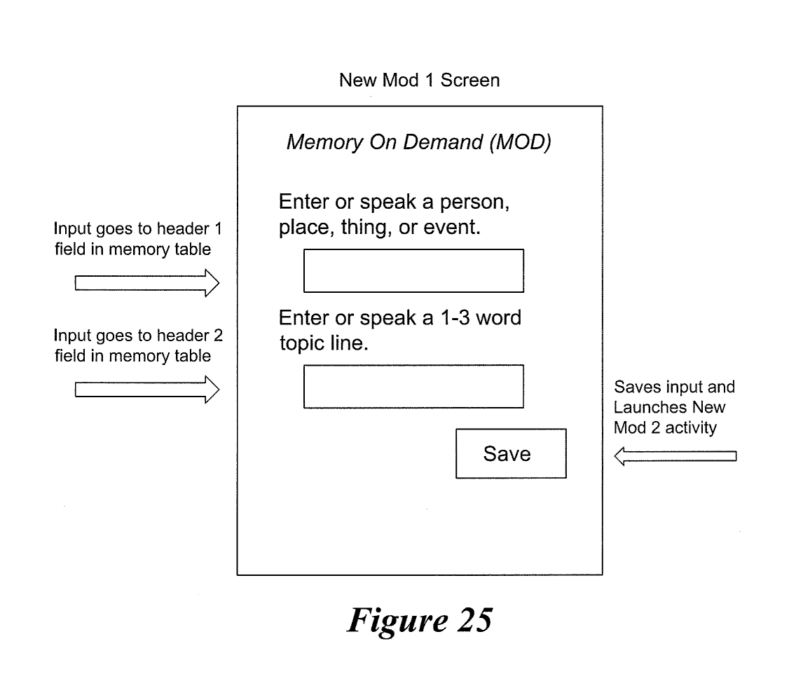

FIGS. 25-28 show inputting of an organizational topic heading (Header 1), a thought-line header (Header 2), and an associated thought-line (thought).

At any point in the process, a user may enter a search mode (not illustrated) and enter a search query into a search box to locate any previously entered information that matches the search query. The search query may be a word or phrase that appears in any portion of the inputted information (e.g., Header 1, Header 2 or a thought-line). The search query preferably specifies the portion of the inputted information to search on, but can also search on all portions, if desired.

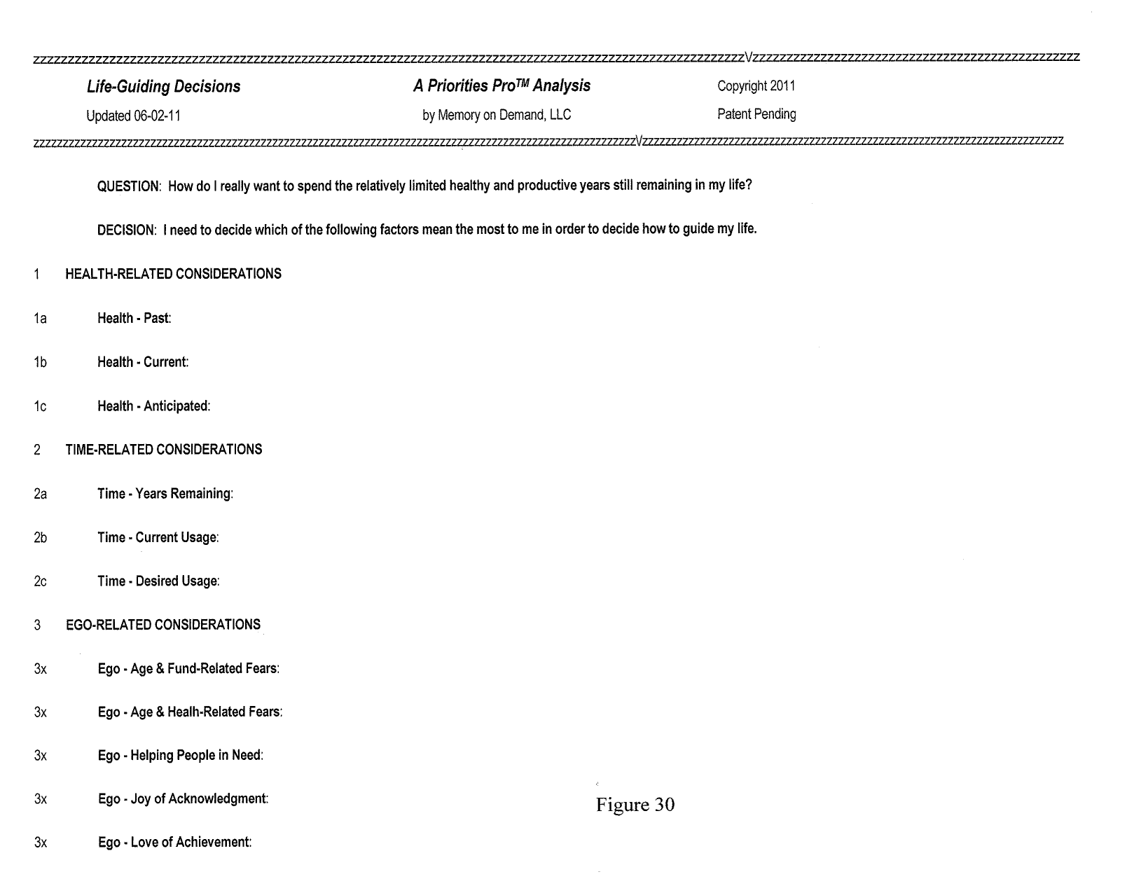

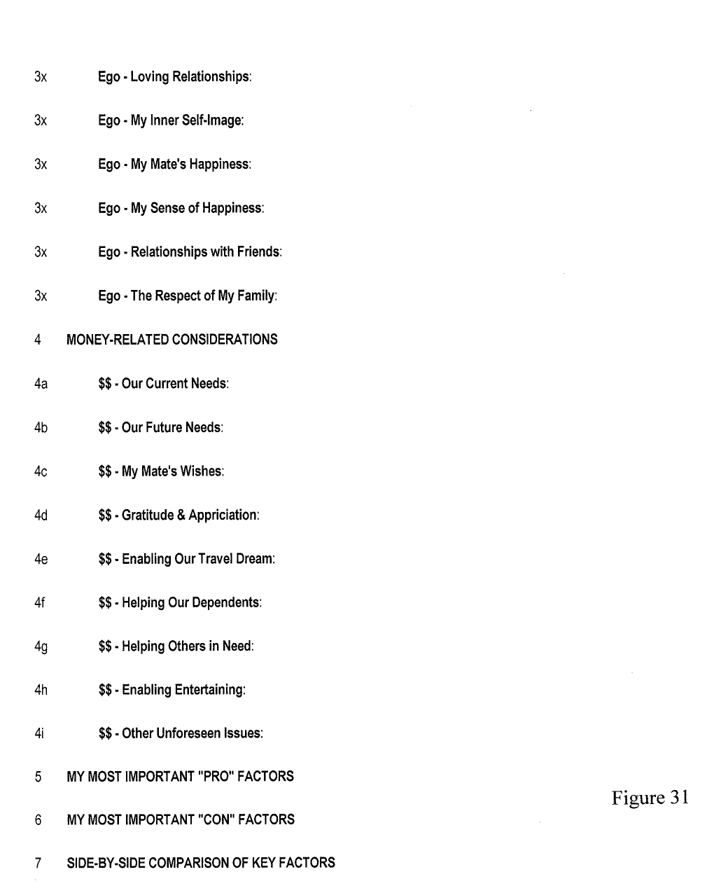

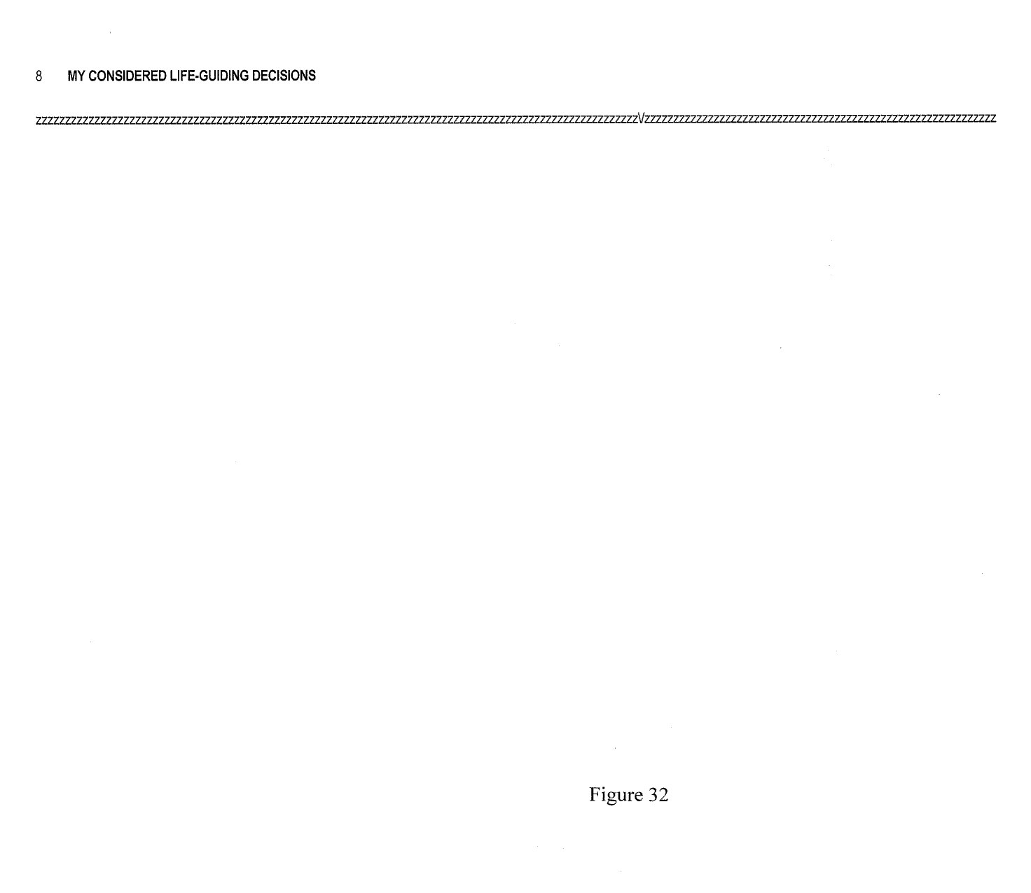

FIGS. 30-32 shows a header-guided embodiment of the present invention wherein pre-populated user interface display screens are provided for inputting information that a user wishes to remember. More specifically, Header 1 and Header 2 are pre-populated. The user provides any of the following inputs:

1. Thought-lines (thoughts) for any respective Headers 2 (thought-line headers) that the user wishes to enter.

2. Instructions to delete any of the Headers 1 and Headers 2 that the user does not wish to respond to or view on the display screen.

3. Insertion of additional Headers 1 and Headers 2 that the user wishes to add. The pre-populated Headers 1 and Headers 2 may provide suggested topics for the new Headers 1 and Headers 2.

4. Sorting/prioritizing instructions for the Headers 1 and Headers 2, either before or after respective thought-lines are added.

In FIGS. 30-32, the project or general topic is “Life-Guiding Decisions.” The project or general topic could be the name of a person, with Headers 1 and Headers 2 being aspects of the person that one wishes to explore. Any project or general topic can be created and pre-populated with appropriate Headers 1 and Headers 2.

Any suitable programming techniques may be used to manage the presentation of the demo page material so that they function in the manner shown in the demo pages. One preferred embodiment of the present invention illustrated herein uses word processing software in conjunction with a PC keyboard macro processor. The software may be executed on any suitable general-purpose computer, such as a personal computer running a Windows or Mac operating system or MS-DOS, or smart phone software, such as Android®.

Exhibit A is a printout of a macro program called X.MAC that may be used with the present invention. Exhibit B is a printout of the operator keyboard instructions for running the X.MAC program. In one preferred embodiment, the program executes in a general-purpose computer.

The present invention has been described in the context of a service called “Memory on Demand” which helps a user recall noteworthy information. However, features of the present invention may also be used in other contexts.

EXHIBIT B
ZZZZZZZZZZZZZZZZZZZZZZZZZZZZZZZZZZZZZZZZZZZZZZ
X.Mac = X.47 (Version 47)
zzzzzzzzzzzzzzzzzzzzzzzzzzzzzzzzzzzzzzzzzzzzzz

| .1 | Alt | + | 1 | Sorts 1-2-3 |
|---|---|---|---|---|
| .2 | Alt | + | Z | Sorts 2 & 1 |
| .3 | zzzzzzzzzzzzzzzzzzzzzzzzzzzzzzzzzzzzzz | | | |
| .4 | Shft | + | “1” | Code = 1x |
| .5 | Shft | + | “2” | Code = 2x |
| .6 | Shft | + | “3” | Code = 3x |
| .7 | Shft | + | “4” | Code = 4x |
| .8 | Shft | + | “5” | Code = 5x |
| .9 | Shft | + | “6” | Code = 6x |
| 10 | Shft | + | “7” | Code = 7x |
| 11 | Shft | + | “8” | Code = 8x |
| 12 | Shft | + | “9” | Code = 9x |
| 13 | TAB | | | Code = #. |
| 14 | zzzzzzzzzzzzzzzzzzzzzzzzzzzzzzzzzzzzzz | | | |
| 15 | Alt | + | Tab | Itali. Prod. Nms |
| 16 | Alt | + | 3 | Dt-Time Stamp |
| 17 | Ctrl | + | Pls | Response Lines |
| 18 | Cntr | | | Cursor 10 Lns |
| 19 | zzzzzzzzzzzzzzzzzzzzzzzzzzzzzzzzzzzzzz | | | |
| 20 | Alt | + | D | New entry @ 1. |
| 21 | Pls | | | Header & Save |
| 22 | Alt | + | A | Mem on Demand |
| 23a | Alt | + | 2 | Set 0.8-1.1 Tabs |
| 23b | Alt | + | 2 | Indent Sub-Lines |
| 24 | Alt | + | | WILD CARD |
| 25 | Ctrl | + | 3 | New F-P Hdr < < |
| 26 | Ctrl | + | 4 | New P-P Hdr < < |
| 27 | Alt | + | 4 | Hi-Low Hdrs < < |
| 28 | zzzzzzzzzzzzzzzzzzzzzzzzzzzzzzzzzzzzzz | | | |
| 29 | Alt | + | Num | Available combo |
| 30 | Ctrl | + | ~ | Available combo |
| 31 | Ctrl | + | 6 | Available combo |
| 32 | Ctrl | + | A | Available combo |
| 33 | Ctrl | + | Tab | Available combo |
| 34 | Shft | + | Del | Available Combo |
| 35 | Shft | + | Ins | Available combo |
| 36 | zzzzzzzzzzzzzzzzzzzzzzzzzzzzzzzzzzzzzz | | | |
| 37 | Alt | + | 1 | NOT available |
| 38 | Alt | + | End | NOT available |
| 39 | Alt | + | 3 | NOT Available |
| 40 | Ctrl | + | 1 | Erase line |
| 41 | Ctrl | + | 2 | Find/Erase III |
| 42 | Ctrl | + | 5 | NOT Available |
| 43 | Ctrl | + | 7 | NOT Available |
| 44 | Ctrl | + | 8 | NOT Available |
| 45 | Ctrl | + | 9 | NOT Available |

| | |
|---|---|
| 46 | zzzzzzzzzzzzzzzzzzzzzzzzzzzzzzzzzzzzzz |

END OF EXHIBIT B

Another preferred embodiment of the present invention is described in the context of a service called Focus GPS™ commercialized by Memory on Demand, LLC, West Chester, Pa. Three examples of this preferred embodiment are described below.

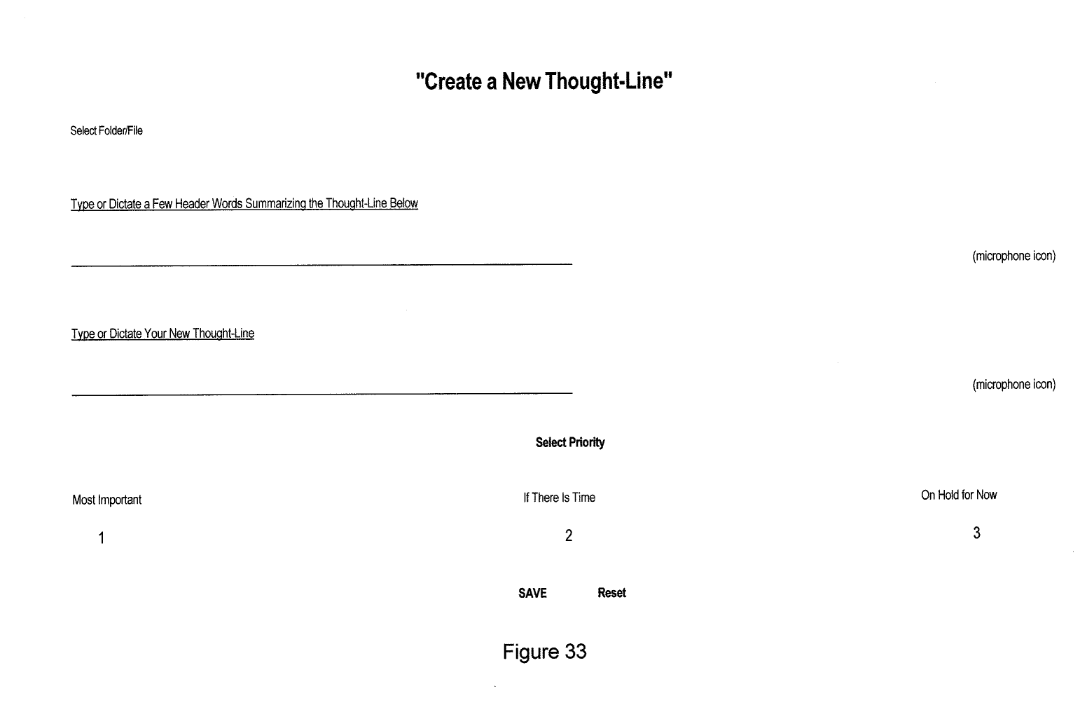

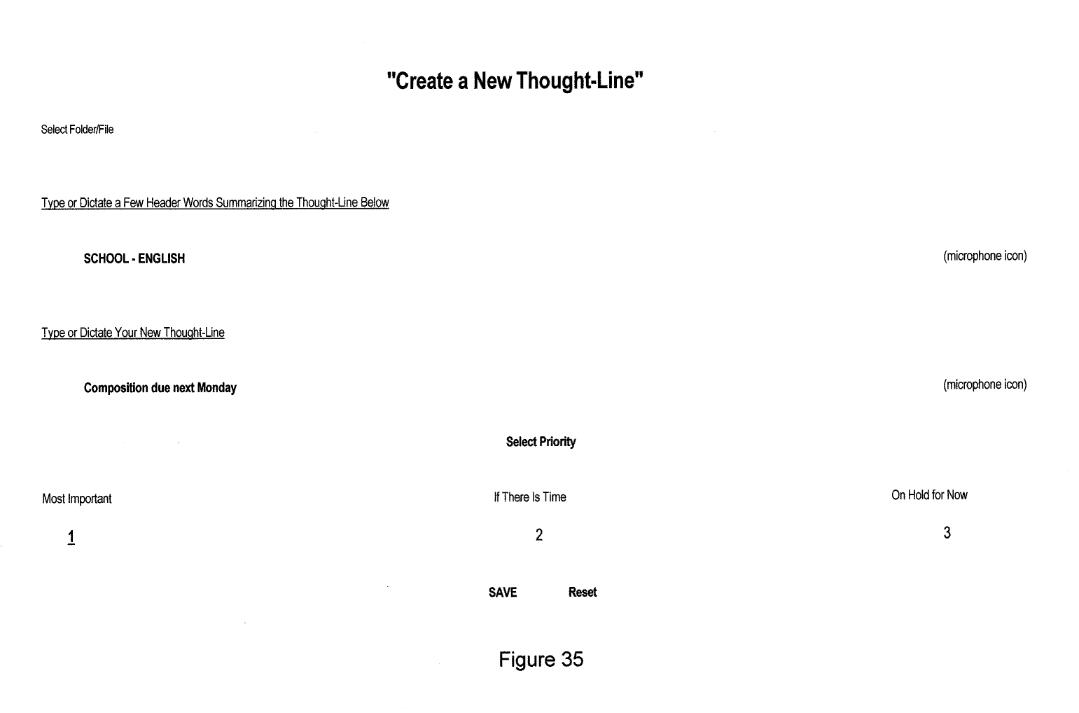

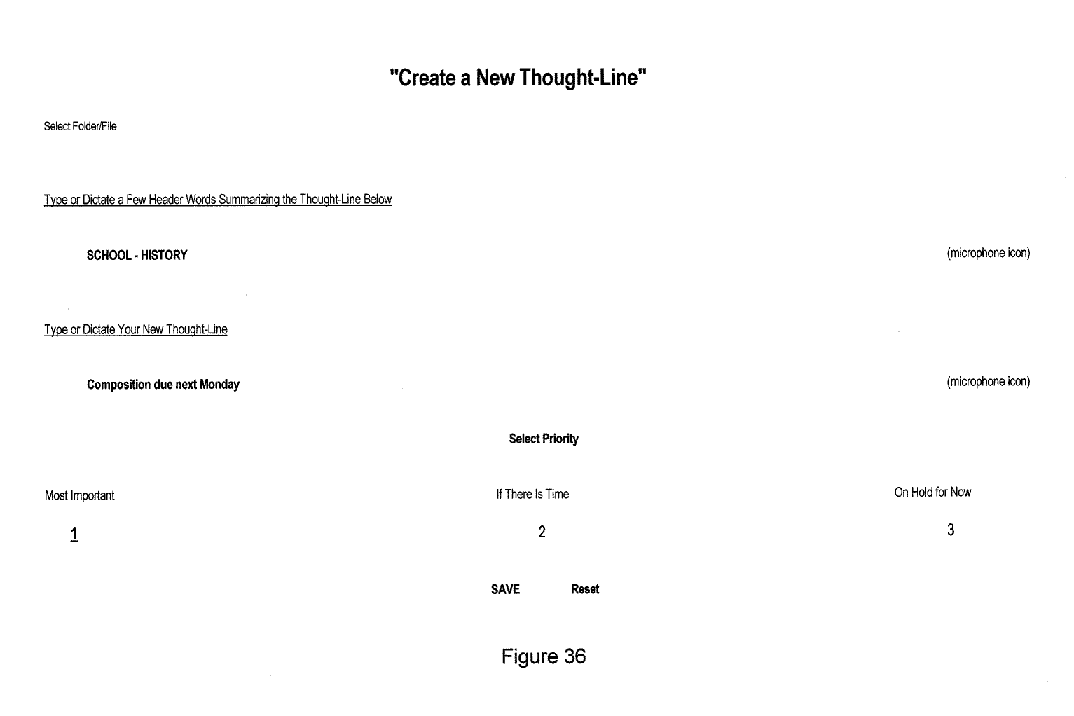

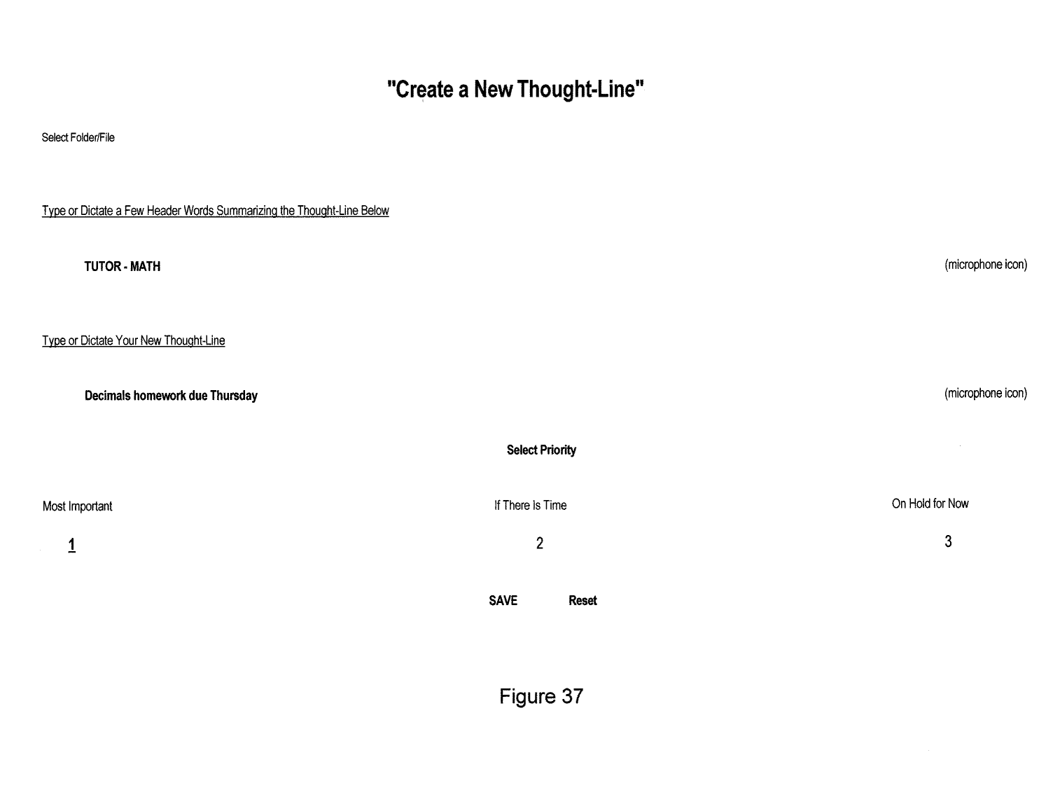

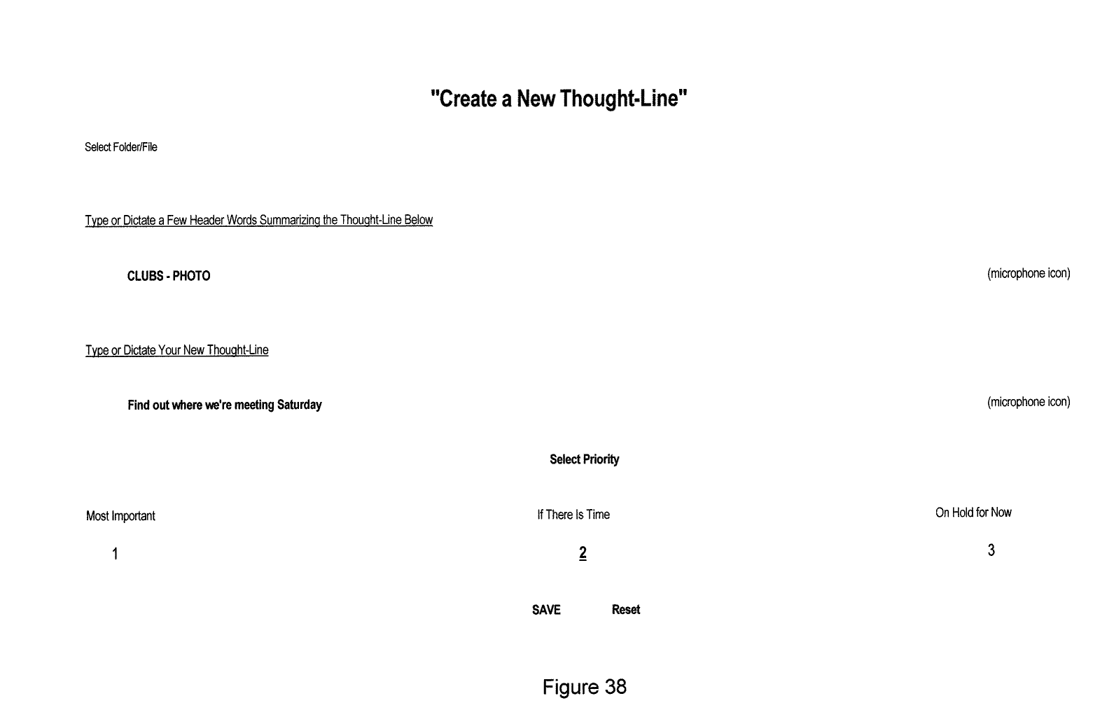

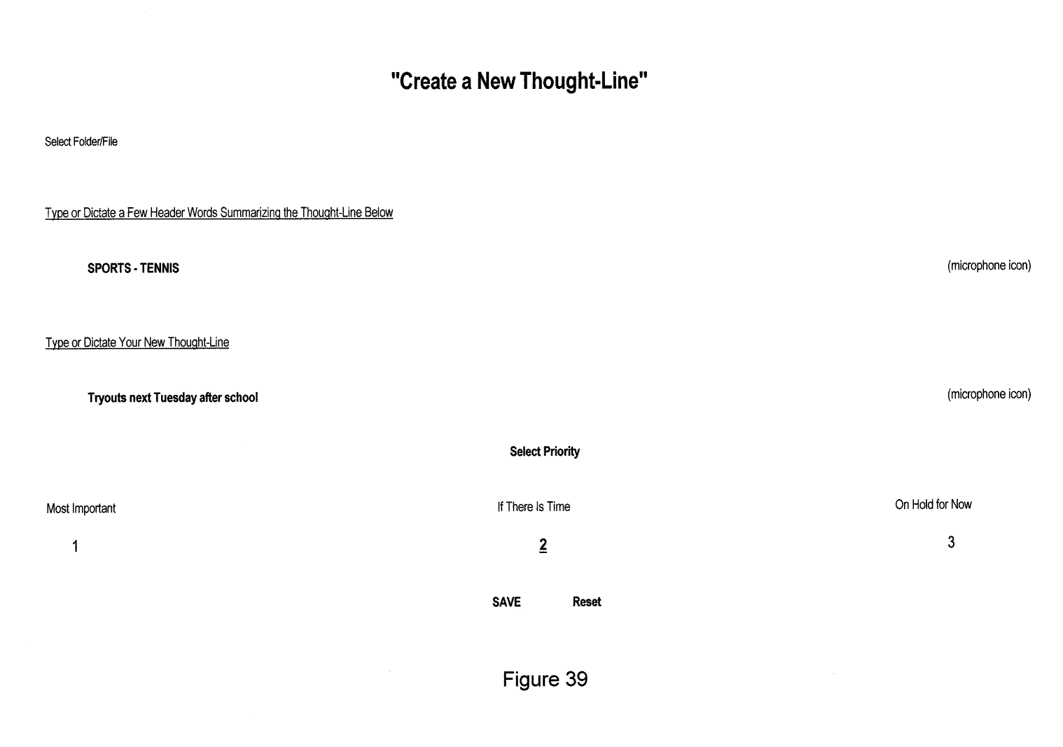

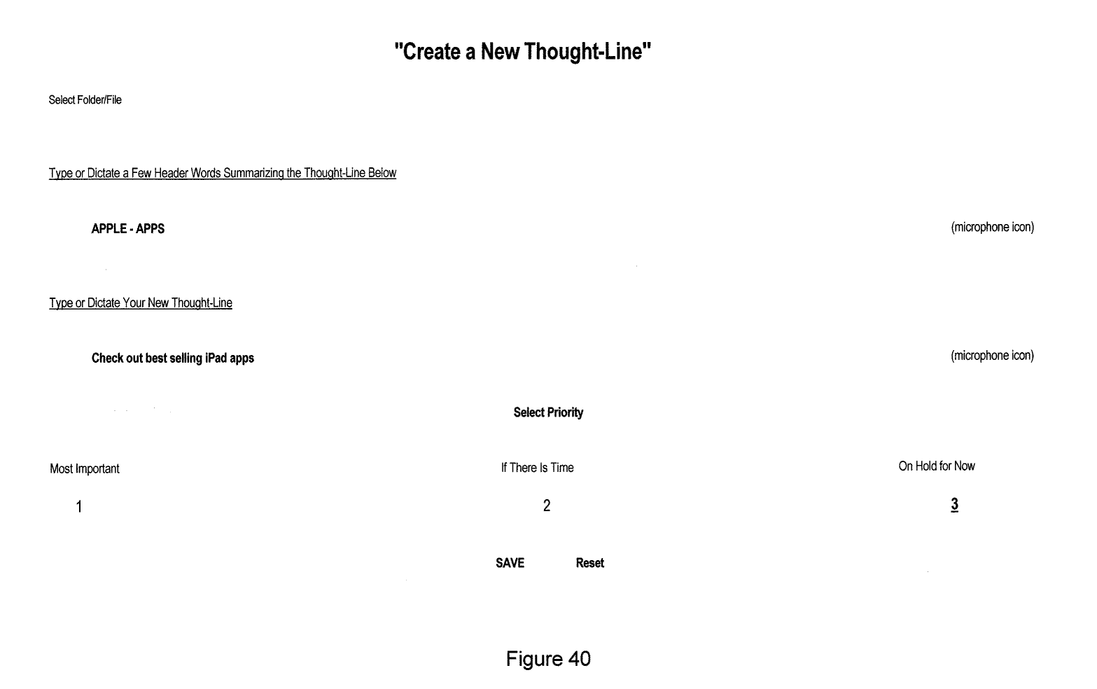

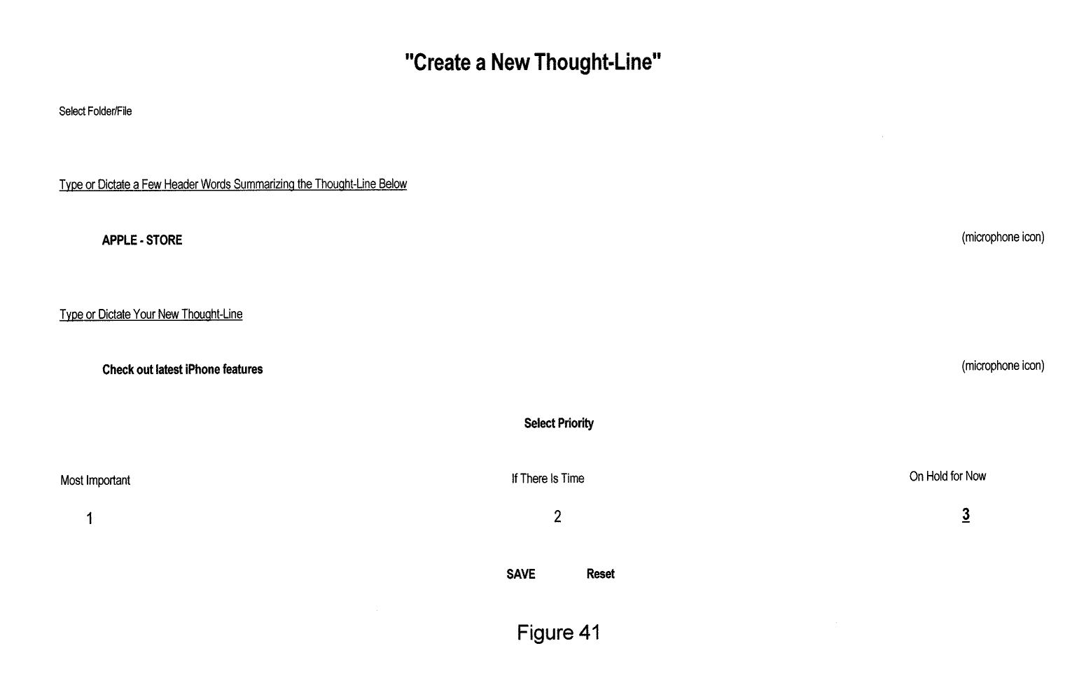

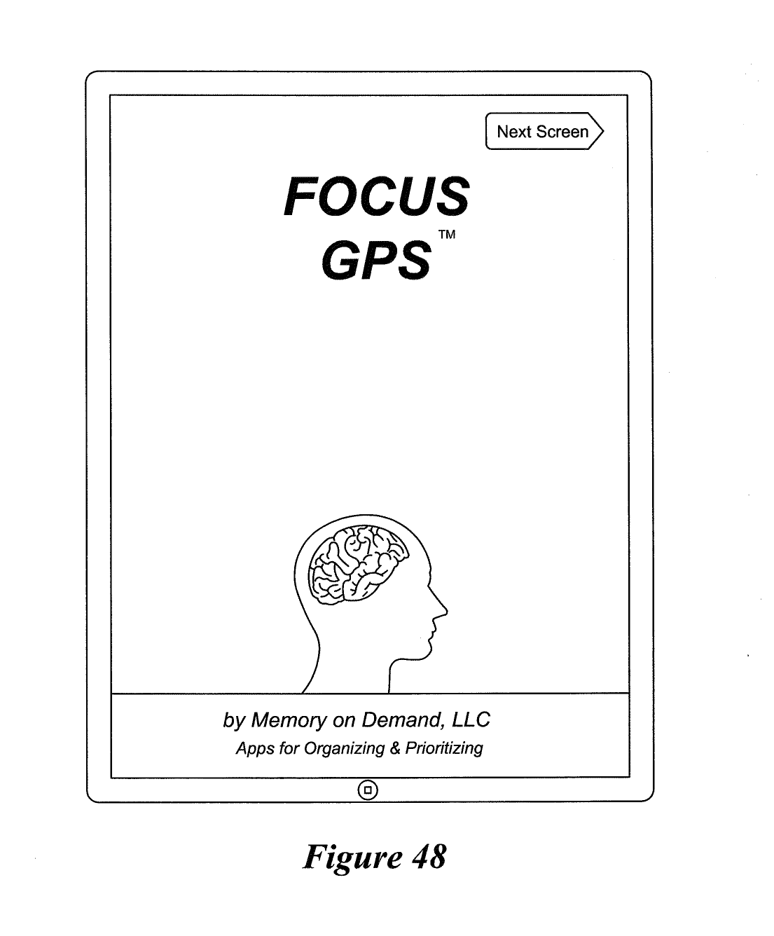

EXAMPLE 1 is illustrated in FIGS. 33-57. FIGS. 33-46 show the functionality via user interface display screens. FIG. 47 shows a flowchart of selected steps of the process. FIGS. 48-57 show sample user interface display screens for a portable electronic device, such as an Apple iPad that implements the functionality shown in FIGS. 33-46. These figures are described in more detail below.

FIG. 33 shows the appearance of the default screen prior to any entries.

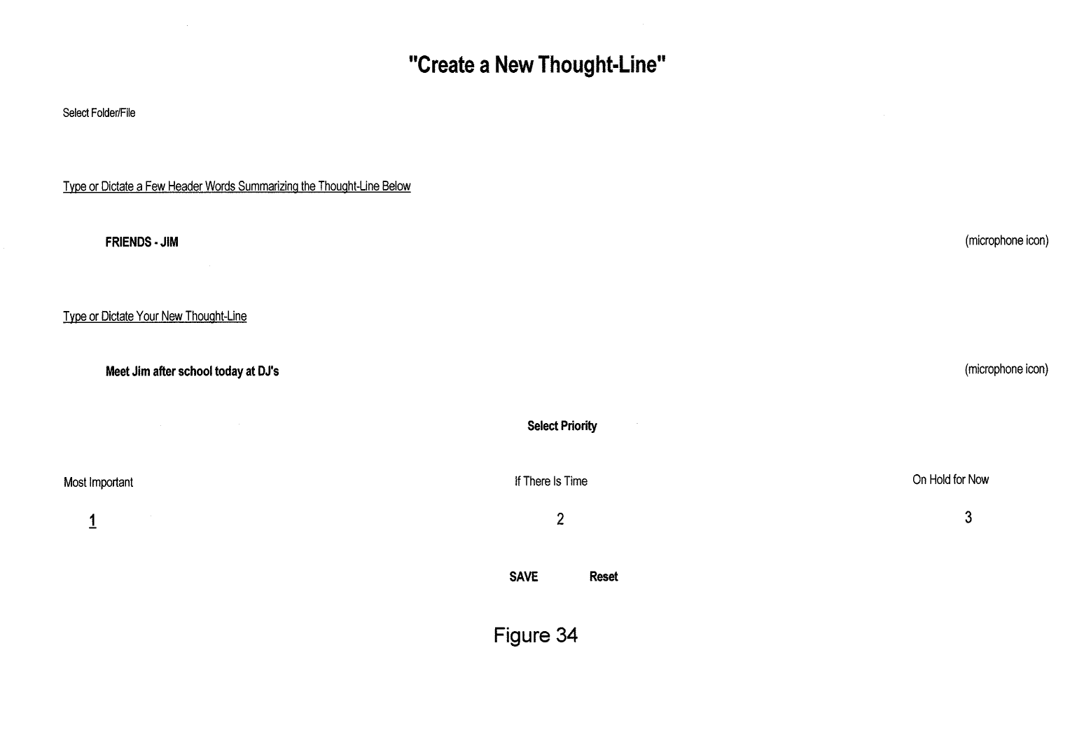

FIGS. 34-41 show “Create a New Thought-line” entry screens for the entry of a thought-line header, an associated or corresponding thought-line (which, together, define a complete thought-line), and an initial priority rating for each of the complete thought-lines. The thought-line header is also referred to herein interchangeably as a “Topic Header.”

The entry process operates as follows:

1. The header word(s) are been selected and entered.

2. The thought-line word(s) are selected and entered.

3. The priority number is selected (shown underlined in the figures).

4. The “SAVE” button is selected which causes the entry to be saved. The display screen then clears so that new entries can be made.

In one embodiment, the priority is a number from 1-3 designating “Most Important” (“1”), “If There is Time” (“2”), and “On Hold For Now” (“3”). However, the scope of the present invention includes other ranked priority schemes.

In the example above, the user has entered all of the information in each of the entry screens. However, a user may enter only a portion of information in an entry screen during an entry session, and whatever portions of information are entered become saved. The user may then return to the uncompleted screen(s) in one or more subsequent entry sessions to complete the remaining entries. Preferably, the user must enter at least an initial priority and either a topic header or a thought-line.

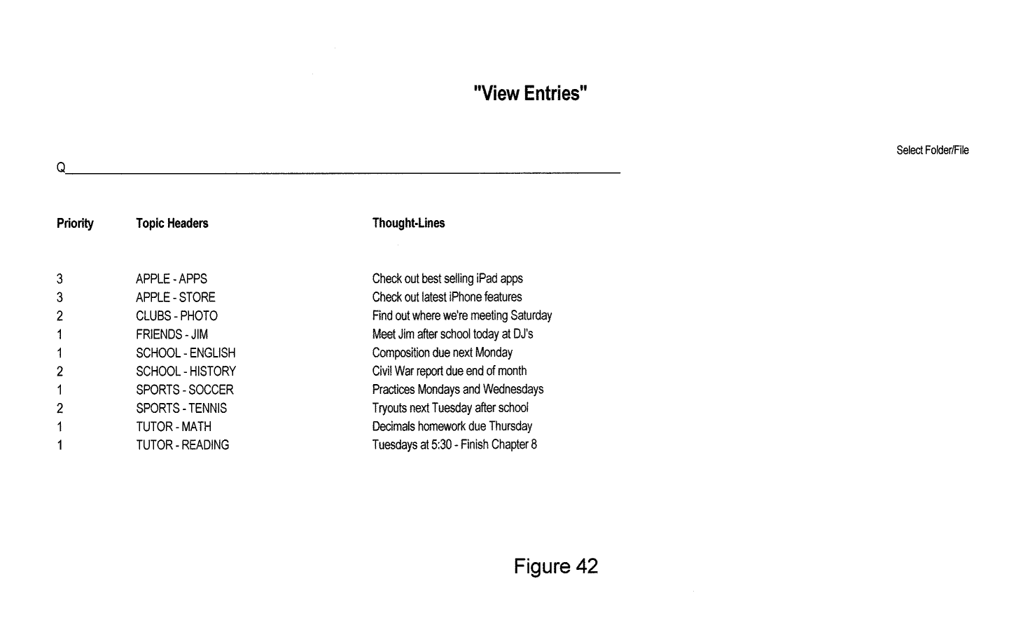

FIG. 42 shows a “View Entries” screen that displays the entries made using the “Create a New Thought-Line” screens. Columns can be arranged alphanumerically by tapping “Priority,” “Topic Headers,” or “Thought-Lines.” In the example of FIG. 42, the columns are arranged alphanumerically by Topic Header.

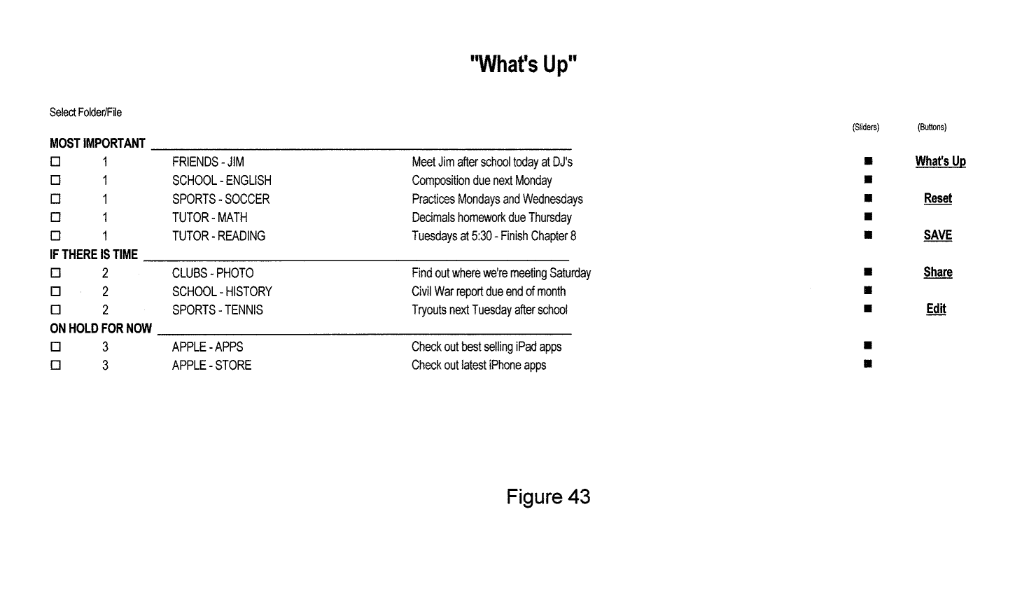

FIGS. 43-46 show examples of a “What's Up” screen and the successive actions that can be taken by the user on this screen.

FIG. 43 shows an initial view of this screen. This screen shows the initial priorities, thought-line headers and thought-lines. The complete thought-lines are displayed in order of their initial priority rating from highest to lowest, and then arranged alphabetically within each initial priority rating category by their thought-line headers. Thought-line priority-selection boxes are located in the far-left column (selectable by finger contact).

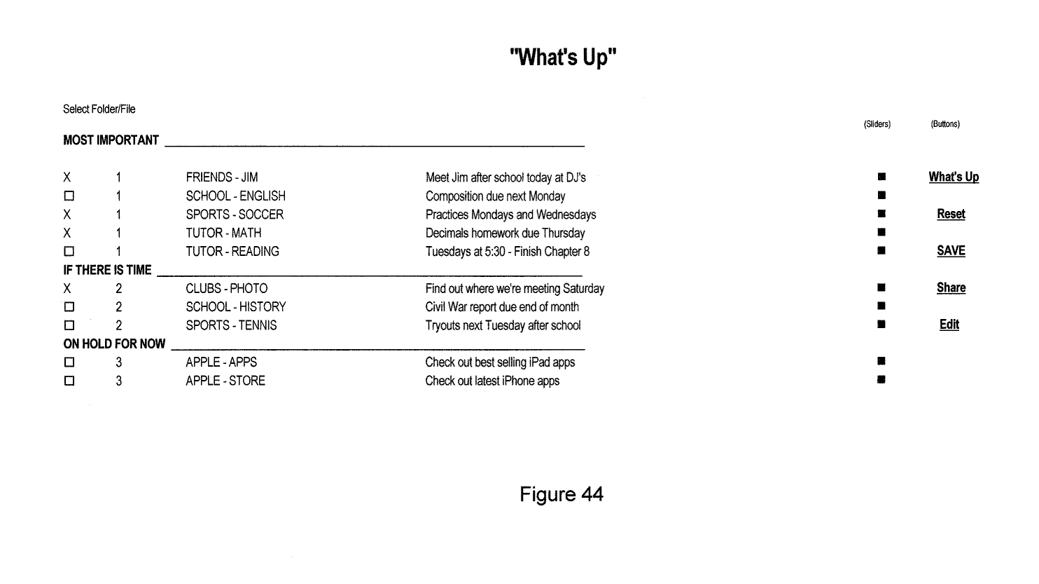

FIG. 44 shows the user selecting one or more of the complete thought-lines as being of upcoming greatest importance to the user. Selected thought-line priority-selection boxes on the left have been checked (shown by an “X” in this example). The “What's Up” button on the upper right has not yet been pushed to re-organize the screen.

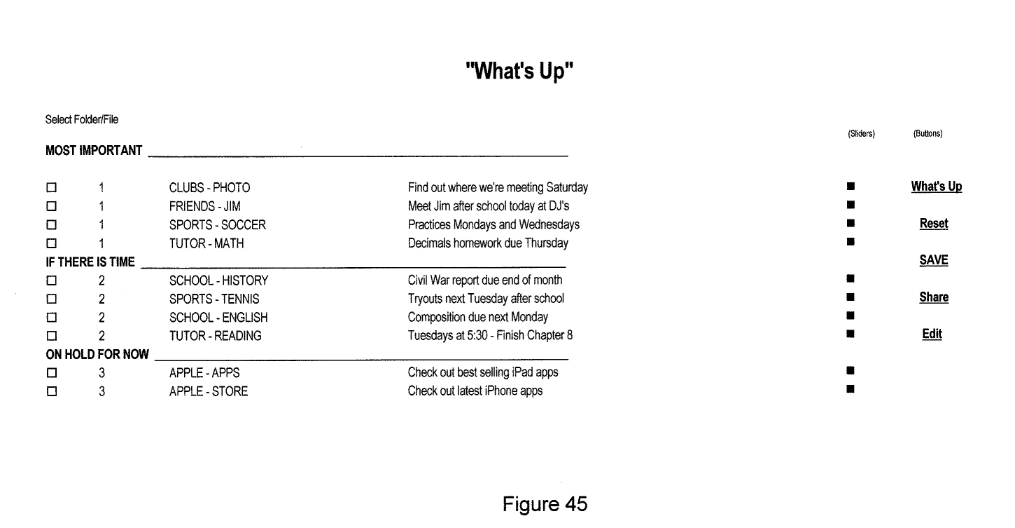

FIG. 45 shows the screen after the “What's Up” button is selected. The order of complete-thought-lines is modified so that the complete thought-lines selected in the FIG. 44 screen appear at the highest order on the user interface display screen. The priority ratings of the complete thought-lines that have the highest initial priority rating and that were not selected in the FIG. 44 screen are temporarily lowered. The modified order of complete-thought-lines show the temporarily lowered priority ratings of the non-selected complete thought-lines. The process can be summarized as follows:

1. The “What's Up” button on the upper right has been pushed to re-organize the screen.

2. The selected complete thought-lines have become “1″s and have been moved into the “Most Important” category.

3. All non-selected thought-lines have been moved below the “Most Important” range.

4. The formerly “X”-marked priority-selection boxes on the left have been restored to empty boxes.

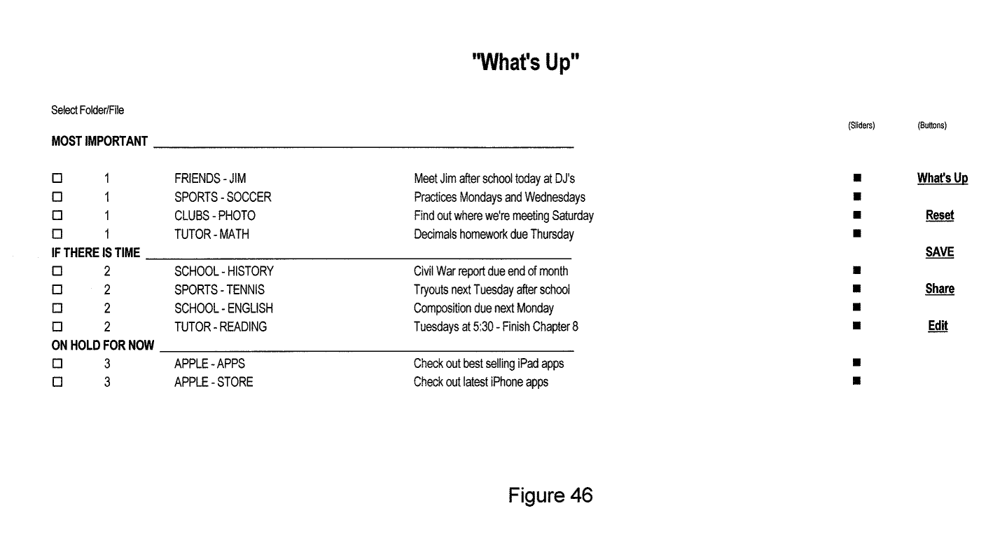

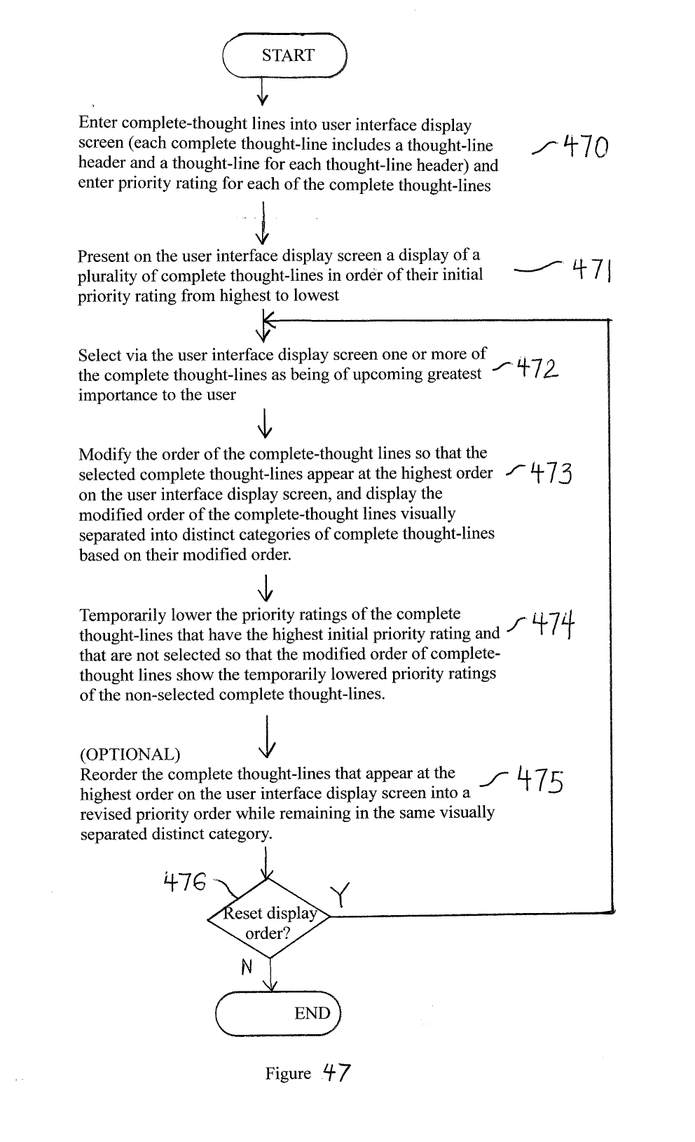

5. The solid “slider” icons on the right of the screen can now be used to exactly position the Most Important items, as shown in FIG. 46.

FIG. 46 shows the results of a reordering function wherein the complete thought-lines that appear at the highest order on the screen can be reordered by the user into a revised priority order while remaining in the same visually separated distinct category. In this example, the “slider” icons on the right have been used to move the complete thought-lines into the exact order wanted. Here, the first three complete thought-lines 1-2-3 were reordered as 2-3-1. The fourth complete thought-line remained unchanged in the fourth position.

To reorder a complete thought-line, the user clicks on the “slider” icon and then can slide (e.g., drag and drop) the complete thought-line to another location within the distinct category (here, “MOST IMPORTANT”).

When circumstances change and new priorities are needed, the reset button can be used to start again. The reset button will restore the original “What's Up” screen, ready for reprioritization on the spot.

The steps in FIG. 47 correspond to the display screens in FIGS. 33-46 as follows:

Step 470: FIGS. 33-41

Step 471: FIG. 43

Step 472: FIG. 44

Steps 473 and 474: FIG. 45

Step 475: FIG. 46

Step 476: Use of reset button in FIG. 45 or 46

As discussed above, FIGS. 48-57 show sample user interface display screens for a portable electronic device, such as an Apple® iPad® that implements the functionality shown in FIGS. 33-46.

FIG. 48 is the initial splash screen.

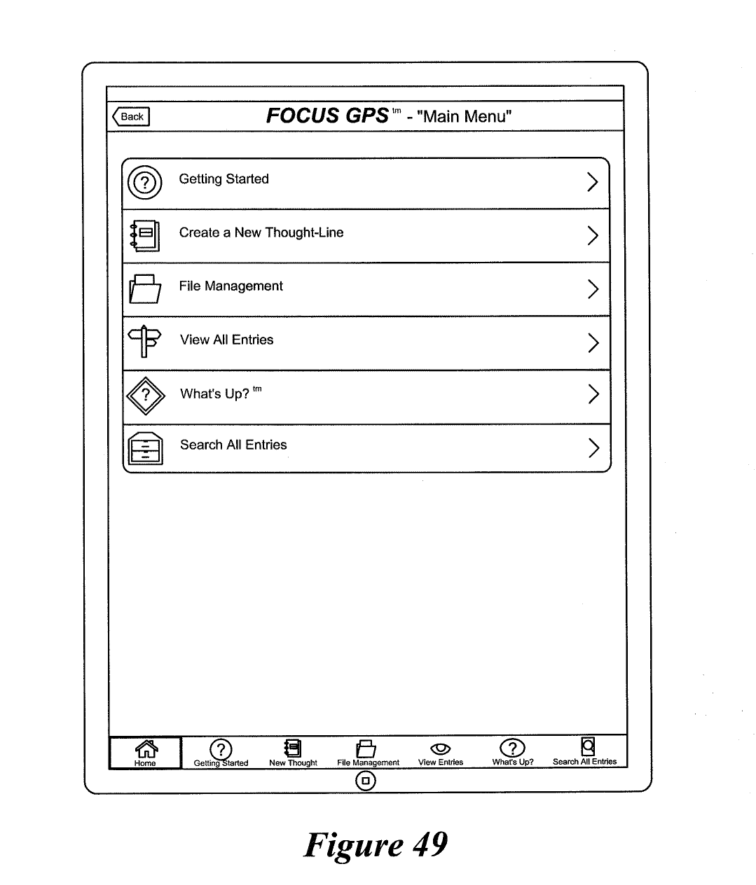

FIG. 49 is a “Main Menu” screen.

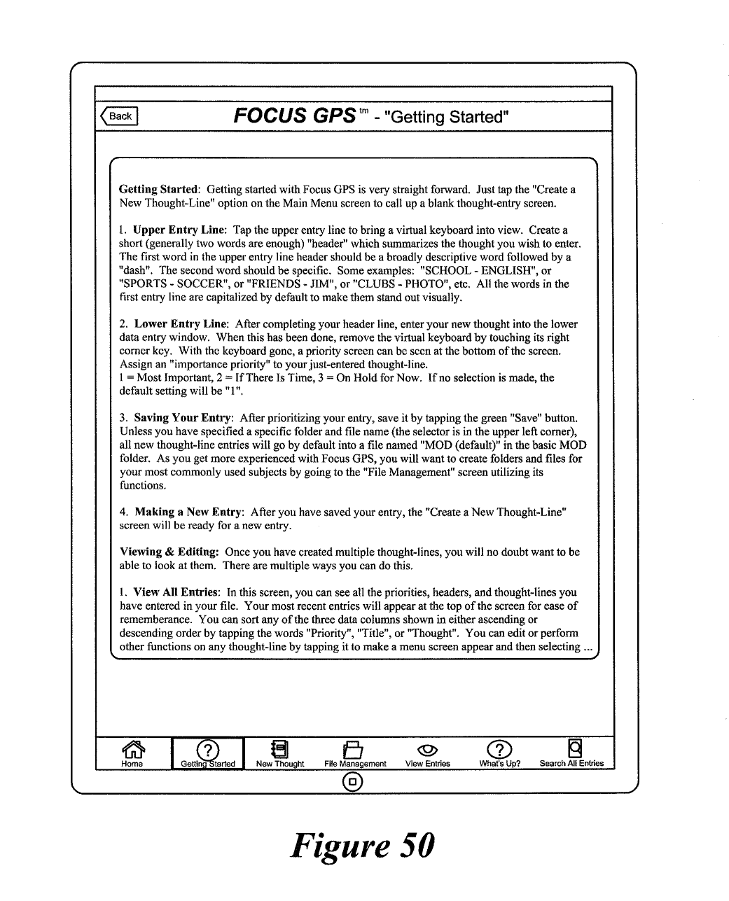

FIG. 50 is a sample “Getting Started” help screen. An alternative version of the “Getting Started” screen may include the following text:

“Getting Started” screen button, first entry on the Main Menu (not the “i” button):
Getting Started: Getting started with Focus GPS is quick and simple. Just go the “Create a New Thought-Line” screen and begin typing or dictating.
   1. First create a descriptive topic header such as “FAMILY—JOHN”, or “WORK—MEETING”, or “SCHOOL”, etc.
   2. After completing your header line, either type or speak your Thought-Line into the second data entry window. Remove the keyboard and then assign a priority of “1”, “2”, or “3”, with “1” being the highest.
   3. Click on the “Save” button. Unless you specify a specific folder and file location, all new Thought-Line entries will go into the MOD (default) file and MOD folder by default. As you get more experienced with Focus GPS, you will want to create folders and files for your most commonly used subjects with the File Management function.
   4. The Create a New Thought-Line screen should now be ready for another entry.
Viewing, Editing, and Sharing Entries: Once you have created multiple entries, you probably want to look at them. There are multiple ways you can do this.
   1. Go to the File Management screen and tap on “MOD (default)”, to see a list of all the Thought-Files you have created and saved. You can tap on an individual thought-line to edit it directly here.
   2. If you go to the View Entries screen you can also see everything you just entered. You can drag entire Thought-Lines up and down. With the drag feature turned “Off”, you can tap an individual Thought-Line and be presented with a number of file options. These include—
      a. Advanced Search
      b. Edit Selected Thought
      c. Email Thoughts
      d. Advanced Sort
      e. Delete
   3. To view those items that are of the highest priority, you can then go to the What's Up? Screen. Select those Thought-Lines which are absolutely the most important and then tap the “What's Up?” button. To share or print out this report, simply tap the “Share” button.
      Note: More detailed instructions and tips on how to use Focus GPS can be found on each individual screen by tapping the “i” button for Help.

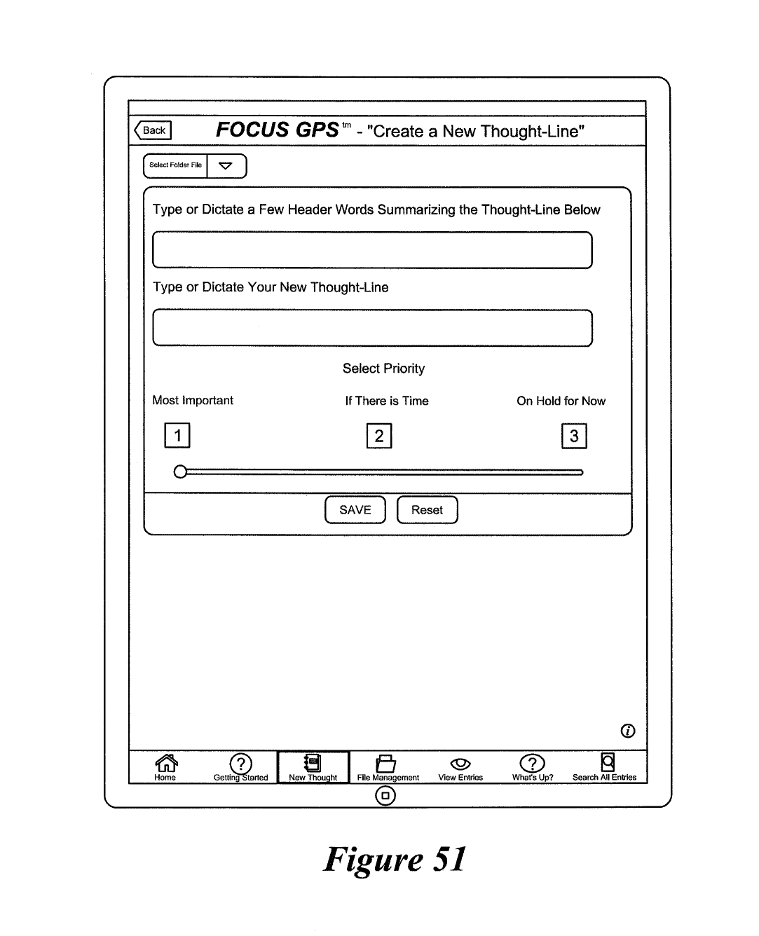

FIG. 51 is a “Create a New Thought-Line” screen and is similar to FIG. 33 discussed above.

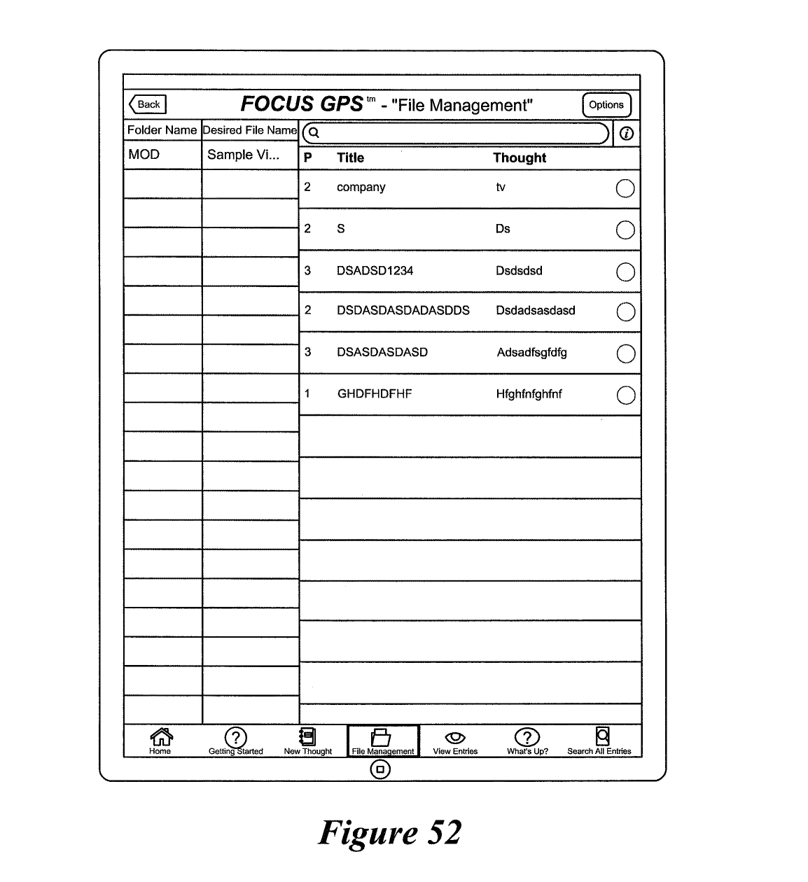

FIG. 52 shows a “File Management” screen which allows for editing of complete thought-lines.

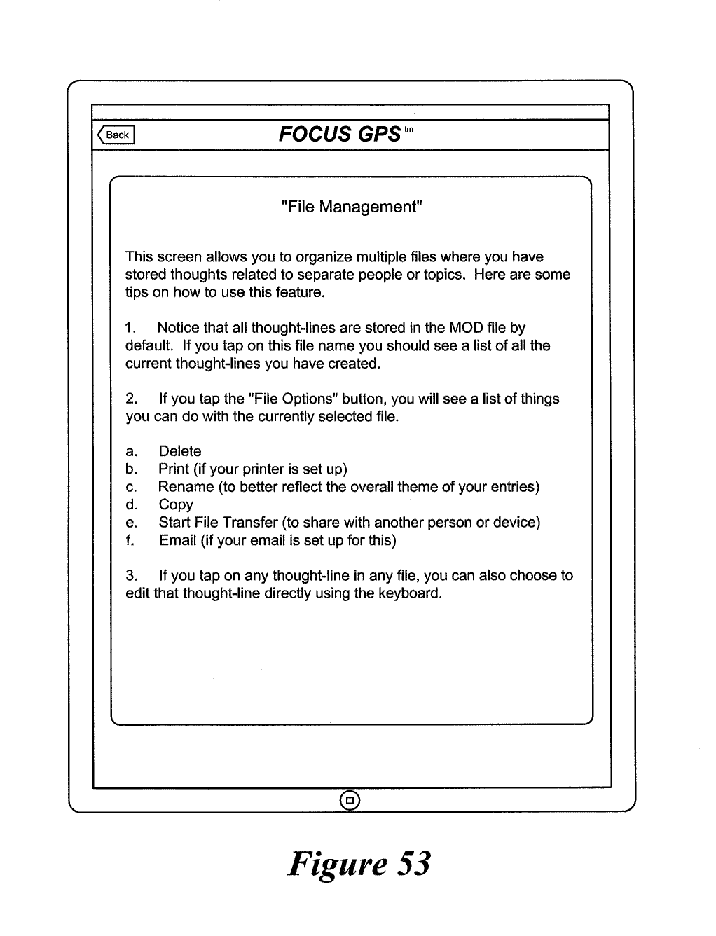

FIG. 53 is an information/help screen for the “File Management” screen.

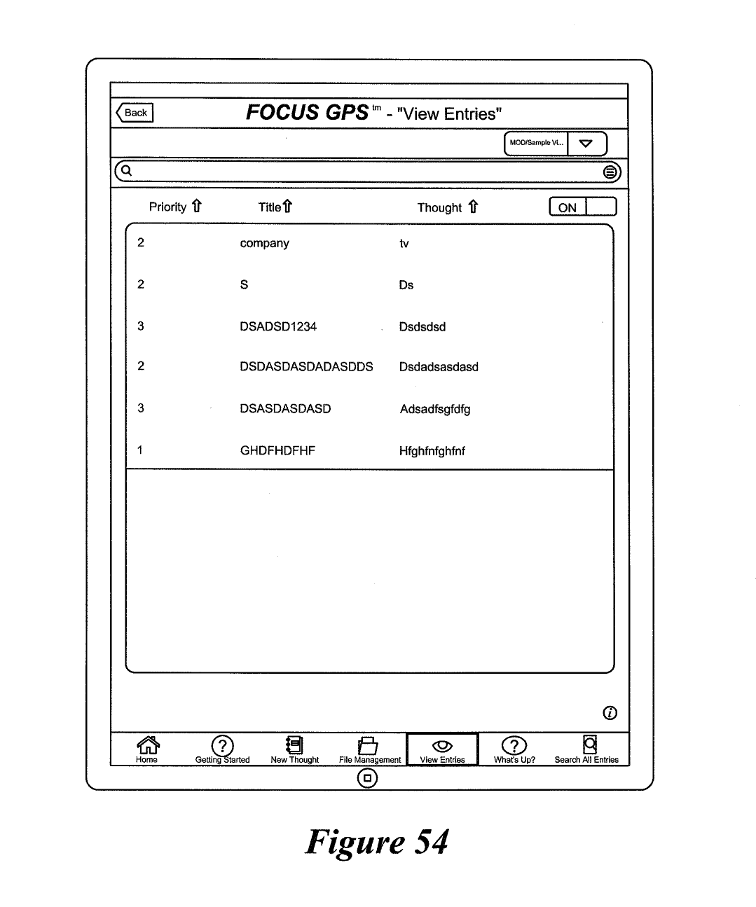

FIG. 54 shows a “View Entries” screen which allows for the functionality discussed above.

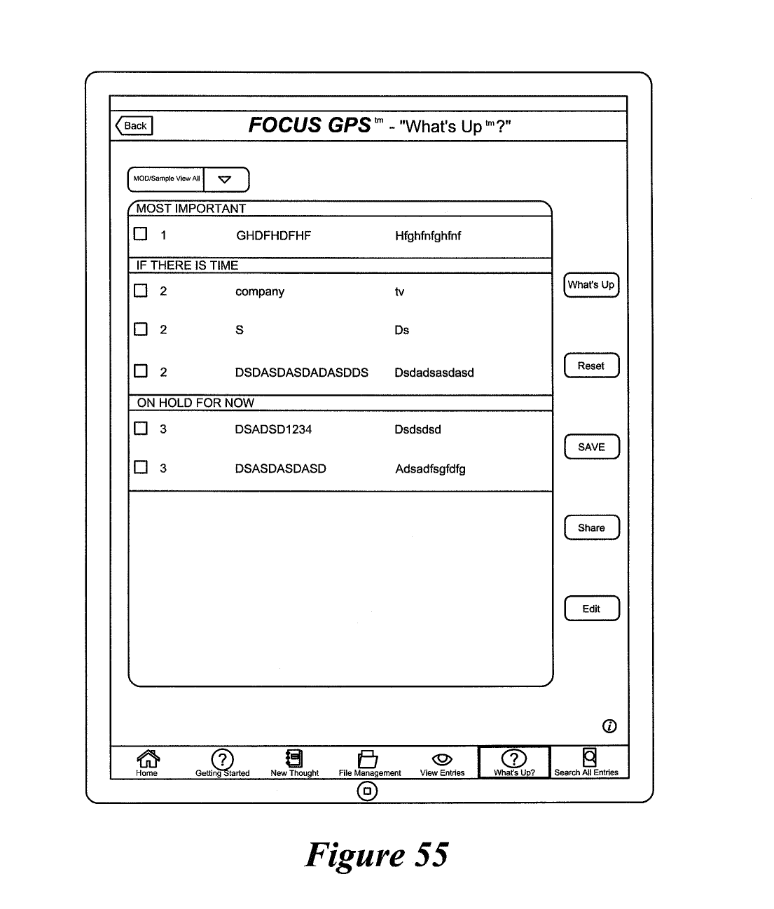

FIG. 55 shows a “What's Up?” screen which is similar to FIG. 42 discussed above.

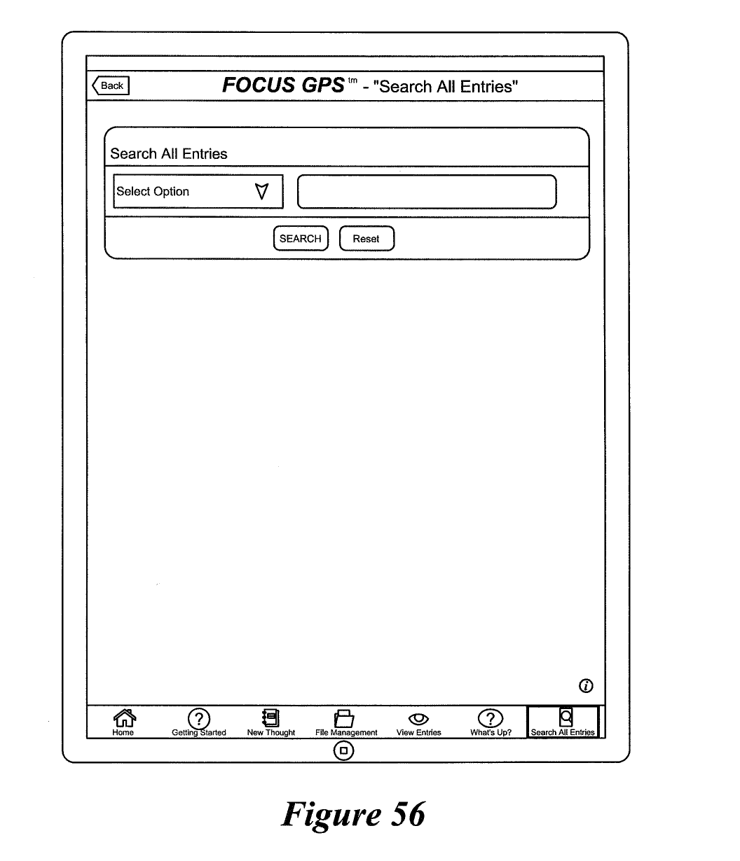

FIG. 56 shows a “Search All Entries” screen which allows the user to search entries by keyword.

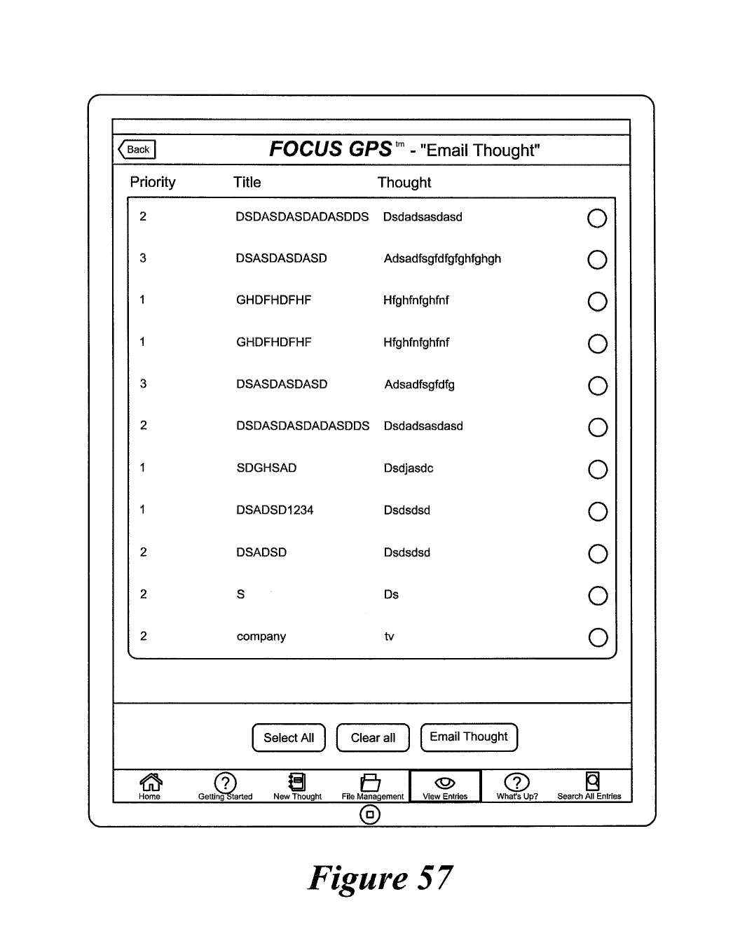

FIG. 57 an “Email Thought” screen which allows the user to email any of the complete thought-lines to a recipient.

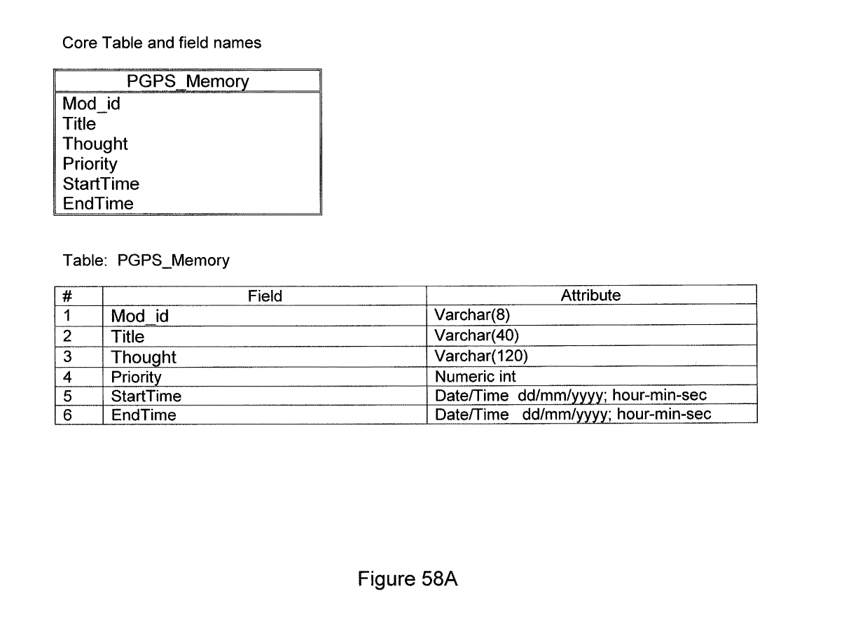

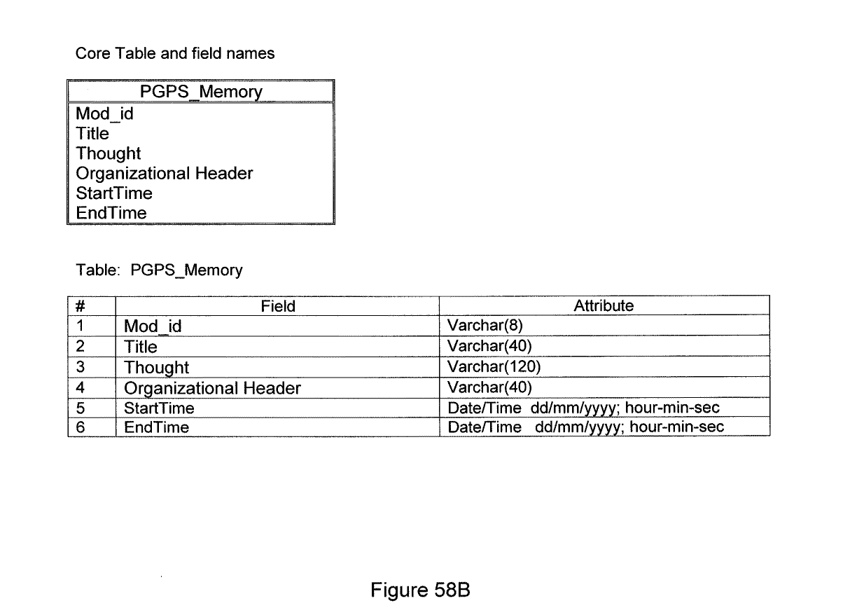

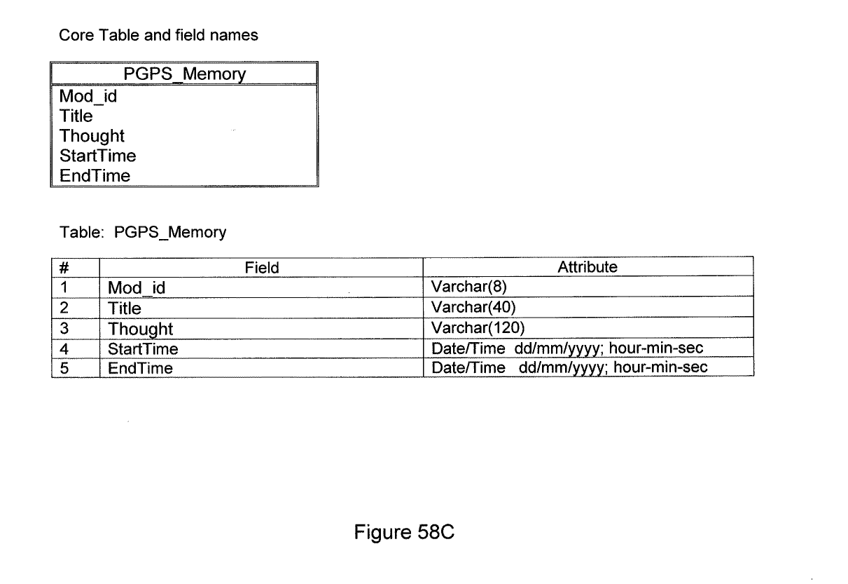

FIG. 58A shows two views of a database for use in one preferred embodiment of EXAMPLE 1. The database includes a single table named PGPS_Memory having at least the following fields:

1. Mod_id:—This is a primary key of table. When a user inserts a record, it automatically increase value of this field.

2. Title (Thought-line header): entered by the users.

3. Thought (Thought-line): entered by the user.

4. Priority:—this field is used to store the priority value entered by the user.

5. StartTime:—it is the concatenation of the date and time when the thought was entered. It is gotten from the device itself and is used to keep track of the time that a record was inserted.

6) EndTime:—it is the same as start time but the value is changes when the record is updated.

The Appendix shows sample source code for generating selected screens. The Appendix is divided into three parts, as follows:

Part I: Main Menu Screen (FIG. 49)

Part 2: New Memory Screen (same as FIGS. 33 and 51 “Create a New Thought-Line” screen)

Part 3: What's Up Report Screen (same as FIGS. 42 and 55)

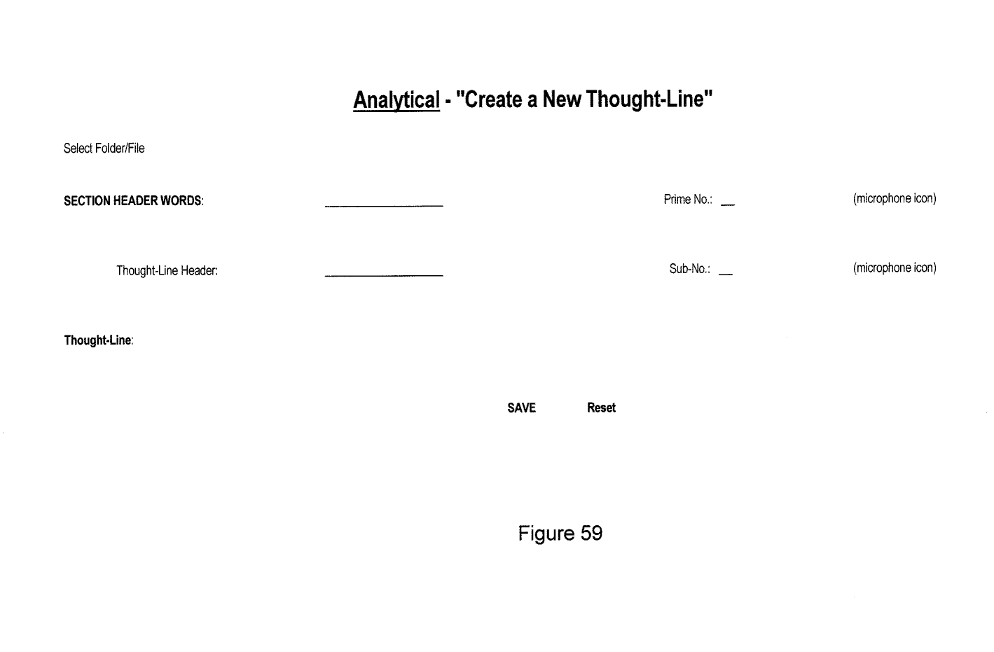

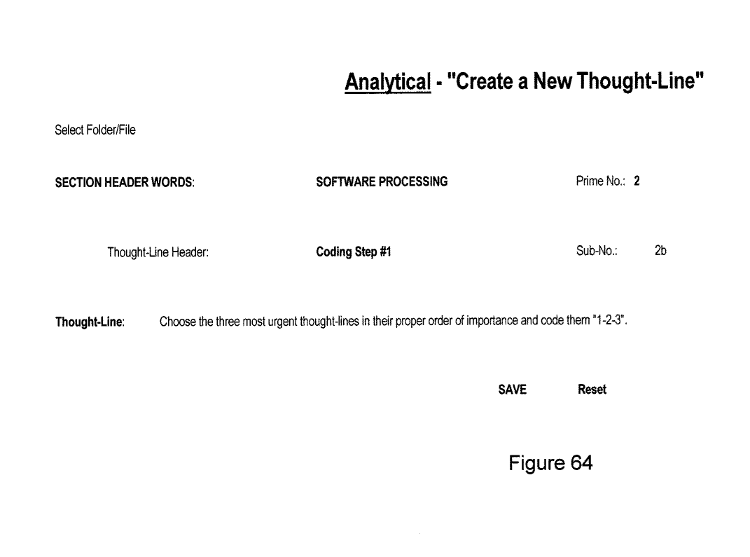

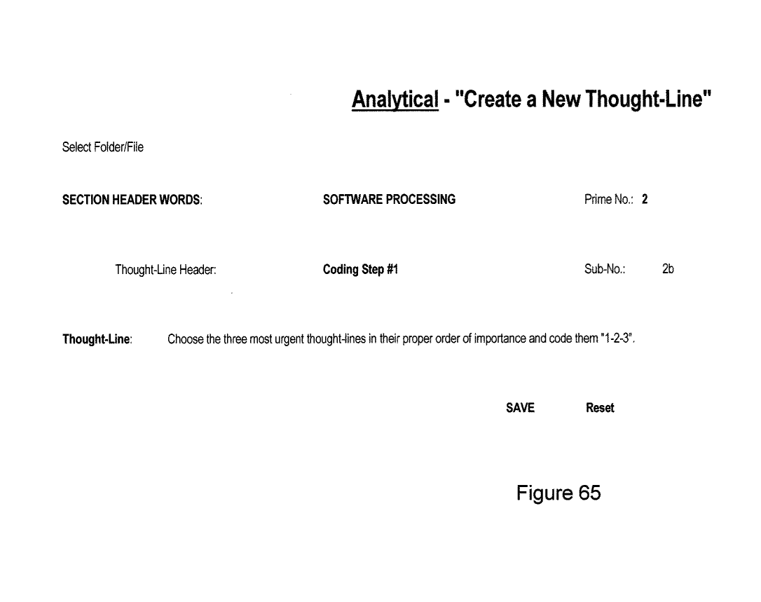

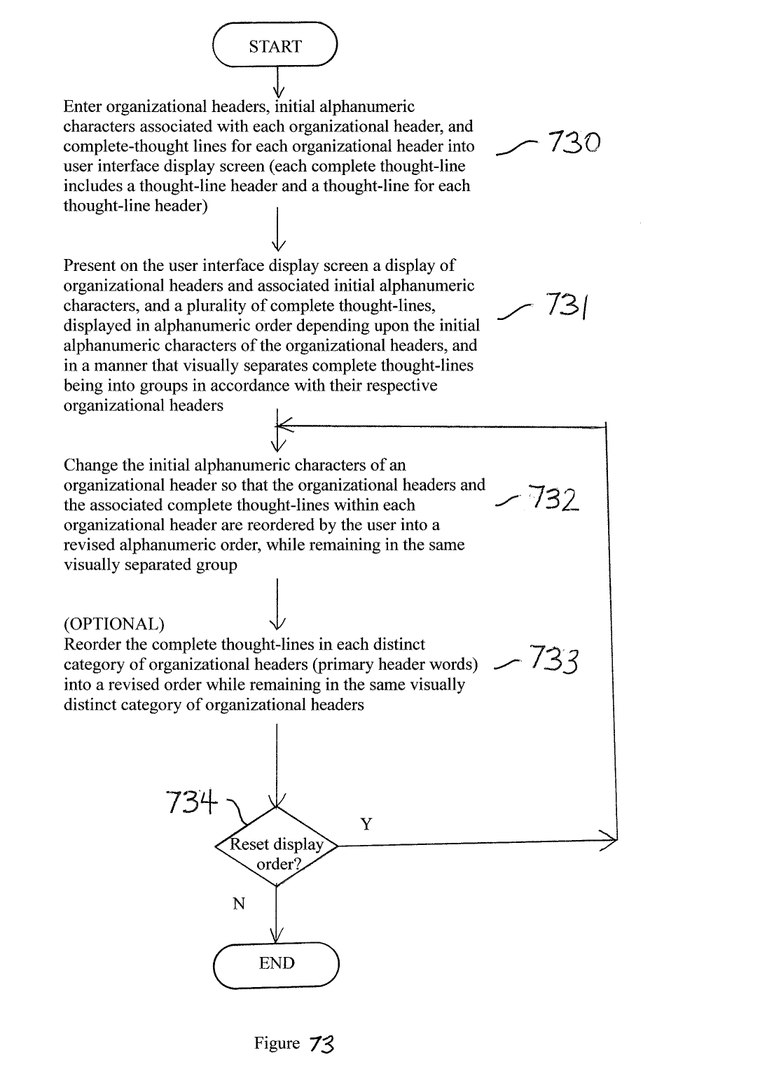

EXAMPLE 2 is illustrated in FIGS. 59-73. FIGS. 59-72 show the functionality via user interface display screens. FIG. 73 shows a flowchart of selected steps of the process.

FIG. 59 shows the default Focus GPS Analytical “Create a New Thought-Line” screen prior to any entries. The organization in the Focus GPS Analytical format is by content logic, not be importance prioritization (e.g., 1-2-3), as in EXAMPLE 1. Primary header words (also, referred to herein interchangeably as “Section header words” or “organizational headers”) can describe broad topics, such as chapter names, historical periods, intellectual concepts. Each category of primary header words should be given a prime organizational number (1, 2, 3, etc.) in a logical sequence. Each sub-thought-line header (also referred to herein interchangeably as a “thought-line header”) created within this category should be assigned the same number followed by a sequential letter (a, b, c, etc.). In the View Entries screen, all of the coded thought-lines will be assembled in the right order for further editing, if needed. Like EXAMPLE 1, each thought-line header and associated thought-line define a complete thought-line.

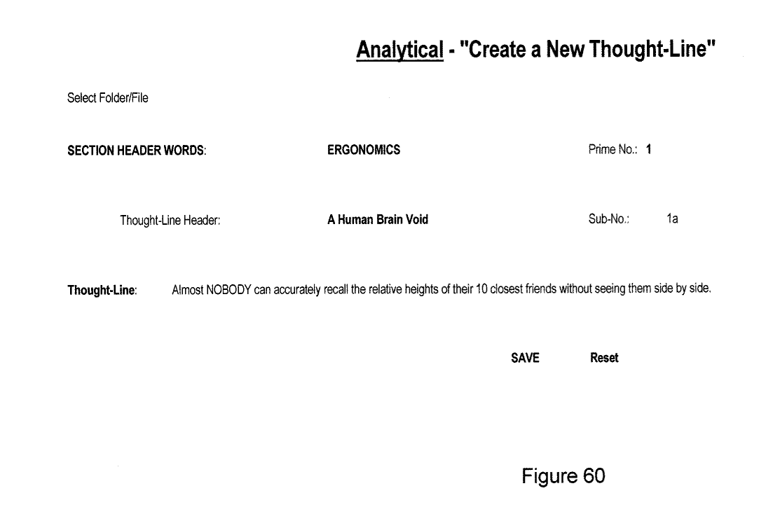

FIGS. 60-69 show “Create a New Thought-Line” screens populated with different entries. Referring to FIG. 60, the primary header, ERGONOMICS, has been entered and given the primary code number “1”. The new thought-line header has been entered and given the sub-code number “1a”. The thought-line has also been entered. When the SAVE button is selected, the entry is saved and the screen is reset to allow for another entry. In the “View Entries” screen described below, the complete thought-lines are assembled in the right order for further editing, if needed.

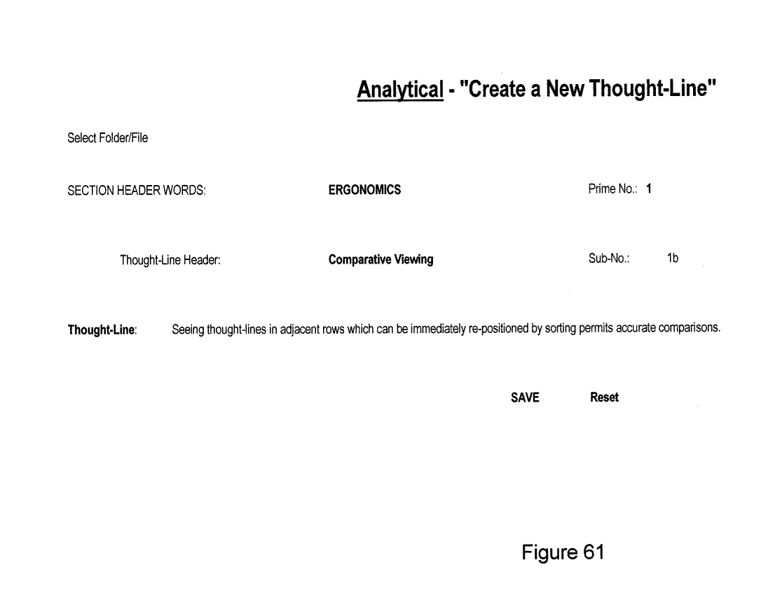

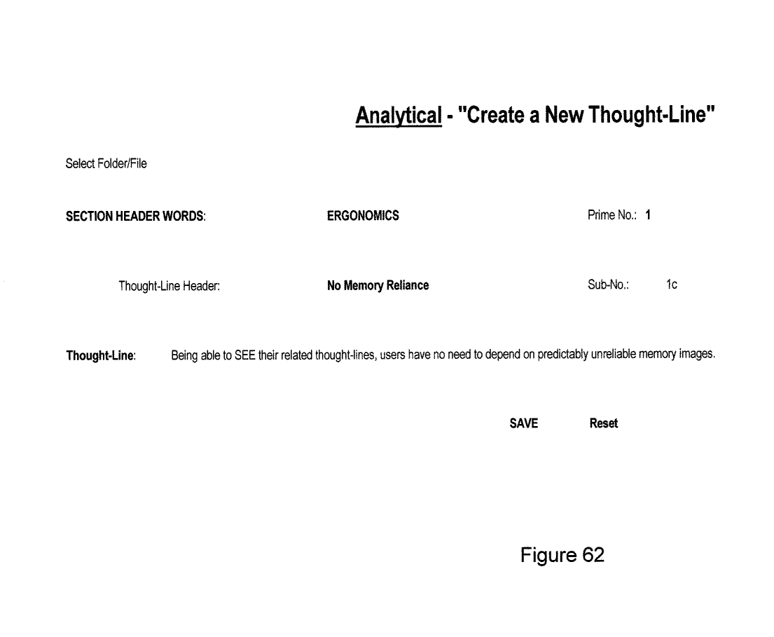

FIGS. 61 and 62 has the same primary header, ERGONOMICS, and the same primary code number “1” as FIG. 60. However, different complete thought-lines are entered and they are assigned different sub-code numbers “1b” and “1c,” respectively.

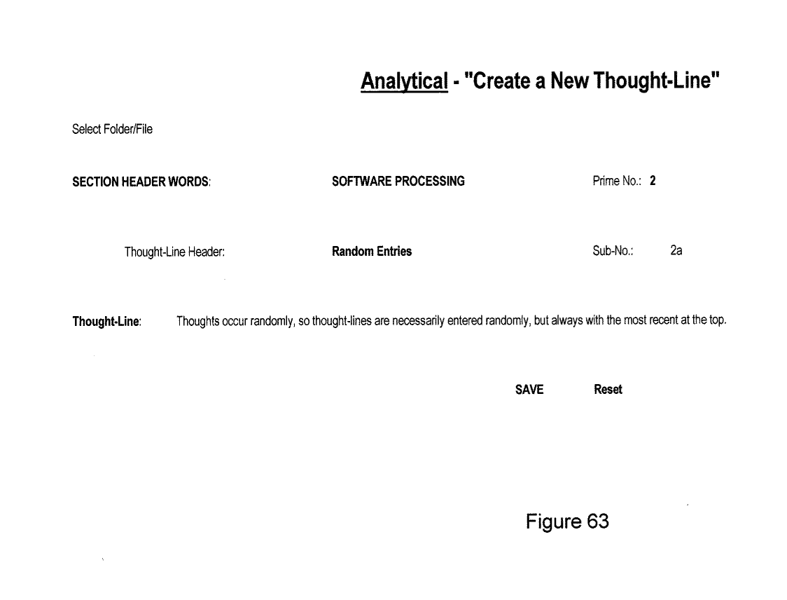

FIGS. 63-65 show the entry of complete thought-lines under a new primary header of SOFTWARE PROCESSING. The primary numbers of these entries are all “2” and their sub-code numbers are “2a,” “2b,” and “2c,” respectively.

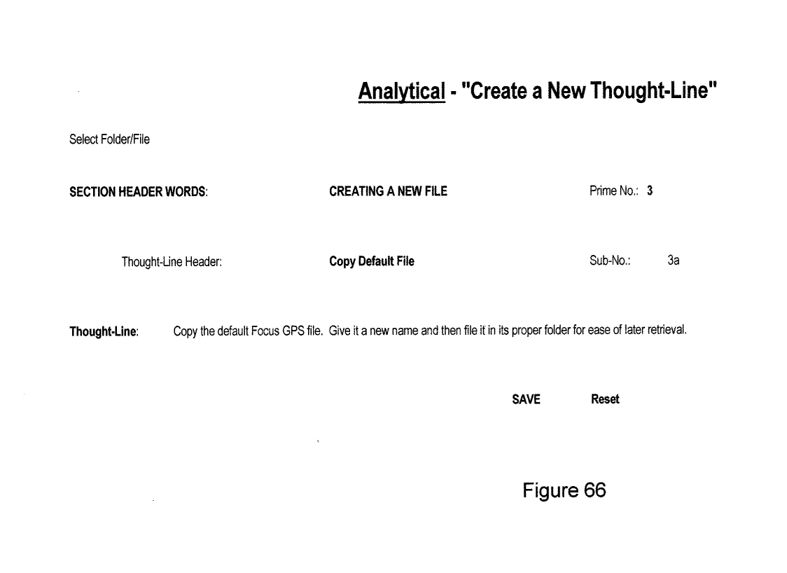

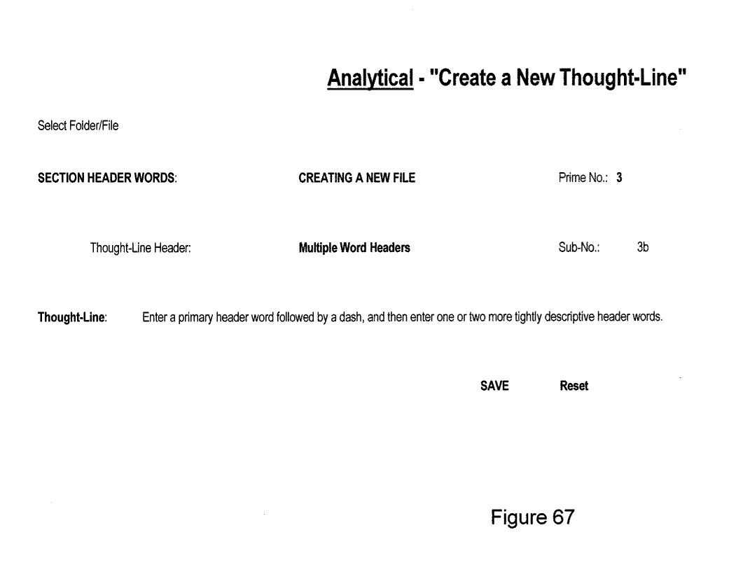

FIGS. 66-67 show the entry of complete thought-lines under a new primary header of CREATING A NEW FILE. The primary numbers of these entries are all “3” and their sub-code numbers are “3a” and “3b,” respectively.

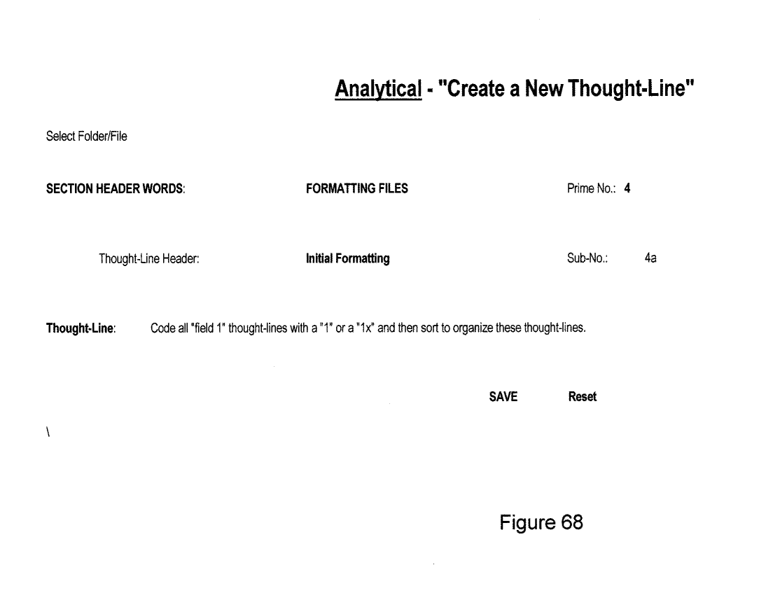

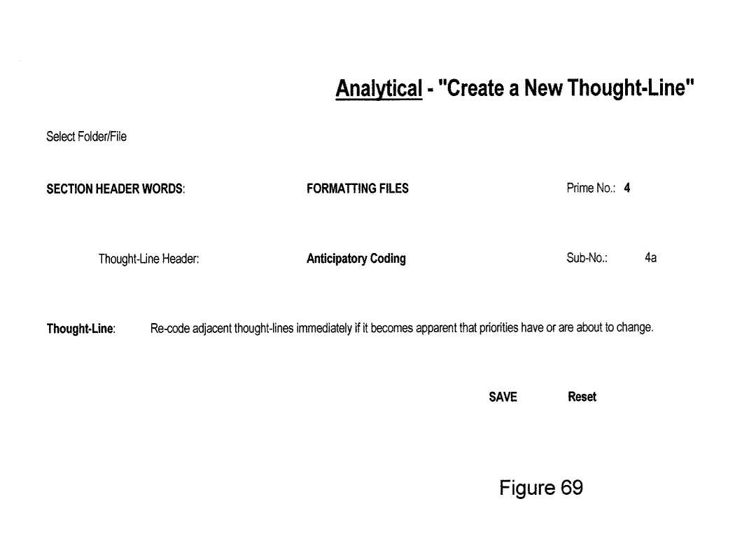

FIGS. 68-69 show the entry of complete thought-lines under a new primary header of FORMATTING FILES. The primary numbers of these entries are all “4” and their sub-code numbers are “4a” and “4b,” respectively.

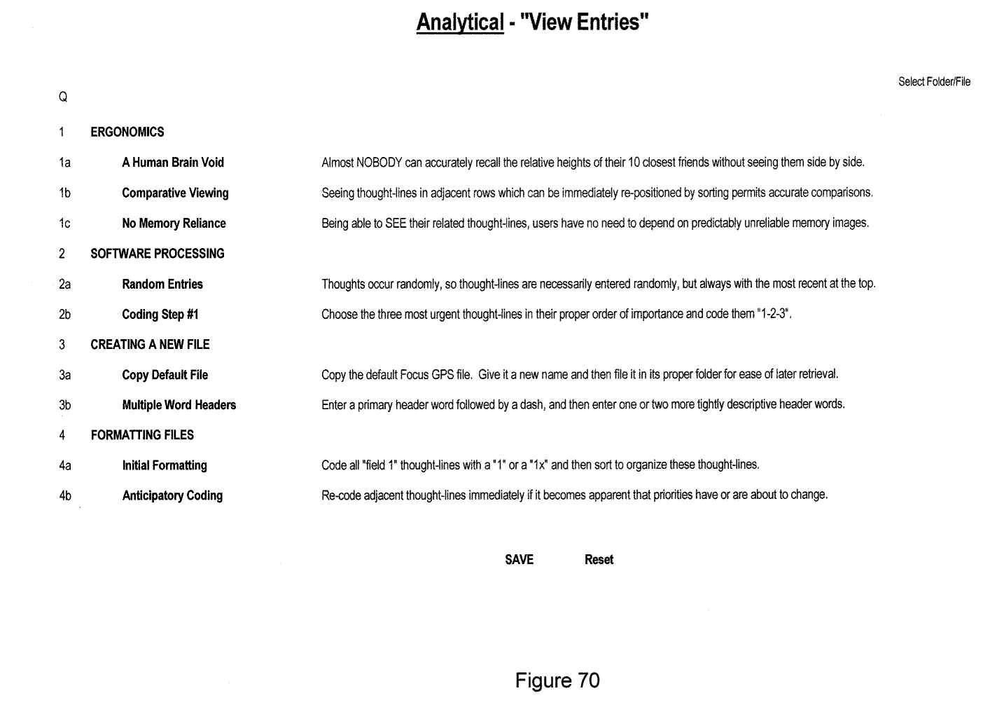

FIG. 70 shows a “View Entries” screen that displays all of the complete thought-lines in visually separated groups in accordance with their respective organizational headers. The organizational headers are arranged in alphanumeric order depending upon the initial alphanumeric character of the organizational header. Here, the alphanumerical order using the initial alphanumeric character is 1-2-3-4, so the organizational headers are arranged in the order of ERGONOMICS, SOFTWARE PROCESSING, CREATING A NEW FILE, FORMATTING FILES.

In FIG. 70, the control coding column is shown on the far left. The primary codes with no letters (1, 2, 3, and 4 in this case) indicate the primary organizational headers. The subordinate thought-line headers are organized under each of the primary code headers. Primary headers are all caps and bolded, and thought-line headers are bolded to make them stand out. The SAVE button preserves this file in the folder the user has selected under the name the user has selected.

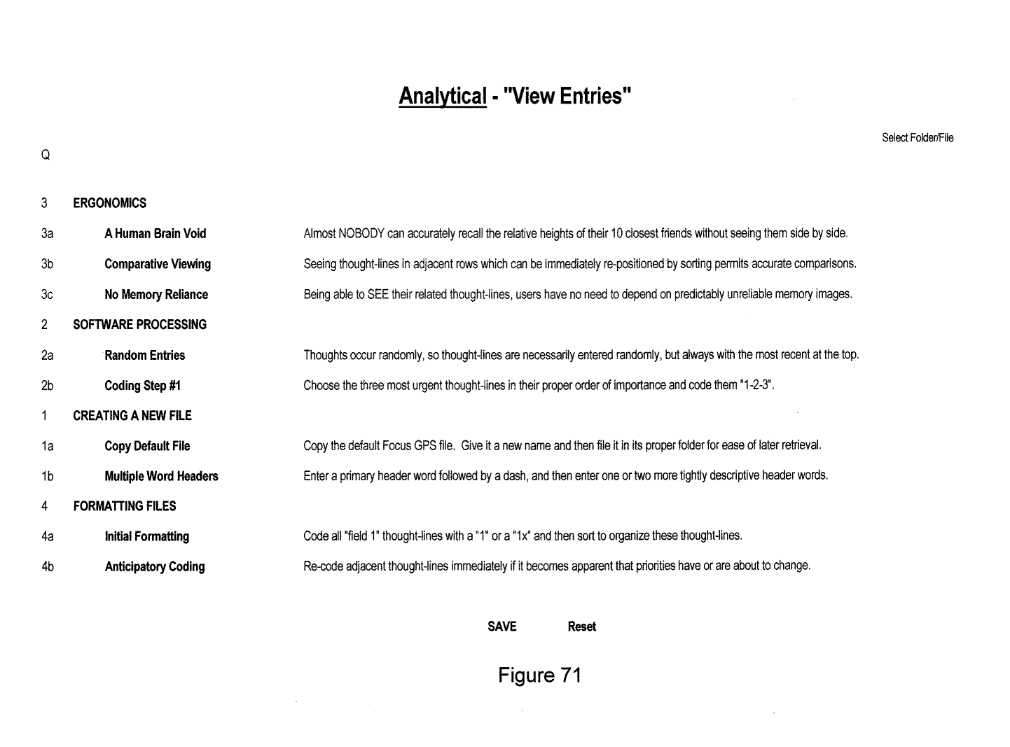

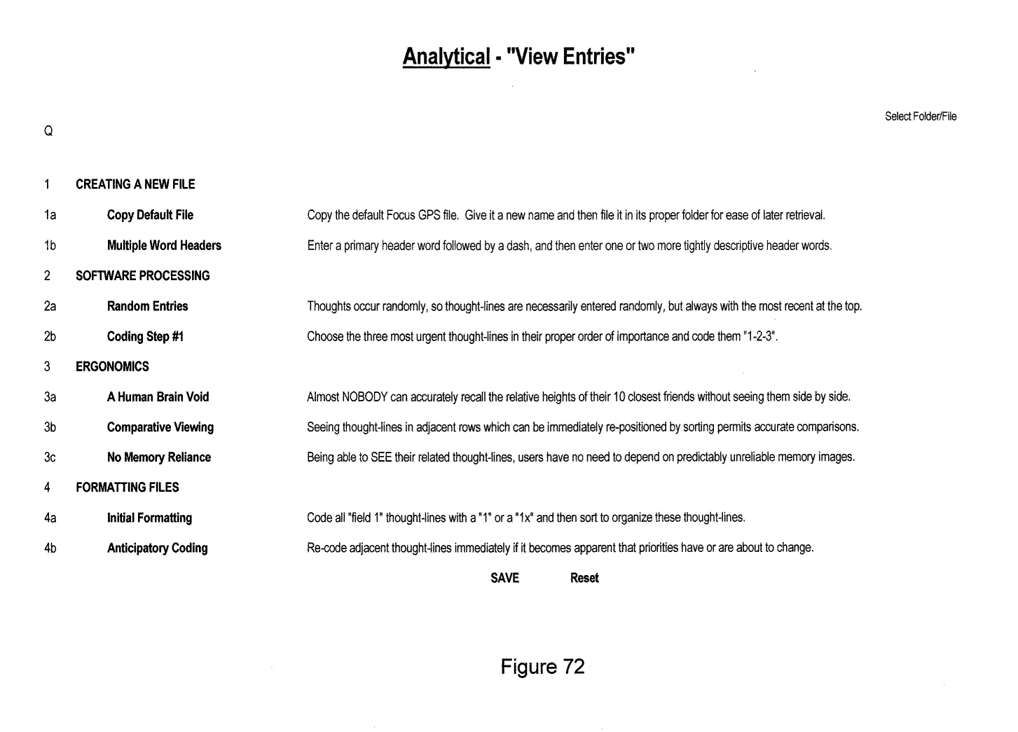

FIGS. 71-72 show how a user can change the initial alphanumeric characters of an organizational header so that the organizational headers and the associated complete thought-lines within each organizational header are reordered by the user into a revised alphanumeric order, while remaining in the same visually separated group.

Referring to FIG. 71, assume that the user decides that the ERGONOMICS grouping should logically be in position #3 instead of in position #1. In column #1, the user can then convert each of the “1” entries to “3” entries (“1” to “3”, “1a” to “3a”, etc.). Assume that the user also decides that the CREATING A NEW FILE grouping should be in position #1 instead of in position #3. In column #1, the user can then convert each of the “3” entries to “1” entries (“3” to “1”, “3a” to “1a”, etc.). Alternatively, the system may allow the user to only have to change the primary codes (here, “3” to a “1” and “1” to “3”) and the sub-codes would change automatically to their respective new sub-codes. The user can then tap the top of column #1 to sort the column alphanumerically ascending or descending.

FIG. 72 shows the results of this change. The organizational header, CREATING A NEW FILE, and its associated complete thought-lines now appear at the top of the screen, and the organizational header “ERGONOMICS” and their associated complete thought-lines appear in the third section.

The RESET button returns the screen to the original display order.

In the “View Entries” screen, a user may also reorder the complete thought-lines in each distinct category of organizational headers (primary header words) into a revised order while remaining in the same visually separated distinct category of organizational headers. The user may simply change the sub-code numbers to reorder the complete thought-lines. For example “1c” may be changed to “1a,” thereby causing the complete thought-line that was originally “1c” to appear at the top of the ERGONOMICS listing with a sub-code number of “1a.” The initial “1a” will become “1b” and the initial “1b” will become “1c.” Alternatively, this reordering process may be performed in the same sliding (e.g., drag and drop) manner as discussed above with respect to EXAMPLE 1.

The steps in FIG. 73 correspond to the display screens in FIGS. 59-72 as follows:

Step 730: FIGS. 60-69

Step 731: FIG. 70

Step 732: FIG. 71

Step 733: not shown, but similar to other examples

Step 734: Use of reset button in FIGS. 71-72

The user interface display screens shown in FIGS. 59-72 may be presented on a portable electronic device, such as an Apple® iPad® that implements the functionality shown in these figures.

FIG. 58B shows two views of a database for use in one preferred embodiment of EXAMPLE 2. The database is similar to the database for EXAMPLE 1 shown in FIG. 58A, except that there is no Priority field and there is a new field for the organizational header.

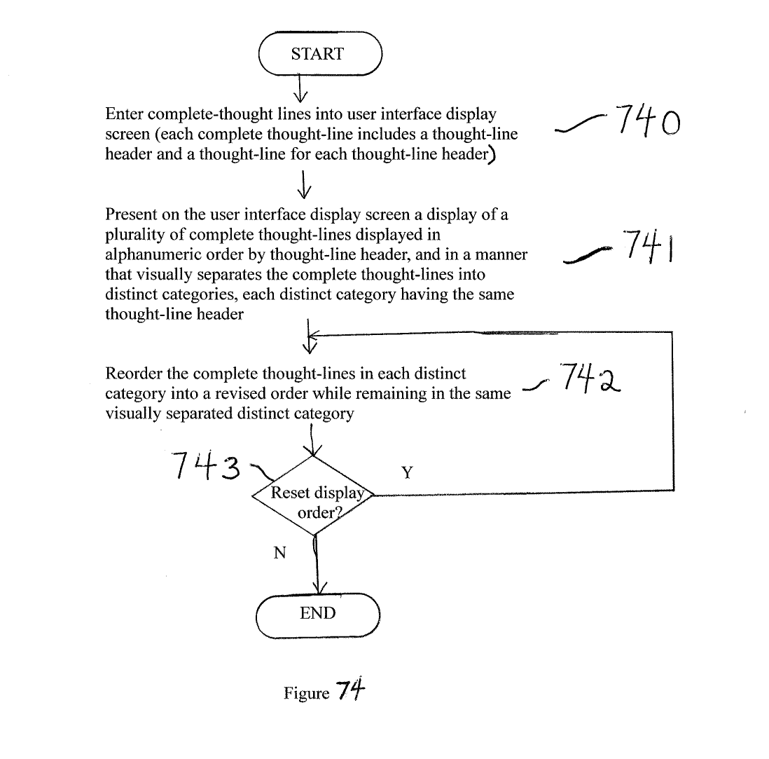

EXAMPLE 3 is illustrated in FIG. 74 and includes at least the following steps:

Step 740: Enter complete-thought-lines into user interface display screen. (Each complete thought-line includes a thought-line header and a thought-line for each thought-line header.) The screen for this step is similar to the screens in EXAMPLES 1 and 2, except no priority numbers or organizational headers are entered.

Step 741: Present on the user interface display screen a display of a plurality of complete thought-lines displayed in alphanumeric order by thought-line header, and in a manner that visually separates the complete thought-lines into distinct categories, wherein each distinct category has the same thought-line header. The screen for this step is similar to the screens in EXAMPLES 1 and 2, except that no priority numbers or organizational headers are shown.

Step 742: Reorder the complete thought-lines in each distinct category into a revised order while remaining in the same visually separated distinct category. The screens and process for performing this step is similar to EXAMPLES 1 and 2

Step 743: Reset the display order, if desired.

FIG. 58C shows two views of a database for use in one preferred embodiment of EXAMPLE 1. The database is similar to the database for EXAMPLE 1 shown in FIG. 58A, except that there is no Priority field.

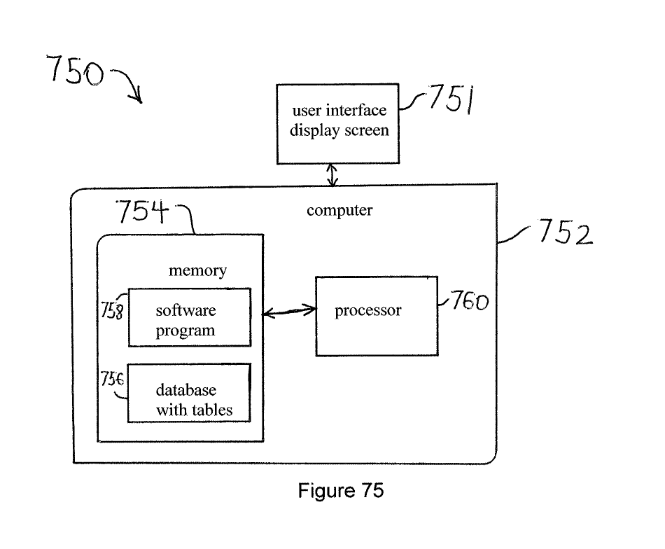

FIG. 75 is a schematic diagram of the hardware/software system 750 used to implement preferred embodiments of the present invention, including EXAMPLES 1-3. The system 750 includes at least the following elements:

user interface display screen 751

computer 752

memory 754

database with tables 756 (FIGS. 58A, 58B and 58C)

software program 758

processor 760

In the EXAMPLES 1-3 above, the “View Entries” screen allows the user to make pairwise comparisons to create logical groupings.

In the EXAMPLES 1-3 above, the complete thought-lines are entered on a user interface display screen and the “View Entries” screen is displayed on a different user interface display screen. However, in an alternative embodiment, the complete thought-lines are entered and viewed on the same screen. Preferably, the new complete thought-lines are entered in one portion of the screen (e.g., at the top of the screen), and the previously entered complete thought-lines are viewed/displayed in another portion of the screen (e.g., below the entry portion).

The present invention may be implemented with any combination of hardware and software. If implemented as a computer-implemented apparatus, the present invention is implemented using means for performing all of the steps and functions described above.

When implemented in software, the software code can be executed on any suitable processor or collection of processors, whether provided in a single computer or distributed among multiple computers.

The present invention can also be included in an article of manufacture (e.g., one or more computer program products) having, for instance, computer readable storage media. The storage media has computer readable program code stored therein that is encoded with instructions for execution by a processor for providing and facilitating the mechanisms of the present invention. The article of manufacture can be included as part of a computer system or sold separately.

The storage media can be any known media, such as computer memory, one or more floppy discs, compact discs, optical discs, magnetic tapes, flash memories, circuit configurations in Field Programmable Gate Arrays or other semiconductor devices, or other tangible computer storage medium. The storage media can be transportable, such that the program or programs stored thereon can be loaded onto one or more different computers or other processors to implement various aspects of the present invention as discussed above.

The computer used herein may be embodied in any of a number of forms, such as a rack-mounted computer, a desktop computer, a laptop computer, or a tablet computer. Additionally, a computer may be embedded in a device not generally regarded as a computer but with suitable processing capabilities, including a Personal Digital Assistant (PDA), a smart phone or any other suitable portable, mobile, or fixed electronic device.

The computer may have one or more input and output devices. These devices can be used, among other things, to present a user interface. Examples of output devices that can be used to provide a user interface include printers or display screens for visual presentation of output and speakers or other sound generating devices for audible presentation of output.

Examples of input devices that can be used for a user interface include keyboards, and pointing devices, such as mice, touch pads, and digitizing tablets. As another example, a computer may receive input information through speech recognition or in other audible format.

Such computers may be interconnected by one or more networks in any suitable form, including as a local area network or a wide area network, such as an enterprise network or the Internet. Such networks may be based on any suitable technology and may operate according to any suitable protocol and may include wireless networks, wired networks or fiber optic networks.

The various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

The terms “program” or “software” are used herein in a generic sense to refer to any type of computer code or set of computer-executable instructions that can be employed to program a computer or other processor to implement various aspects of the present invention as discussed above. The computer program need not reside on a single computer or processor, but may be distributed in a modular fashion amongst a number of different computers or processors to implement various aspects of the present invention.

Computer-executable instructions may be in many forms, such as program modules, executed by one or more computers or other devices. Generally, program modules include routines, programs, objects, components, data structures, and the like, that perform particular tasks or implement particular abstract data types. The functionality of the program modules may be combined or distributed as desired in various embodiments.

Data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Preferred embodiments of the present invention may be implemented as methods, of which examples have been provided. The acts performed as part of the methods may be ordered in any suitable way. Accordingly, embodiments may be constructed in which acts are performed in an order different than illustrated, which may include performing some acts simultaneously, even though such acts are shown as being sequentially performed in illustrative embodiments.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention.

What is claimed is:

1. A computer program product for capturing and organizing thoughts and ideas of a user, the computer program product comprising non-transitory computer-readable media encoded with instructions for execution by a processor to perform a method comprising:
(a) entering by the user into a first user interface display screen:
(i) one or more thought-line headers,
(ii) a thought-line for each thought-line header, and
(iii) a user-defined initial priority rating for each of the thought-line headers and associated thought-lines,
wherein each thought-line header and associated thought-line define a complete thought-line, thereby capturing the thoughts and ideas of the user as they occur;
(b) presenting on a second user interface display screen a display of a plurality of complete thought-lines in order of their initial priority rating from highest to lowest;
(c) the user selecting via the second user interface display screen one or more of the complete thought-lines as being of upcoming greatest importance to the user; and
(d) modifying, using the processor, the order of the complete-thought lines so that the complete thought-lines selected in step (c) appear at the highest order on the second user interface display screen and displaying the modified order of the complete-thought lines, thereby organizing the thoughts and ideas of the user.

2. The computer program product of claim 1 wherein step (d) further comprises visually separating the complete thought-lines on the second user interface display screen into distinct categories of complete thought-lines based on their modified order.

3. The computer program product of claim 2 wherein the instructions for execution by the processor perform a method further comprising:
(e) providing a reordering function so that the complete thought-lines that appear at the highest order on the second user interface display screen can be reordered by the user into a revised priority order while remaining in the same visually separated distinct category, thereby further organizing the thoughts and ideas of the user.

4. The computer program product of claim 1 wherein the thought-line header is differentiated in appearance from the thought-line on the second user interface display screen in a manner that emphasizes the thought-line header compared to the thought-line.

5. The computer program product of claim 1 wherein the user interface display screen in step (a) includes labeled entry locations for the user entry of (i) the one or more thought-line headers, (ii) the thought-line for each thought-line header, and (iii) the user-defined initial priority rating for each of the thought-line headers and associated thought-lines.

6. The computer program product of claim 1 wherein the second user interface display screen in step (b) is a different user interface display screen than the first user interface display screen in step (a), and wherein the first user interface display screen in step (a) allows for entry and display of only one complete thought-line at a time, and the second user interface display screen in step (b) simultaneously displays a plurality of complete thought-lines.

7. The computer program product of claim 1 wherein the instructions for execution by the processor perform a method further comprising:
(c) temporarily lowering the priority ratings of the complete thought-lines that have the highest initial priority rating and that are not selected in step (c), wherein the modified order of complete-thought lines show the temporarily lowered priority ratings of the non-selected complete thought-lines.

8. The computer program product of claim 1 wherein step (a) is performed in a plurality of different sessions.

9. The computer program product of claim 1 wherein the instructions for execution by the processor perform a method further comprising:
(e) providing a reset function so that the display order in step (b) can be reestablished.

10. A computer program product for capturing and organizing thoughts and ideas of a user, the computer program product comprising non-transitory computer-readable media encoded with instructions for execution by a processor to perform a method comprising:
(a) entering by the user into a first user interface display screen:
(i) an organizational header,
(ii) an initial alphanumeric character associated with the organizational header,
(iii) one or more thought-line headers for each organizational header, and
(iv) a thought-line for each thought-line header,
wherein each thought-line header and associated thought-line define a complete thought-line, thereby capturing the thoughts and ideas of the user as they occur;
(b) presenting on a second user interface display screen a display of:
(i) organizational headers and associated initial alphanumeric characters, and
(ii) a plurality of complete thought-lines, the complete thought-lines being visually separated into groups in accordance with their respective organizational headers, wherein the display is initially ordered in alphanumeric order depending upon the initial alphanumeric characters of the organizational headers;
(c) providing a first reordering function, using the processor, that allows the user to change the initial alphanumeric characters of an organizational header so that the organizational headers and the associated complete thought-lines within each organizational header can be reordered by the user into a revised alphanumeric order, while remaining in the same visually separated group, thereby organizing the thoughts and ideas of the user.

11. The computer program product of claim 10 wherein the instructions for execution by the processor perform a method further comprising:
(d) providing a second reordering function so that the complete thought-lines within each organizational header can be reordered by the user into a revised order while remaining in the same visually separated group, thereby further organizing the thoughts and ideas of the user.

12. The computer program product of claim 10 wherein the thought-line header is differentiated in appearance from the thought-line on the second user interface display screen in a manner that emphasizes the thought-line header compared to the thought-line.

13. The computer program product of claim 10 wherein the first user interface display screen in step (a) includes labeled entry locations for the user entry of (i) the organizational header, (ii) the one or more thought-line headers for each organizational header, and (iii) the thought-line for each thought-line header.

14. The computer program product of claim 10 wherein the second user interface display screen in step (b) is a different user interface display screen than the first user interface display screen in step (a), and wherein the first user interface display screen in step (a) allows for entry and display of only one complete thought-line at a time, and the second user interface display screen in step (b) simultaneously displays a plurality of complete thought-lines.

15. The computer program product of claim 10 wherein step (a) is performed in a plurality of different sessions.

16. The computer program product of claim 10 wherein the instructions for execution by the processor perform a method further comprising:
(d) providing a reset function so that the display order in step (b) can be reestablished.

17. A computer program product for capturing and organizing thoughts and ideas of a user, the computer program product comprising non-transitory computer-readable media encoded with instructions for execution by a processor to perform a method comprising:
(a) entering by the user into a first user interface display screen:
(i) one or more thought-line headers, and
(ii) a thought-line for each thought-line header,
wherein each thought-line header and associated thought-line define a complete thought-line, thereby capturing the thoughts and ideas of the user as they occur;
(b) presenting on a second user interface display screen a display of a plurality of complete thought-lines in alphanumeric order by thought-line header, and in a manner that visually separates the complete thought-lines into distinct categories, each distinct category having the same thought-line header; and
(c) providing a reordering function, using the processor, so that the complete thought-lines in each distinct category can be reordered by the user into a revised order while remaining in the same visually separated distinct category, thereby organizing the thoughts and ideas of the user.

18. The computer program product of claim 17 wherein prior to step (c), the complete thought-lines are displayed alphanumerically by thought-line within each distinct category.

19. The computer program product of claim 17 wherein the thought-line header is differentiated in appearance from the thought-line on the second user interface display screen in a manner that emphasizes the thought-line header compared to the thought-line.

20. The computer program product of claim 17 wherein the first user interface display screen in step (a) includes labeled entry locations for the user entry of (i) the one or more thought-line headers, and (ii) the thought-line for each thought-line header.

21. The computer program product of claim 17 wherein the second user interface display screen in step (b) is a different user interface display screen than the first user interface display screen in step (a), and wherein the first user interface display screen in step (a) allows for entry and display of only one complete thought-line at a time, and the second user interface display screen in step (b) simultaneously displays a plurality of complete thought-lines.

22. The computer program product of claim 17 wherein step (a) is performed in a plurality of different sessions.

23. The computer program product of claim 17 wherein the instructions for execution by the processor perform a method further comprising:
(d) providing a reset function so that the display order in step (b) can be reestablished.

24. The computer program product of claim 1 wherein the first and second user interface display screens are different portions of the same user interface display screens.

25. The computer program product of claim 10 wherein the first and second user interface display screens are different portions of the same user interface display screens.

26. The computer program product of claim 17 wherein the first and second user interface display screens are different portions of the same user interface display screens.
